(19) United States
(12) Patent Application Publication
(10) Pub. No.: US 2007/0234224 A1
(43) Pub. Date: Oct. 4, 2007

(54) Method for developing and implementing efficient workflow oriented user interfaces and controls

(76) Inventors: Joseph M. Leavitt, Florence, AL (US); Darrell D. Diem, Madison, AL (US); Jeffrey M. Silvaggi, Madison, AL (US)

Correspondence Address: MARK CLODFELTER, 555 SPARKMAN DRIVE, SUITE 1602D, HUNTSVILLE, AL, 35816, US

(21) Appl. No.: 11/518,057

(22) Filed: Sep. 8, 2006

Related U.S. Application Data
(63) Continuation-in-part of application No. 10/931,128, filed on Aug. 30, 2004.
Application No. 10/931,128 is a continuation-in-part of application No. 09/986,765, filed on Nov. 9, 2001, now Pat. No. 6,918,091.
(60) Provisional application No. 60/247,643, filed on Nov. 9, 2000.
(60) Provisional application No. 60/325,179, filed on Sep. 28, 2001.
(60) Provisional application No. 60/498,656, filed on Aug. 29, 2003.
(60) Provisional application No. 60/714,965, filed on Sep. 8, 2005.

(51) Int. Cl. G06F 3/00; G06F 3/048

(52) U.S. Cl. 715/762; 715/747; 715/765

(57) ABSTRACT

A method for developing user interfaces to support efficient workflow implementation in an organization or in daily tasks of a typical consumer is disclosed. The method accounts for limitations in ability of a typical user of such interfaces to deal with more than about six elements of information or choices at any given step of a workflow. The method may include use of customized tools and other components developed to support implementation of user interfaces and data structures needed to implement user interfaces and associated data exchanges between client devices and applications on servers. The user interfaces, methods, tools, and other components may also be used to support user interfaces used to control software applications, information appliances, and other devices.

### CROSS REFERENCE TO RELATED APPLICATIONS

The instant application is a continuation-in-part of U.S. patent application Ser. No. 10/931,128, filed Aug. 30, 2004, which is a continuation-in-part of application Ser. No. 09/986,765, filed Nov. 9, 2001, now U.S. Pat. No. 6,918,091, issued Jul. 12, 2005 and which also claimed the benefit of Provisional U.S. Patent Application No. 60/247,643, filed Nov. 9, 2000, and Provisional U.S. Patent Application No. 60/325,179, filed Sep. 28, 2001. Application Ser. No. 10/931,128 also claimed the benefit of provisional application No. 60/498,656, filed Aug. 29, 2003. The instant application also claims the benefit of provisional U.S. Patent Application No. 60/714,965, filed Sep. 8, 2005. Application Ser. Nos. 10/931,128, 09/986,765, 60/247,643, 60/325,179, 60/498,656 and 60/714,965 are hereby incorporated herein by reference in their entireties.

### COPYRIGHT AND TRADEMARK NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

ZenuSuite™, ZML™, ZCom™, MenuStack™, and ZipTech™ are trademarks of Change Tools, Inc. ZENU® and ZTool® are registered trademarks of Change Tools Inc., as is ChangeTools®. Unix is a registered trademark of The Open Group. Microsoft, Microsoft Windows, Window NT and/or other Microsoft products referenced herein are either trademarks or registered trademarks of Microsoft Corporation. Various terms and icons in the figures may be trademarks or registered trademarks of other companies.

### FIELD OF THE INVENTION

The present invention relates generally to the field of user interfaces for efficient workflow management and/or control of tasks involving user interactions with systems or devices that store, use, or present information, and more particularly to a server controllable user interface system for remote devices and to methods for mapping information exchanges required to support various task specific work flows or device controls into an efficient user interface using a standardized information display protocol that efficiently presents information and choices in a manner compatible with human capabilities and limitations.

### BACKGROUND OF THE INVENTION

As users become more untethered from their desks, they will rely more and more on technologies and devices that enable true mobility by enabling an ‘always on’ connection to their information. A basic premise of mobility is miniaturization and the need to travel light, hence, the growing demand for laptop PC's and suitable wireless handheld information appliances/devices.

People are now in highly mobile, time critical situations and need to access and use information ‘on the fly’ without stopping what they are doing. Getting their desktops onto smaller information appliances like cell phones, and PDA's is not a big deal from a features perspective. Today's devices have more than enough memory, capacity and processing power, but that is not the issue. The issue is—how do you get access to all this information and accomplish what you want to do easily. A group of components and tools called ZenuSuite and an associated methodology disclosed herein provide an enabling technology that delivers this capability.

There is at least one key reason and four major trends that drive the need for the current invention:
1. Mobility as a mega trend is a ‘key reason’. We are all doing more and more outside the confines of the office.
2. “Always on” broadband connections are becoming ubiquitous.
3. People are now comfortable with interacting over the Internet.
4. Web search has become the norm.
5. Revenue models are now established—standard license or advertising based revenue.

Communication and real-time information sharing are the key pillars to enabling the mobile enterprise. Users, and particularly mobile users, require technologies that are easy to use, lightweight, and interoperable with other elements of their information systems and appliances both at home and on the road. The proliferation of complex electronic communication and computational devices and their capabilities have mushroomed over the past few years and have left consumers, road warriors, and real soldiers lost in a stream of disparate operating systems—a jumble of platforms and interface control mechanisms. Integrating all these pieces has caused headaches for Information Technology (IT) managers who are searching for an easier way to make information accessible to their organization's mobile work force. Literally tons of data reside on complex banks of central or remote servers and the challenge is how to give the user access to that information. How do you enable the average user to efficiently navigate and obtain information without requiring specialized training? The problem exacerbates itself when a user tries to translate command information or menus, designed for a flat screen of a PC, and tries to reconfigure existing screens and menus for the small window of a portable device. Now add to the ergonomic frustration of the activity by asking the soldier, driver, student, factory worker, or other user to have to find a stylus to orchestrate the browser.

Applications typically require prodigious amounts of screen real estate to collect or display all the information related to completing a particular task or mobile activity. If applications don't require custom hardware, mobile device selection usually boils down to choosing an off-the-shelf hand-held device that offers a large enough screen, and sufficient memory.

Users will tell you that a well-designed screen is of utmost importance. It is their window to viewing the capabilities of the system. To many, it is the system, being one of the few visible components of the product. It is also the vehicle through which many vital tasks are presented and/or controlled.

One of the problems well known to users of many typical software applications on computer systems, and interfaces to other modern devices, such as laptops, PDA's, Smartphones, information appliances, video cassette recorders and digital versatile disk (DVD) devices, is the complexity of the user interface. As the number of such devices increases, an increasing number of members of society experience almost daily interactions with various user displays or voice menus on multiple data sources or other devices, often leading to confusion and stress for a typical user having to understand and remember multiple menus or display formats and sequences, to accomplish common tasks. Too often, it appears that user interfaces are developed by computer software engineers who take great pride in displaying, in a typical user interface, all the wonderful flexibility and features they have built into their software programs without apparently realizing that a great preponderance of consumers or other users who must interact with such programs or devices are only interested in accomplishing a particular task with minimal effort in minimal time with minimal stress. Interactions with complex interfaces frequently create additional stress on common and professional users of consumer electronics products and services, rather than providing the relaxation and assistance in daily living that is supposed to be a benefit of our modern technologies. Stress is frequently a result when a user interface presents more information and choices than a typical human is able to readily comprehend and use efficiently.

In a typical interaction, users are frequently presented with an overwhelming number of choices in a complex application specific user interface. Complex or unfamiliar interfaces may cause confusion or at least delay in execution of typical day-to-day transactional tasks. Such tasks may require a user to exchange information to or from a device from a system that stores or processes data, or a task may require a user to interact with a modern household or office device having a remote control or other user interface. (Such systems or devices are also referred to herein as information appliances.) A complex presentation of many choices may provide great flexibility to a trained computer professional or experienced user, but when a user not trained in the specific application or device is presented a complex user interface with many choices, confusion and inefficiency are likely results as a user tries to figure out or remember which button is needed to control or input the desired information required to accomplish a desired task or result. Trained computer professionals represent only a small percentage of the population. Although modern consumers are being challenged to interface with more and more information appliances in the daily lives, their interaction with any specific software applications and devices may be infrequent, leading to more stress as the user is forced to reach back into memory and try to recall the specific functions of a particular user interface needed to control the device. As the number of information devices increase and the user interfaces to such devices become more integrated into our daily lives, it is increasingly important that the user interface becomes more task oriented and focused on enabling a consumer to efficiently perform error-free tasks with any device, all-the-while minimizing the stress induced by the screen clutter present in many user interfaces developed without adequate consideration of usability and human factors necessary to perform the tasks.

Various researchers in fields of human psychology and information processing have asserted that most individuals become stressed or even disoriented when confronted with too much information or too many choices at once. One world-renowned researcher, George A. Miller, wrote the following in a paper entitled “The Span of Immediate Memory: The Magical Number 7 plus or minus 2—Some Limits on our Capacity for Processing Information” (The Psychological Review, 1956, vol. 63, pp. 81-97) about his findings in this area of psychological understanding:

“Let me summarize the situation in this way. There is a clear and definite limit to the accuracy with which we can identify absolutely the magnitude of a unidimensional stimulus variable. I would propose to call this limit the span of absolute judgment, and I maintain that for unidimensional judgments this span is usually somewhere in the neighborhood of seven.”

“The span of absolute judgment and the span of immediate memory impose severe limitations on the amount of information that we are able to receive, process, and remember. By organizing the stimulus input simultaneously into several dimensions and successively into a sequence or chunks, we manage to break (or at least stretch) this informational bottleneck.”

As cited above, Miller asserted that the number of elements of information a typical person could deal with was about seven, while other researchers have asserted a number closer to four. Although complex multi-choice user interfaces may be more efficient for some applications especially where users have received adequate training, to become familiar with the multiple features of the interface, most users employing information devices should be presented with fewer logical transactional workflow choices more akin to a human conversational style, in order to complete the task at hand. This normal conversational flow is further enhanced if the user interface is based on a standardized information display protocol, and in a form that permits a user to input and receive information with minimal effort excercising control over the application and device using spoken commands, or single handed, one thumb intearaction.

The recognition that many, if not most, user interfaces are confusing or simply unusable to the casual user lead to the creation of a user interface called Zenu, disclosed in earlier patents and patent applications previously incorporated herein by reference, and the instant invention, which includes a method for integrating a user interface such as Zenu with other components and software to provide a breakthrough in user interface management and in CONTROL—enterprise control of user interfaces on remote end-user platforms, and end-user control of information appliances, applications and information on remote servers, and other devices and functions. The Zenu user interface and associated components and methods disclosed herein are specifically developed to create a common user experience on any device from the desktop to the laptop to the cell phone, PDA, and/or remote control—but predominantly to small information appliances—irrespective of the underlying operating system.

The approach to solving this problem of providing a flexible and adaptable but common user interface includes design and development of an Information Display Protocol (IDP), generally presenting only (but not necessarily) six options at a time, and integration of the previously patented Zenu interface and other elements of the ZenuSuite disclosed herein to implement the Information Display Protocol on various platforms and networks, aiding in increased information use and productivity by enabling users to easily and intuitively control their devices and the network alike.

One objective of the instant invention is to address the need expressed in the following statement: “Technology can make anything possible. It's the training of people to use the technology that's impossible.” Technology can achieve almost anything, but the training of people to use the technology is what challenges many worthy technologies.

The methods of the instant invention have been developed by the Applicants to provide an innovative solution in response to frustrations with multiple unnecessarily complex user interfaces and take advantage of insights into human psychology and physiology. These methods also build upon disclosures of user interfaces and related innovations provided in prior patents and patent applications which were previously incorporated herein by reference.

Much of the reason or “necessity” leading to development of the instant invention arose from frustrations and stress encountered by the Applicants in attempting to accomplish common tasks with commercial software or devices that were acquired to perform simple tasks in the Applicants' daily lives. Too often, the user interfaces to such devices attempt to display controls and inputs for a myriad of tasks or other activities supported by the great power and flexibility that software programmers and other engineers have designed into such devices, sometimes, seemingly, driven more by a desire to provide another bullet point on a marketing brochure rather than to provide a simple method of control that most purchasers of such devices require to easily perform tasks. Typical users, including the Applicants, attempting to interface with such software or devices often have an experience similar to that of dealing with an individual who wants to expound upon and proudly display his or her great knowledge of a subject rather than providing a simple “yes” or “no” answer, or other simple answer, to a simple inquiry that may be asked in attempting to accomplish a simple task.

Furthermore, the proliferation of computers, cell phones, PDAs, Blackberries, and many other wireless devices has created a jumble of platforms, interfaces, and applications. Integrating all these disparate pieces has caused headaches for more than one system administrator. Additionally, the people using these devices must remember how each device's interface is configured, and thus how they can drag information reluctantly from them—if at all.

What is needed are methods and tools for standardizing the interface so that application designers and programmers could quickly, easily, and productively build workflow-based applications to enable users to efficiently access their required data.

The Zenu methodology, ZenuSuite tools, and the Zenu user interface described herein and in a previous patent and in patent applications previously incorporated herein by reference places control of how the user interface is designed for control of a software application into the hands of the person or business organization owner, management group, or a central military command unit responsible for implementing a task specific workflow rather than an anonymous software engineer's or application developer's idea of what an organization or end-user really needs to perform a required task or implement an efficient workflow. The ZenuSuite components and methods of the instant invention were designed to make it possible for an individual user or an organizational user of ZenuSuite to take charge and lay out an end-user interface and information display protocol that meets their needs for enhancing efficiency and minimizing stress and training by implementing the easy to use information display protocol and control functions inherent in the patented Zenu interface.

The overall approach toward designing this revolutionary interface stems from research into human mental capacity, some of which was cited earlier herein.

One object of the instant invention is to provide a methodology by which many of the common tasks of everyday life, as well as more complex tasks encountered in various professional occupations, may be accomplished using a simple user interface that generally presents only so many items (normally six or fewer items) as may be readily comprehended and understood by an average, untrained individual using a standardized information display protocol. The information display protocol may be adapted to virtually any task or visual, aural, or other sensory human activity involving control of, or data exchange with, an information appliance

### BRIEF DESCRIPTION OF THE DRAWINGS

FIG. 1 is a top-level block diagram of a representative enterprise information architecture showing an application of the instant invention in developing user interfaces for devices that exchange information with application servers.

FIG. 2 is another block diagram of an information architecture emphasizing various communications media that may be used with the instant invention.

FIG. 2a is a block diagram showing more detail in an example embodiment that uses a particular communications path.

FIG. 3 is a block diagram that shows various combinations of devices, user input techniques, and operating systems that may be used with embodiments of the instant invention.

FIG. 4 is a block diagram showing how the instant invention may be used to configure interfaces between a user device and applications on a server.

FIG. 4a is a block diagram showing how features of the instant invention interact to provide a user interface between a client device and a data source.

FIG. 5 is a block diagram showing the key components in a data exchange between a Zenu client and a database.

FIG. 6 is an block diagram showing an example of how a Zenu client may interact with a server to retrieve information about a personal contact.

FIGS. 7a and 7b are illustrations of a candidate circular user input device that may be used in some embodiments of the instant invention to help enable operation with a thumb or a single finger.

FIG. 8 is a screen shot of a display of available application on a Pocket PC device.

FIG. 9 is a screen shot of another display of applications showing how a Zenu icon may be displayed.

FIG. 10 is a screen shot showing an opening screen for a Zenu user interface client software embodiment.

FIG. 11 is a screen shot showing a home page of a Zenu interface.

FIG. 12 is an enlarged view of a portion of a Zenu screen showing the command arrows and Z-button portions of a Zenu display.

FIG. 13 is a screen show showing a representative keyboard that may be displayed and used for data entry with a Zenu user interface implementation.

FIG. 14 is an enlarged view of a portion of a Zenu screen showing an ‘abc’ button that may be used to toggle the keyboard display of FIG. 13 to enter upper case or lower case letters.

FIG. 15 is a view of the keyboard of FIG. 13 toggled for entry of upper case letters.

FIG. 16 is an enlarged view of a portion of a Zenu display showing a key that may be used to toggle a portion of the keyboard of FIG. 13 for entry of symbols.

FIG. 17 is another view of a keyboard of FIG. 13 showing additional keys that are available in symbol mode for entering frequently used information.

FIG. 18 is another enlarged view of a portion of a Zenu screen showing additional keys that have special functions.

FIG. 19 is a screen shot of a Zenu display showing a data entry field.

FIG. 20 is a screen shot of a portion of a Zenu display showing the right arrow key used to enter information and move to the next step in a work flow.

FIG. 21 is a screen shot showing example choices that may be presented at a step in a workflow.

FIG. 22 is a screen shot showing how a picture or other illustration may be presented within a Zenu interface.

FIG. 23 is a screen shot showing how a Zenu interface may be used to display a map.

FIG. 24 is a screen shot showing the “breadcrump” feature of Zenu displays that help a user keep track of where he is in a workflow.

FIG. 25 is a text chart showing steps in the methodology of implementing a Zenu user interface for a work flow.

FIG. 26 is an illustration showing an example of storyboard that may be used in defining information and displays needed at various steps in a workflow.

FIGS. 27 through 29 illustrate use of the storyboard forms of FIG. 26 in various stages of developing a Zenu user interface application.

FIG. 30 is an illustration of basic screen templates used within ZTool to aid in developing and implementing user interface screens.

FIG. 31 is an expanded view of a portion of a screen shot of a Zenu screen showing selection buttons and other command and navigation features.

FIG. 32 is an expanded view of some of the command buttons shown in FIG. 31.

FIG. 33 is a screen show of a screen of a ZTool application that may be used on a personal computer or other workstation to support implementation of Zenu interfaces within an enterprise.

FIG. 34 is a table showing tags that may be used in embodiments of Zenu Markup Language to support implementation of Zenu user interfaces.

FIG. 35 is a screen shot showing how ZTool may be used to connect buttons with desired functionality.

FIG. 36 is a screen shot showing a partial listing of ZML generated by ZTool for a particular screen implementation.

FIG. 37 is another example listing of ZML used to communicated information between a Zenu client device and an application on a server.

FIG. 38 is a view of a ZTool screen used for design of a Zenu screen.

FIG. 39 is a screen shot of a ZTool screen showing an example of a Zenu screen being developed.

FIG. 40 is screen shot of a ZTool screen showing how various project files may be accessed through ZTool.

FIG. 41 is a screen shot of a ZTool screen showing various file and data management features.

FIG. 42 is a view of a portion of a ZTool screen shot showing how files may be viewed within a project.

FIG. 43 is view of a portion of a ZTool screen shot showing how a new page may be added.

FIG. 44 is a view of a portion of a ZTool screen shot showing how command files or asp scripts may be linked with various buttons or other controls on a Zenu screen.

FIG. 45 is a screen shot of a ZTool screen showing how properties of screen controls or other objects may be displayed.

FIG. 46 is a view of a portion of a ZTool screen shot showing how other properties or objects may be displayed.

FIG. 47 is a view of a portion of a ZTool screen shot showing how object properties may be entered in a ZML data exchange to control Zenu display characteristics.

FIG. 48 is a view of a portion of a ZTool screen shot showing how hidden objects may be displayed.

FIG. 49 is a view of a portion of a ZTool screen shot showing how Members may be added to a collection of objects.

FIG. 50 is a view of a portion of a ZTool screen showing how the size of a pane may be adjusted.

FIG. 51 is a screen shot of a representative Zenu home page.

FIG. 52 is a screen show showing a Zenu screen that may be used to access contact information.

FIG. 53 is a screen shot showing data fields that may be used to enter information for a contact.

FIG. 54 is a view of how the screen of FIG. 53 appears when filled in before the right arrow key is pressed.

FIG. 55 is a screen shot of a screen that may be displayed after contact information has been accepted by a server.

FIG. 56 is a screen shot of a screen that may be display after the continue button is pressed in the screen shown in FIG. 55.

FIG. 57 is an illustration of elements of an information architecture that may be used with and by aspects of the instant invention.

FIGS. 58a and 58b are views of an information architecture showing how ZML may be used to exchange information between a Zenu user interface and other elements of the architecture.

FIG. 59 is a screen show showing an example of a Zenu application login screen after it has been filled in by a user.

FIG. 60 is a screen shot of a Zenu home page that may be presented after login credentials have been verified by a server.

FIG. 61 is a screen shot of a Zenu screen that may be displayed in an example application.

FIG. 62 is a screen show of a Zenu screen requesting data for an example workflow.

FIG. 63 is a screen show of an example of the completed data entry screen of FIG. 62 before the right arrow button is pressed.

FIG. 64 is a screen show of an example Zenu screen that may be used to present retrieved information to a user where the user may edit the information.

FIG. 65 is a screen shot of a Zenu example application showing how additional information may be presented on a subsequent screen after the continued button is pressed on the screen of FIG. 64.

FIG. 66 is a screen shot of a Zenu example application showing choices that may be presented at a particular portion in a workflow.

FIG. 67 is a screen shot of a Zenu screen that may be displayed in response to a user pressing button 1 in the screen shown in FIG. 66.

FIG. 68 is a screen shot of a Zenu screen showing how responses to inspection questions may be presented to a user for selection and entry.

FIG. 69 is a screen shot of another Zenu screen that may be presented in an example application.

FIG. 70 is a screen shot of another Zenu screen showing a summary of data entered by a user in previous screens.

FIG. 71 is a screen shot of a Zenu screen showing how control may be returned to a previous screen after a subtask flow of a work flow is completed.

FIG. 72 is a screen shot of a Zenu screen showing how additional data may be presented in a work flow.

FIG. 73 is a screen shot of a Zenu screen showing again how choices may be presented for selection by a user in an example workflow.

FIG. 74 is a screen shot of a Zenu screen showing a subsequent question that may be presented to a user in an example workflow.

FIG. 75 is a screen shot of another Zenu screen displaying another question that may be presented to a user in a particular workflow.

FIGS. 76 and 77 are Zenu screen shots of additional screens showing other questions that may be presented to a user in a particular workflow.

FIG. 78 is a screen shot of a Zenu screen showing a summary of data entered that may be presented to a user for confirmation.

FIGS. 79 and 80 are screen shots of additional Zenu screens that may be presented to a user for confirmation of additional inspection items in an example application.

FIG. 81 is a screen shot of a Zenu screen showing a summary of data entered in previous screens presented to a user for confirmation.

FIG. 82 is a screen shot of a Zenu screen showing how control may be returned to a higher level or home page after a subtask or selected workflow is completed.

FIG. 83 is an illustration showing how domain knowledge and breadth of knowledge may vary based upon educational level of a user.

FIG. 84 is an illustration showing how a Zenu information display protocol and ZenuStack may be used to present multiple levels of information to a user.

FIG. 85 is another illustration of storyboard forms that may be used to help implement a methodology for developing Zenu user interface applications.

FIG. 86 is a screen shot of a Zenu screen showing how an airline check-in workflow choice may be presented to a user.

FIG. 87 is a screen shot of a Zenu screen requesting confirmation and name data from a user.

FIG. 88 is a screen shot of a Zenu screen showing how flight information may be retrieved and presented to a user in an example application.

FIG. 89 is a screen shot of a Zenu screen showing a confirmation of completion of check-in by a user.

FIG. 90 is a flowchart providing another illustration of a methodology that may be used in developing ZTool user interfaces for various applications and workflows in an enterprise or other organization.

FIGS. 91 through 105 are graphs showing bar plots indicating how a group of users compared Zenu and a conventional user interface implemented on PCs and on handheld PDAs, based on various comparison metrics shown at the top of each graph, with Zenu rankings shown in the left bar of each pair of bars.

### DETAILED DESCRIPTION OF THE DRAWINGS

Methods and interfaces disclosed herein provide simple and direct, and generally intuitive, approaches to performing most common and even specialized tasks involving user interfaces with computers, data bases, or other information acquiring, processing, and display devices. Methods disclosed herein may be used with a wide variety of information presentation techniques, including visual, aural, or other techniques that may rely on senses of touch or feeling (e.g., including use of active tactile devices that may provide Braille-like stimuli or encoded vibrational, gesture or tactile stimuli) or other human senses. Human input of information via such interfaces may include keyboards, touch screens, or common computer mouse, trackball, or joystick point and click type interfaces, or other known input techniques including, for example, use of voice commands or other voice recognition inputs, input techniques that employ eye-tracking, and other input means including those emerging from research into direct inputs from brain waves or other direct thought-driven control techniques.

A foundational concept in the implementation of the methodology of the instant invention involves recognizing or defining a natural work flow and/or information flow that may be associated with any given task that may involve using a user interface to exchange data between a human and an information input, processing, or serving device, including software or firmware running on such a device. Tasks may involve a string of activities and information exchanges with any software or firmware programs or devices intended to accomplish a particular objectives such as: obtaining a reservation and seat assignment from an airline, programming a video cassette or video disk recorder to record a particular television program, or ordering a replacement part, accessory, or supply item for a piece of equipment, performing standard field inspections, and issuing permits, etc.

As noted earlier, it is generally known and accepted from the work and publications of Miller and others, as well as from the day-to-day experience of most of us, that the human brain can efficiently handle only about six or seven pieces of information at a time. Other research has suggested that the number may be even more like four.

When most daily or other common tasks are approached from a viewpoint of identifying a logical workflow path, comprising multiple steps to perform, information requirements of a particular step rarely require having to simultaneously deal with more that six elements of information, generally in a form of choices, before moving on to a next step. Even tasks such as looking up a telephone number in a directory are generally assisted by search and organizational (e.g., alphabetizing) capabilities in modern devices wherein a user may enter just a few letters and then be presented with a short list that meet the qualifying input. Many task steps require only one or a couple of elements of information. Thus, a simple user interface that presents and allows a user to efficiently and easily indicate a choice, e.g., via thumb driven rocker switch or other simple input, from only up to approximately six information elements or choices is able to handle nearly all daily or common tasks most users of modern information using and/or presenting devices will ever need to perform. Virtually any task, including simple daily interfaces with remotely controlled devices as well as more complex interfaces with data retrieval systems, may thus be broken down into a logical workflow with required information exchanges between machine and user mapped into a simple standardized user interface, thereby reducing the number or choices or inputs at each step, minimizing user stress and frustrations, and enabling the user to accomplish virtually any task based on the control that only an intuitive, user friendly interface provides.

The Zenu™ Information Display Protocol basically allows a user to turn the tables on software programmers and developers of other information appliances, and provides a defense for an average, untrained or infrequent user of a particular information appliance, by allowing the user to say, in effect, “Look, I have enough to do in life already, and this is the understandable user interface which enables me to perform my tasks. You, the trained software professional, must learn to adapt and present your capabilities in a manner that is simple and intuitive to me, the user.

Since for most consumer devices, the preponderance of users are individuals with little training or interest in computer science or in the discipline needed to recall and execute specific instructions, it will be far more efficient and less stressful for most members of society, as a whole, to have a standardized or common user interface through which an untrained user can interact. The Zenu™ user interface, described in Applicants' prior patents and patent applications, previously incorporated herein by reference, provided such an interface through innovative techniques of structuring information exchange, presenting information, and controlling information to enable easy and error free task completion by presenting information in sets of layers in a common format using a standardized information display protocol. The Zenu™ interface, described in U.S. Pat. No. 6,918,091 and other applications incorporated herein, with additional description herein, provides a standardized GUI screen that can be programmed for use on any desktop or handheld wireless device. The interface provides a simple, common point of reference and a familiar look and feel for use in most common information exchange and control tasks.

Components of the ZenuSuite disclosed herein, and in earlier patent applications previously incorporated herein, may be used to implement a Zenu interface on a single personal computer or on multiple PCs or portable devices in an enterprise architecture. ZenuSuite helps a configuration user implement user interfaces such as a Zenu user interface using a standard set of command buttons that provides an intuitive interface that most users can pick up and understand with little or no training. Once an end-user is familiar with the Zenu interface, and ZenuSuite tools and methods disclosed herein have been used to implement appropriate supporting elements of an architecture, the Zenu interface can then be used to access information from all applications the user currently uses. The end-user can then use the familiar Zenu interface to interact with and control a given application without having to learn each application's individual characteristics and foibles, thus reducing the learning curve associated with introduction of a new software application. Zenu's standardized GUI is particularly suited to, (but not limited to) PDA's and other mobile handheld information appliances which are increasingly being used to interact with information. The Zenu user interface eliminates the need for a stylus and hence the need to scroll (a tedious and time-consuming task), enabling a user to drill into or “Zen-in” to applications one layer at a time—all from substantially the same command region on the Zenu interface. This Zen-In functionality feature enhances user productivity by enabling faster and error free task completion.

The Zenu™ user interface and associated tools, methods, and techniques disclosed herein for implementing user interfaces to connect and control information on remote servers and other information appliances including common household appliances, provides for implementation of a standardized information display protocol that has been shown through testing (described later herein) to provide an efficient and intuitive user interface used to enable an untrained user to efficiently accomplish a wide variety of tasks involving interactions with information appliances, all with minimal stress. The Zenu™ user interface and associated tools and components, including ZTool™ and ZML™, are referred to herein as ZenuSuite™. An information management architecture easily implemented by use of ZenuSuite capabilities offers a robust and user-friendly solution to technical issues confronting wireless data access as shown in Table 1.

TABLE 1
Zenu's Solution to Existing Wireless Problems

| Wireless Device/Data Problems | ZenuSuite Solution |
|---|---|
| I/O data out of sync | Data in real time with no need to sync |
| Deployment of new upgrades or | Changes become instantly available |
| versions to users in the field | without loading new software on the device |
| Unreliable wireless connections | Fewer bits means less transmission |
| | time |
| Unknown actual bandwidth availability | Fewer bits means faster transmissions |
| Wireless and device security | Encryption, SSL, VPN and no |
| | information resides on the device |
| Limited device processing power | Server side does all the processing |
| Limited user device battery power | Limited processing required by PDA |
| Huge number of device interfaces and buttons | Standard and intuitive Zenu interface |
| Differing device software | Standard Zenu provides a consistent |
| | look and feel |
| Intermittent connectivity - Ad hoc | Option available to cache data locally if |
| Networks | a connection is not available |

ZenuSuite comprises four parts:
Zenu™ Graphical User Interface (GUI)
ZML™
ZTool™
ZCom

The Zenu graphical user interface (GUI) provides a standardized portal that enables the wireless transmission and display of any text or graphical data on a handheld device. A Zenu user may use this simplified, intuitive, patented user interface, including its optional layered approach to presenting information and choices, to provide access to, and control of, an application in any operating environment, especially but not limited to ones with the limited screen sizes seen on mobile devices. A user does not need a stylus to use the Zenu—the keys are big enough to input singlehandedly with one thumb or finger so that a user can enter information, send emails, retrieve records, etc. Embodiments of the Zenu GUI may also use voice commands or eye movements and other gusture controls alone or in combination with other input methods.

ZML (Zenu Markup Language) is an austere XML-based language that uses extremely small tags and short data streams to communicate between the Zenu application and the Server designed solely to promote bandwidth efficiency.

ZTool, described in patent application Ser. No. 10/931,128 and described further herein, is a rapid development utility created so an individual user or a configuration user, typically a system administrator, also referred to herein as an enterprise user, within a using organization can design and create the ZML templates that define the layout and properties of forms used to define the screen display and related controls. ZTool allows a configuration user to view and build a Zenu screen display form using a virtual display on a small screen device, or on a desktop. The ZML code can then be integrated with any server-side application providing data access and updating capability. Through it all, ZTool eliminates unnecessary code and tags, saving precious bandwidth and accelerating delivery of data. Faster delivery also reduces airtime costs, extends battery life of handheld devices, and thus saves time and money for a company or organization.

ZCom is a term used herein to refer to a communications infrastructure that provides real-time synchronization with applications that may be used on a PC desktop, PDA, or on any Web-enabled phone to access data and applications on a server. ZCom can connect to the Internet through a TCP/IP socket connection. ZCom uses a proprietary and secure markup language called ZML to allow server-side applications and script files to communicate. ZCom may be implemented using commercial or private telecommunications and networking media, including wired, fiber optic, or wireless networks, including for example cellular phone networks or private data networks.

ZenuSuite™ provides tools and components that greatly simplify implementation of an uncomplicated user interface, such as a Zenu interface, for a end-user on many different platforms, including desktop, PDAs, cell phones, and other wireless communication devices. ZenuSuite™ provides a solution to problems inherent with integrating software applications on one system, or many devices on one network. A Zenu interface implemented through use of ZenuSuite™ components and methods disclosed herein avoids a need to retrain users each time hardware or applications are changed or upgraded, because a Zenu interface and methodology uses the same standardized design on every display. With the ZTool utility—a rapid development tool for user interfaces and support software and data for multiple portable and stationary devices—an organization can design application interfaces to suit the needs of the organization as well as the needs of particular end users. Once tasks and/or workflows needed to achieve objectives of the organization are defined, ZenuSuite tools may be used to design user interfaces that provide efficient implementation of tasks from a logical work flow approach. ZTool and the Zenu interface support implementation of individual tasks that tie together to meet workflow needs of an organization.

In some embodiments and applications, the Zenu™ interface and associated tools and techniques provide the unbinding of control from device. That is, a Zenu™ user interface when implemented on any wireless or wired information appliance such as a computer, laptop, automobile or portable devices such as cell phones, personal digital assistants, remote control devices (having an infrared, acoustic, or BlueTooth™ connection), or household appliances, household control and security systems, provides the user with the capability to control the device in the same consistent manner. This allows the user to ignore (if they wish) the control features provided by the supplier of such devices and exercise an unprecedented degree of intuitive control. The Zenu is the instantiation of the unbinding of control from device. In many embodiments, a Zenu™-enabled device may then be viewed as a remote-control, or a portal interface to information or applications residing on any remote server accessed through the internet. Such a Zenu™ enabled device may then help provide the truly portable constant companion interface, or agent which has been the unrealized promise of the information age for too long.

A Zenu interface allows use of standardized templates, implemented in ZTool, to reduce effort in defining an application's user interface, and help make a user interface instinctive to use. Once a user understands the simple navigation options, using the Zenu interface becomes second nature. ZTool creates the software language needed to integrate applications to a Zenu interface, also referred to herein simply as Zenu.

ZenuSuite and the method disclosed herein support implementation of a universal portal (Zenu) as an interface between an end user and an application along with management tools that reside on a server to reduce or eliminate a need for extensive device training to master a particular handheld device. Through ZenuSuite, a server side system administrator (also referred to herein as a configuration user) has an efficient capability to design server-driven displays that present only relevant options to a user at any one time, thereby reducing a user's mental processing needed to deal with the interface and workflow, thus enhancing a user's situational awareness to other activities in his or her environment, whether in an office or on a battlefield. With increasing emphasis on situational awareness in the military and homeland security sectors, this interface can help better equip and inform end users, and in some cases save lives in the process.

An important benefit of a Zenu interface and associated information architecture that may be implemented using ZenuSuite is the security that is inherent in such architecture configurations. Data may reside on one or more common servers that handheld devices may communicate with, eliminating integration problems. Because of this configuration, data is more secure: Loss of a device or its failure won't compromise security of password-protected data. Even better, making software upgrades is a simple matter of loading new program(s) or displays onto a server, upgrading scripts if necessary, and instantly every user has access to them. A system administrator will be more effective at maintaining the system, thus increasing productivity and responsiveness.

Although ZenuSuite tools and methods may be used to help implement a Zenu interface on a single PC or other information appliance, a greater benefit may be found in implementing Zenu interfaces on multiple user platforms within an enterprise architecture, such as discussed below.

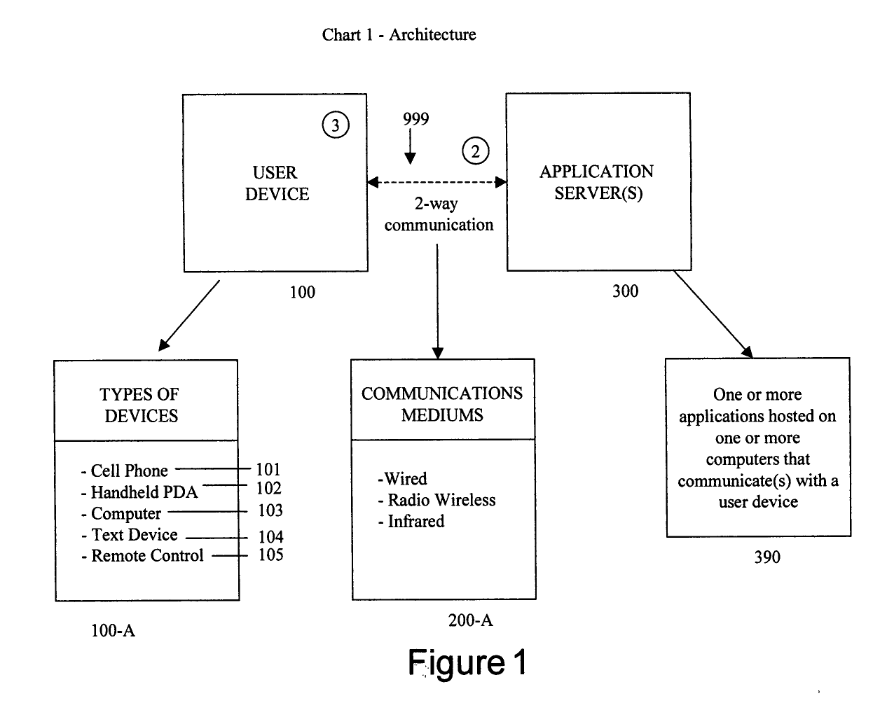

FIG. 1 provides a simple illustration of a representative enterprise information architecture comprising user devices 100, application servers 300, and a communications infrastructure 200, referred to herein as ZCom, that provides 2-way connectivity between user devices 100 and servers 300. ZCom may enable true mobile access to information residing on any remote application server from any user device. ZCom may be an enabling communications infrastructure that encompasses mobility and connectivity.

There may be many user hardware devices 100 within an enterprise architecture that can access information residing in applications 390 stored on any remote server 300. Such devices may include, for example, but are not limited to, cell phones 101, handheld PDAs 102, computers 103, text devices 104, or remote controls 105. These devices are virtually unlimited in scope or size, but all share one common function which is to enable the exchange of information via some communications medium 200, which may be wired (including fiber optics), wireless (including RF, infrared or other optical wavelength media, or acoustic), or other communications media discovered or developed in the future.

Information may be presented to users from any number of applications 390 residing on remote servers 300 and accessed by user devices 100. There are many specific steps that occur to enable secure, speedy, accurate, and easy information exchange anywhere, anytime on any device.

With the incredible number of user devices 100 in the marketplace and with the ever increasing speeds at which these devices are effectively obsoleted or superseded with newer models, users are often left with two choices; either stick to the device you have or upgrade and face a new learning curve in terms of controlling and navigating the various functions of the device and information services associated with such devices.

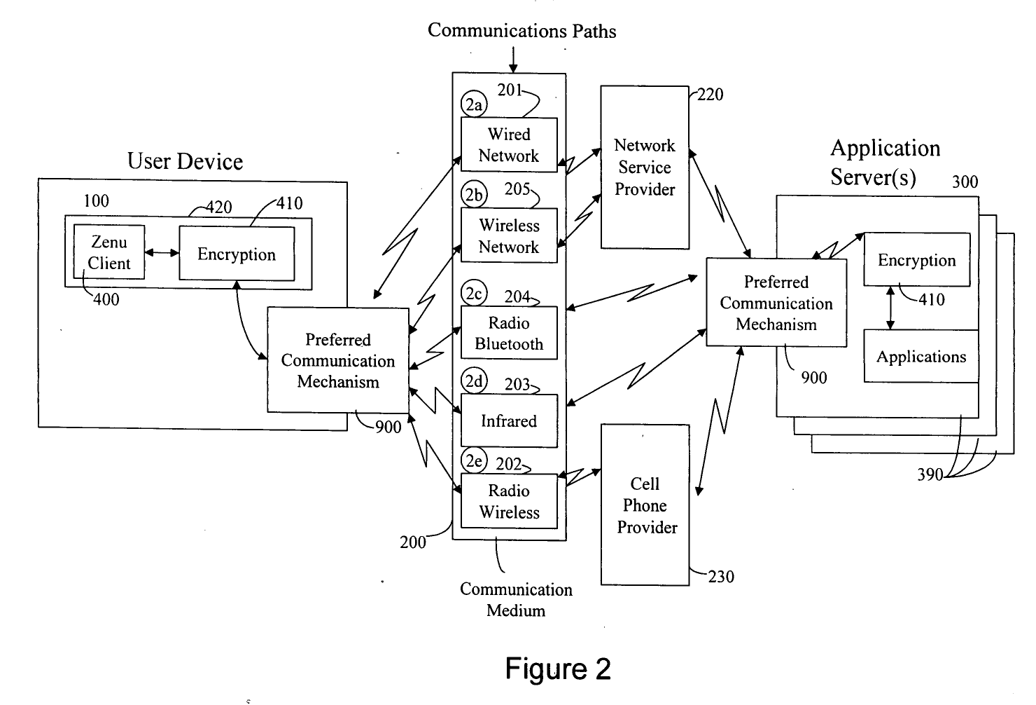

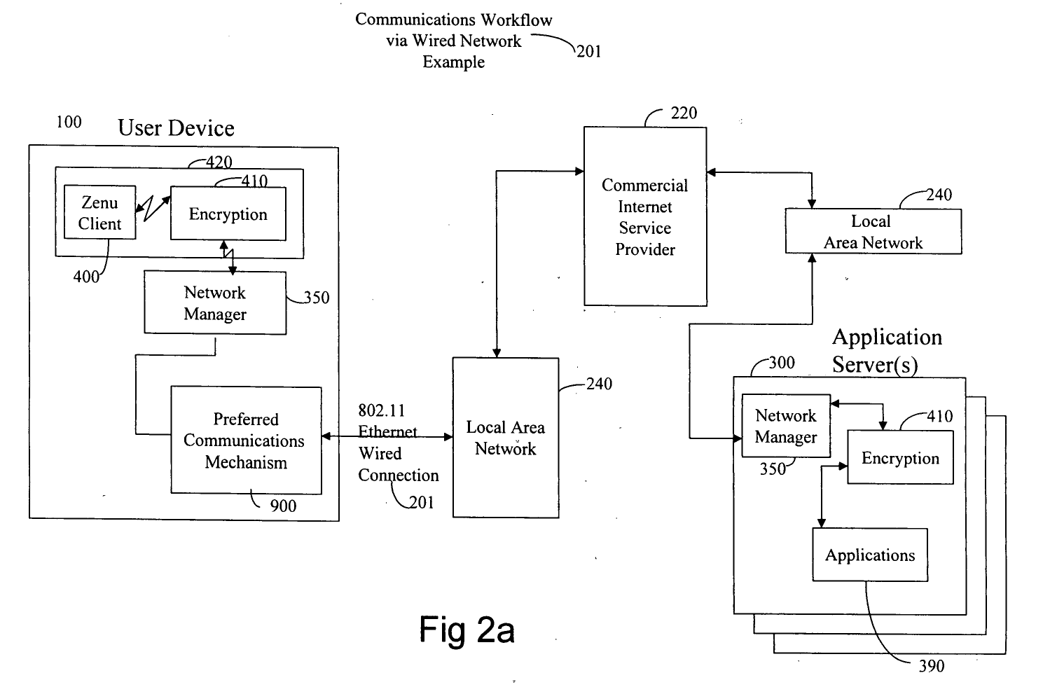

FIG. 2 is an modified view of a representative enterprise information architecture with expanded emphasis on alternative communications media that may be employed in such architectures. The Zenu client side interface 400 and other aspects of the instant invention were developed partly to help solve this problem of device obsolescence and replacement by standardizing the user interface environment so users on any device may maintain control over the device and also readily gain access to and control or exchange information with server side applications 390.

In addition to the Zenu interface 400 secure access protocols may be needed both on user devices 100 and on servers 300 to protect information from unauthorized use or disclosure. User device and application server encryption/decryption 410 may be used to provide a desired degree of security for a particular application or operational environment. In enterprise information architectures wherein Zenu user interfaces are used together with an adequate communications infrastructure to provide timely access to only needed elements of information residing normally on central servers, security concerns may be reduced by two features: 1) the fact that there is no need to retain information on a user device itself 100, which may be lost or stolen, and 2) encryption capabilities 410 both on user devices 100 and application servers 300 to protect data while in transit. Encryption capabilities implemented in a particular application may be adjusted to counter potential threats as appropriate to the importance of information being exchanged on particular communications media.

In some enterprise information architectures that may be implemented using tools and methods of the instant invention, a user may have access as needed, via the Zenu client side interface 400, to elements of information normally residing on central servers. However, where such data is not stored and retained on a device, there is no compromise of such information if the device is lost, stolen or misappropriated. In such architectures, user devices may be just ‘dumb’ appliances whose sole role is to access remote servers 300 and extract information, but purposely not store it on the device 100. There are several benefits of such architectures especially when server access is controlled via user and password authentication or similar measures: unauthorized access to information on, or control of, servers is denied; critical information remains secure behind the server firewalls; information is not ‘lost’ when a user device is lost or stolen; there is no need to ‘restore’ information on a replacement user device where communications access to servers is still intact; there is minimal financial loss due to loss of a user device, just the hardware cost of a replacement device.

The major security effort is on the server side 300 embodied by various degrees of encryption 410 appropriate to a particular communications medium which may be selected by a preferred communications mechanism 900.

Referring also to FIG. 2a, which shows a more detailed example of a representative enterprise information architecture, a network manager 350 assigns user names and passwords for each user allowing users to gain access to data from their devices 100 and therefore authorized access to servers 300 via a communications infrastructure (ZCom).

This is enabled by the Zenu client side interface 400 at an optional and desired security encryption level 410 which may be embodied as a Zenu User Device with Security 420.

To gain access to a server side application 390 users have a choice of communication media 200 (FIG. 2) which may be provided by any number of different types of communications service providers, including, for example, private or public Networks 220 and commercial cellular phone providers 230. Some of the communications media may also comprise short range radio networks or links 204 (such as Bluetooth), microwave or other longer range wireless networks or links 205, or light-based networks or links such as laser or infrared 203. In some embodiments, where multiple media are available, a preferred communications mechanism 900 may be used to select a particular medium for a particular data transfer application, or a media may be selected inherently by a user (e.g., on a cell phone).

When information, usually in a form of data from applications 390 residing on a remote application server 300, is accessed from a user device 100 over a wired 201 or other connection provided by a commercial Internet Service Provider 220 over a local area network 240 there are specific steps that must occur to enable the information exchange.

Access to a server 300 and applications 390 residing thereon may be determined and authorized at the server by a network manager 350 and enabled by a preferred communications mechanism 900 at a desired security encryption level 410.

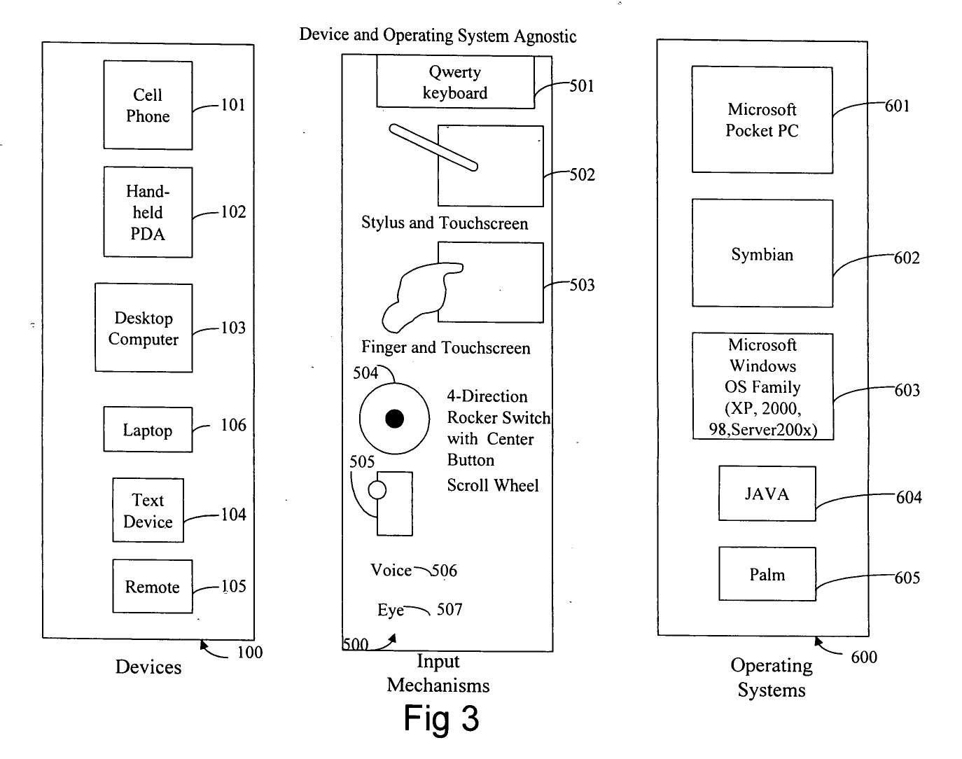

Referring now to FIG. 3, the Zenu client side interface 400 shown in FIG. 2 may be implemented to control any of various types of user devices 100 including cell phones 101, handheld PDAs 102, desktop and laptop or notebook computers 103, other text devices 104, or remote control devices 105, in a consistent and common manner so users do not need to wonder what buttons to press or even have to reach for a user's guide. Standardizing the user interface (e.g., via a Zenu user interface) reduces training and learning costs associated with today's disparate device environment.

The concept of device convergence comes into play. It has not been that long since the advent of extensive wireless communication, the cell phone in 1983, followed 10 years later with the first handheld PDA to access personal information such as telephone numbers. There were pagers that received short messages and wireless remote control devices that control an arsenal of appliances in the home. Laptops enabled the first breakthrough in true mobility for enterprise workers to perform their work anywhere, anytime. Over time and really only in the last couple of years has the notion of device convergence really become a potential reality. This notion states users should need only one device to perform most if not all their computing and control needs.

With increasing demands for true mobility in the conventional workplace and in military environments, devices are coming on the market that are bursting with processing capability and functionality—basically shrinking a former PC-class computer into a handheld device, so true mobility is enabled.

But as in most visions and notions, there are side effects. Processing capabilities are there, but processing places huge demands on battery usage. Screen sizes cannot be too small or the user cannot see what he needs to do to accomplish a task at hand, and as anyone who spends time working outside knows, it may be difficult to view a screen in broad daylight. To compensate manufacturers are inserting high screen resolutions and backlighting ‘improvements,’ but these place further demands on battery life and the overall promise of true mobility is compromised.

The recent advent of the “smartphone” is a huge step forward on the road to device convergence, providing a device that combines a PDA's functionality of providing personal information management (PIM), email, calendars, and voice communication delivered on a palm sized screen so that text may be input for performing tasks. There are various input methods or mechanisms 500, as shown in FIG. 3, which are an important ingredient of the mobility value proposition—access to and manipulation of applications—anywhere anytime on any device.

The issue here is that user interfaces may not be user friendly and device navigation differs from device to device and from operating system to operating system 600.

The value of a Zenu client side interface 400 is that it does not matter what device or operating system is being used on a particular device. A user can always access the underlying features of the device by invoking Zenu.

Considering input mechanisms 500 in more detail, Qwerty keyboards 501 are common in a number of user devices. These are useful but the user needs to use two hands or better stated—thumbs to input information.

A stylus and touchscreen 502 allow users to tap the screen version of keyboard or other imbedded alphanumeric character generator. Here the drawback is when a user loses a stylus it complicates the input and navigation process. A user can always substitute with a pointer but it is still inconvenient and potentially critical when one considers loosing a stylus in a military operation in a desert or other hostile environment.

With Zenu, a user has the benefit of a touch screen by using one finger 503 so the device can be controlled single handedly and easily allow data input, or controlled by a rocker button 504 common in most user devices like a PDA or SmartPhone 102.

Another method is in a device such as a Blackberry™ device 505 where a scrolling wheel is used to navigate an application and depressing the wheel activates certain command functions.

One promising input method but one of the more challenging is voice recognition 506. Voice recognition and voice commands may enable a high degree of mobility since a user may keep both hands free and not be unencumbered by having to view a screen. The main problem with voice recognition is exactly that—computers have to be trained to the sounds of their users' voices'—prone with errors associated with accents, languages, cultures especially when the range of choices of possible words to be recognized is unconstrained. This is especially important in a military environment where interoperability is important—possibly involving multiple users of a given device where the device needs to recognize voice commands from any potential user.

The issue of mis-recognition is a major impediment in use of voice input technology. However, the success of VR may be significantly enhanced by using the Zenu client side interface 400 by virtue of its austere command design and overall value proposition of accessing server side information. One may think of a Zenu interface as the eyes of the computer. As anyone knows when you want to get a point across and be totally understood by another person, you need to ‘look them in the eye’ and make your command. The success of the result is based on the ability of the listener to understand the command. In the case of a Zenu-enabled device, there is a customizable interface that enables a user to easily be understood by the computer as the user needs to learn to say only a very limited vocabulary yet have full access to server side applications that may be ‘delivered’ by a server based on a user's voice commands. The computer's ability to recognize a user's voice and correctly interpret voice commands is greatly enhanced due to the austere vocabulary requirements enabled by the design of the Zenu client side interface 400.

With a Zenu interface, a computer typically needed to distinguish only up to six words in a given data exchange with a user. These may be as simple as words for: 1-2-3-4-5-6. With this vocabulary a user can control a device and manipulate most applications.

A Zenu interface may be used to access applications 390 residing on servers 300 in a manner that allows a user on any device 100 to simply respond to options presented on a screen with this very limited vocabulary.

The same logic applies to eye tracking input 507. By reducing the number of choices presented at each step, a key aspect of Zenu interface design, the possibility of mis-recognition by an input device is also reduced.

A Zenu interface may be implemented via Zenu client device software so that Zenu interface features and functionality may be retained across multiple Operating Systems 600. A Zenu interface may be implemented via a small software application residing and executing on a host device so as to allow control of the device and navigation of various applications on the device or on remotely located servers irrespective of the underlying operating system. Zenu client software may be written in any software language (including, for example C++, C#, Visual Basic, or even an assembly language) compatible with a device's operating system so as to implement the functionality and look and feel of a Zenu interface disclosed in earlier patent applications previously incorporated herein by reference. Zenu client software may use standard subroutine calls or other mechanisms supported by a device's operating system to send data to be transferred over a communications link supported by a devices operating system and to receive, process, and/or display data received through a device's communications link or links and operating system through subroutine calls or other mechanisms of a device's operating system that enable transfer of data from a communications link to a software application running on such device. For example, a Zenu interface may be implemented on devices running any of the following operating systems: Microsoft Pocket PC 601, Symbian 602, Palm 605, Microsoft Windows family (e.g., XP, 2000, 98 and server 2000) 603, Java 604, or others.

One advantage of a Zenu interface is that enterprise owners or military organizations do not have be locked into any particular device environment or operating system and can upgrade or replace devices at will without incurring costs of retraining personnel to use a different user interface. Once a user easily learns to use a Zenu interface he can immediately pick up and use other devices with a Zenu interface, even though the devices may be using different operating systems.

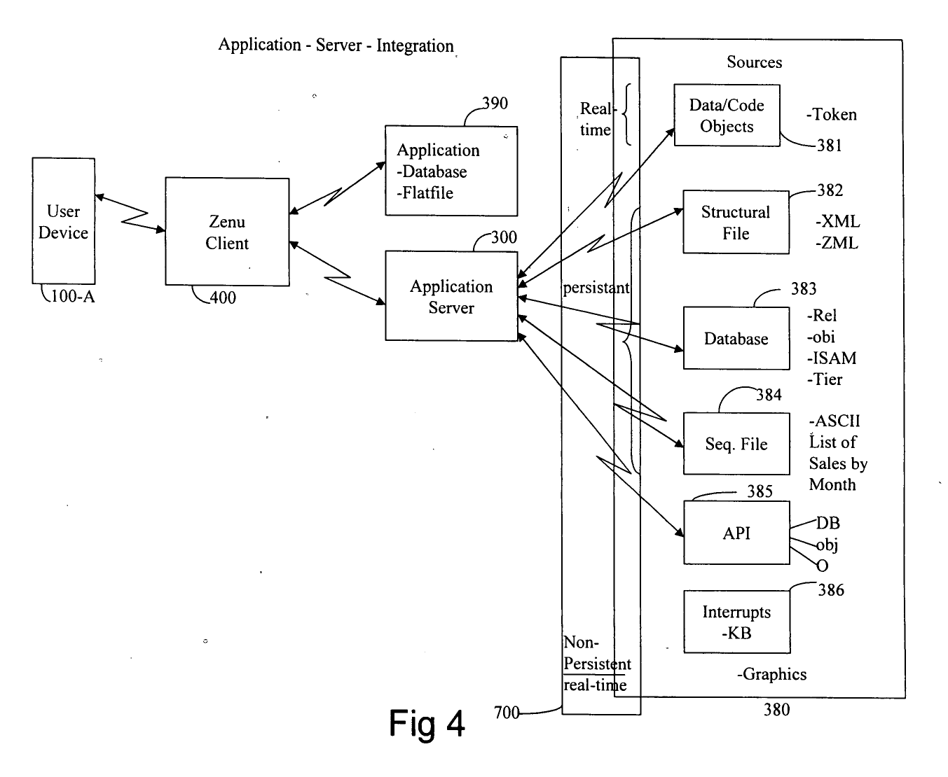

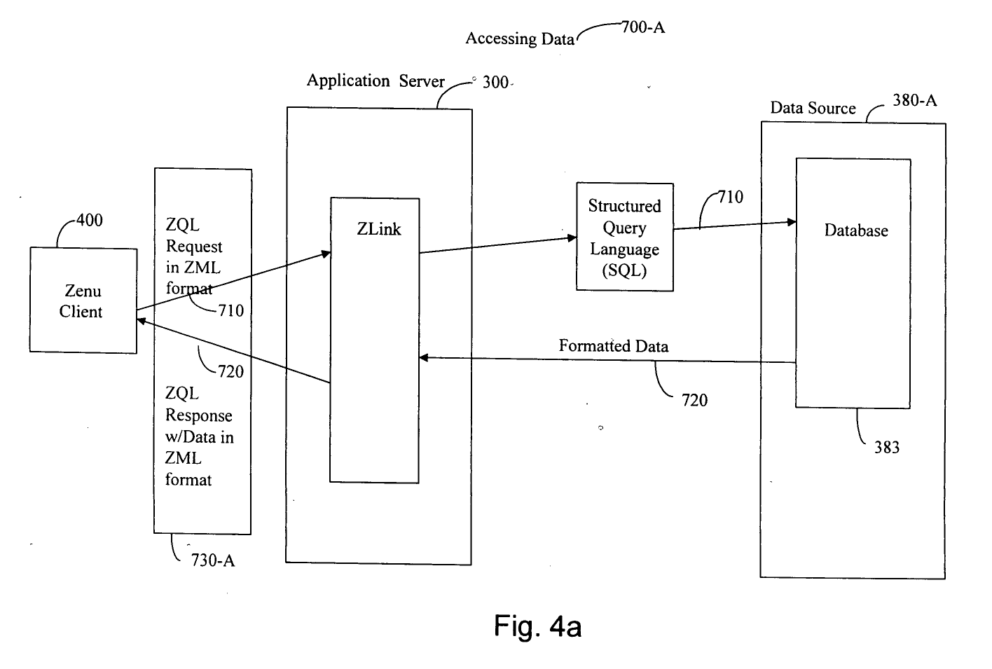

FIG. 4 illustrates how ZCom provides an infrastructure for any Zenu 400 enabled user device 100 to communicate with applications 390 hosted on a server 300. As shown earlier in FIG. 2, communication between a Zenu enabled client device 400 and a server 300 can take place using any of multiple communications media 900. However, a key capability is for the Zenu client 400 to access data on a server 300 using a variety of various data access mechanisms.

There are two classes of data transferred using ZCom—persistent and non-persistent data 700. Persistent data is that data which is stored on a server and can be transferred and retransferred at any time. An example of persistent data is data stored in a database. Non-persistent data is that data that is exchanged as it is generated and does not reside in a data store. An example of non-persistent data is data generated from a data entry device (e.g., keystrokes) or data from a real-time sensor (like a gas gauge) where individual data points may not be important, but the totality of the data may be important (e.g., the total number of sales).

The Data Sources 380 can comprise many different types. For example, the data may be stored as Objects 381, Structured Files 382, Database 383, Sequential Files 384, through an Application Programmers Interface (API) 385, and via hardware or software Interrupts 386. Each of these data sources provides a technique for ZCom data access.

Referring now also to FIG. 4a, each of these different types of Data Sources 380 may be accessed via an Application Server 300 using Zenu Query Language (ZQL) 730. Zenu Query Language is a method for communication with each different type of Data Source 380 and retrieving data from that source. ZQL provides data to a Zenu Client 400 in a format that the client can parse and display. The ZQL also provides data used to query a Data Source 380 so it can return the requested data.

FIG. 4a illustrates how a Zenu client 400 makes a request for data from an Application Server 300. The request 710 may use a ZML 799 format to request data using a ZQL query syntax and terms. ZQL may be similar to SQL language but using abbreviated tags or separators in order to minimize bandwidth usage. An Application Server 300 receives a ZQL quesry 710 and translates the query into a query language appropriate for a particular data server (which in this example may be SQL). The query for data is conducted and data 720 is returned to the application server. The Application Server then returns this data 720 to the Zenu client 400 where it is displayed in the appropriate menu and screen.

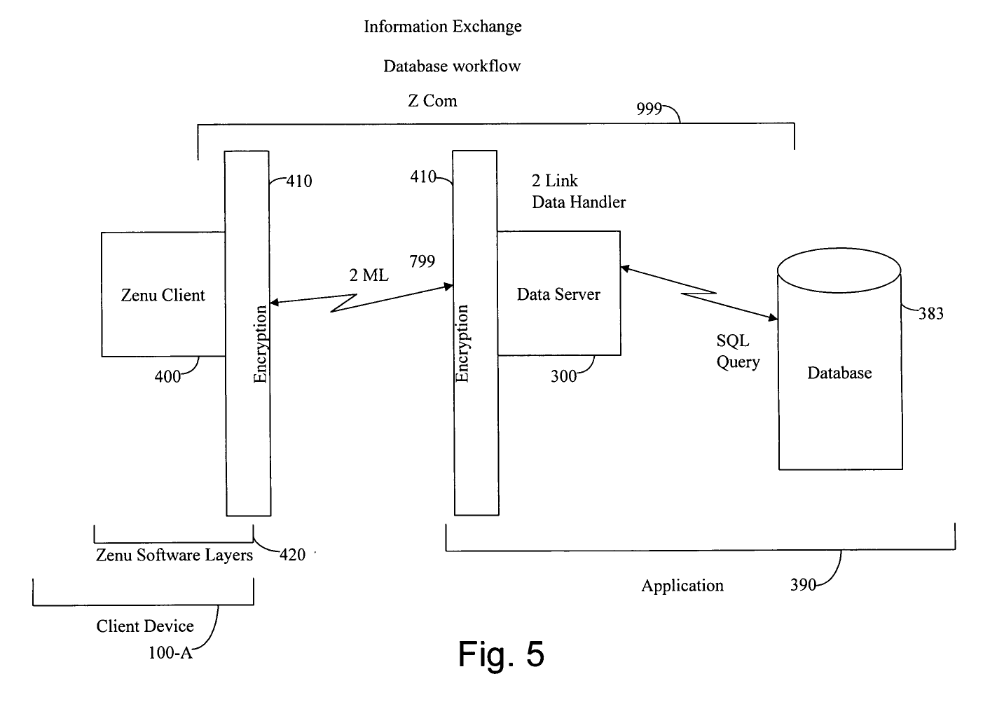

Referring now to FIG. 5, ZenuSuite provides the overall components—a set of tools—that puts control of how user interfaces are designed for specific software application programs, as well as applications in the sensor of overall workflows, into a configuration user's hands (whether such user be an individual, a business or organization owner, or a military unit). Rather than an individual end-user or an organization user of mobile or stationary data access and control devices being at the mercy of the original programmer's idea of what a user needs, ZenuSuite was conceived and developed to make it possible for configuration users to take charge of how an overall workflow support application is built and how specific software applications are accessed by a Zenu interface 400 on any user device 100.

ZenuSuite comprises client application software to implement a Zenu user interface on a device (400), an austere rapid wireless data exchange mark-up language ZML 799 is a ‘shorthand’ subset implementation of XML. ZML has minimal tags and an end result of this ‘shorthand’ is that less data is needed and can be exchanged more rapidly, placing less data transfer and processing demands on devices 100 which in turn maximizes battery life of the device.

This is advantageous in two ways:
There is no requirement for any proprietary middleware server that usually act as a proxy server for a customers own data server 300.
Any application 390 accessing any database 310 can be queried 305 and accessed by users on any Zenu 400 enabled client devices 100.

In summary, ZCom 999 provides a communications infrastructure for a ZenuSuite aided implementation of an information architecture. A ZCom infrastructure connects Zenu 400 and applications 390 using ZML over any communications medium 200 with optional levels of encryption 410 to address security at both the client device side 400 or at the server side 300 protecting applications 390 and data residing in any database 310.

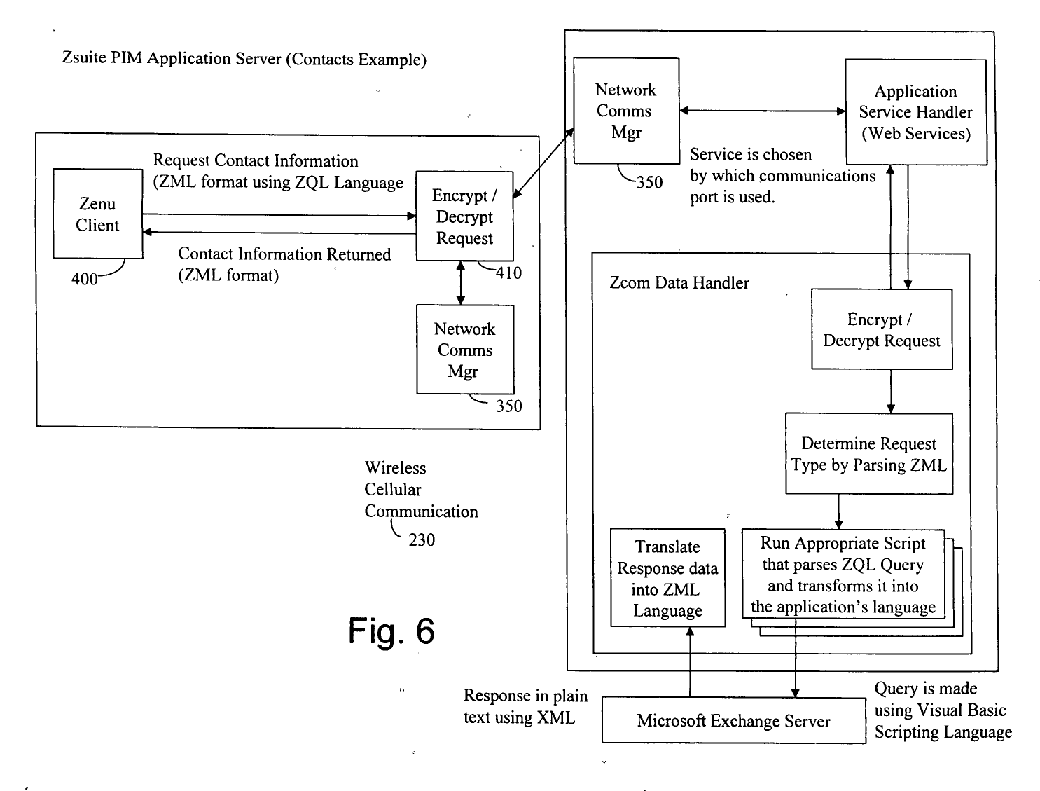

FIG. 6 illustrates an example involving a flow of information between a Zenu Client 400 and an Application Server 300 in a Personal Information Manager (PIM) application where a client requests contact information from a Microsoft Exchange Server.

The user requests an individual's contact information from the Application Server via a Zenu Client by selecting the contact's name from a list of contacts, or by entering all or portions of a contact's name. The request is formatted into a compact ZML format using the terms that are part of the ZQL language. This ZQL language contains the terms needed for the ZCom Data Handler to interpret the request and respond to it.

The contact information request is encrypted and sent via a wireless cellular network by a network communications manager to the application server. The destination is designated by an IP address and a port number, which may be stored on the remote device or stored on the host server for the device. The Applications Server receives the request and routes it to the proper Application Service Handler (in this case Microsoft IIS web services) which then executes the proper ZCom Data Handler Application. The ZCom Data Hander decrypts the information and then parses the ZML to determine the type of request being made and how it should be processed. The appropriate script is then run on the server and the ZQL query terms are translated into query terms that the Microsoft Exchange Server can recognize. In this example, it is translated into Visual Basic Script (VBScript). The Microsoft Exchange Server processes the query and returns the information to the ZCom Data Handler which then translates the information into the compact ZML data language and encrypts and sends the requested information back to the Zenu Client where it is displayed in a Zenu interface on the client device.

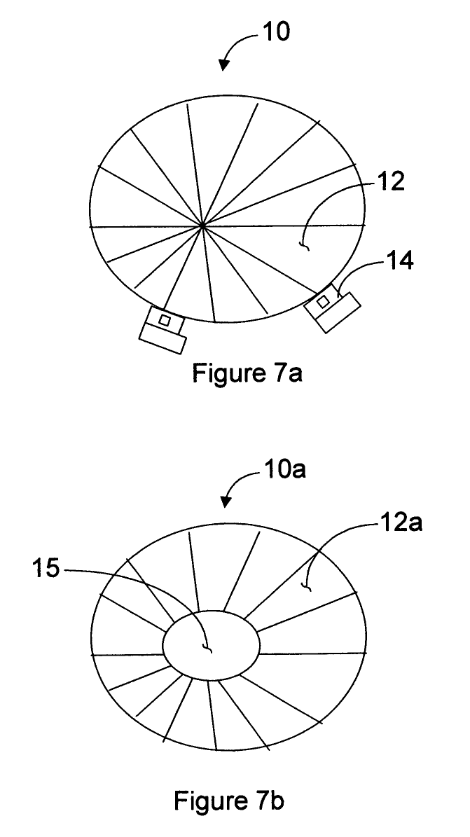

Some embodiments of the instant invention may be hosted on or otherwise employ devices having touch sensitive screens so that a user may indicate a choice by touching a region of a screen. However, other embodiments may use sensing devices outside a region of a display screen to accept user inputs. One aspect of the instant invention includes enablement of innovative user interface devices, such as illustrated in FIG. 7A, that may be used in conjunction with user displays of the instant invention. A user interface device such as illustrated in FIG. 7A may be implemented as a simple circular or elliptical disk 10 mounted on a non-rotating but flexible mount at its center. Disk 10 may contain multiple sensing regions 12, typically four to eight regions, which use capacitive position sensing or other techniques to sense a position of a user's fingertip, thumb, a stylus, or other appendage on various sectors of the disk. Four regions may be used, for example, to provide up or down, or left and right scrolling. Regions 12 may be implemented in hardware as discrete regions such as wedges, or may be implemented in software wherein position signals responsive to capacitive position sensing or other position sensing technology are compared to regions or sectors defined geometrically in software. Such embodiments may also change the number and location of regions to correspond to different modes of operation of software or a device being controlled through such user inputs. An embodiment of a user interface such as described herein and in applications previously incorporated herein may be used to present different menu choices to a user on a display device responsive to a user moving a finger, thumb, stylus, or other device about on disk 10. When a menu or other display of interest to a user is presented, a user may indicate a choice by pressing a corresponding region 12 of disk 10 so that a microswitch 14 or other pressure sensing device may be actuated to send a signal so that user interface software may present additional menus, or so that a selected action may be implemented on a local device or on a server or other host device which is in communication with a device held or otherwise actuated by the user. In some embodiments, in lieu of microswitches, regions 12 may use capacitive sensing or other technologies such as used on personal computer touch pads to be sensitive to one or more taps made by a user on a selected region. In some embodiment, it is desirable that a microswitch or other user selection sensing device provide tactile feedback, or audible feedback, to a user so that a user may not have to observe a display to have confidence his or her selection was received by the user interface device.

Another embodiment of an innovative user interface device is illustrated in FIG. 7B. In this embodiment, a circular or elliptical disk 10a may employ sensing regions 12a positioned around a central region 15. Sensors in regions 12a may be used to determine position of a user's finger, thumb, stylus, or other device and present corresponding displays as before; however, in this device, a user's selection may be indicated by a user tapping or depressing central region 15, which may employ a microswitch, capacitive sensing, or other technologies to send a selection signal to software responsive to user selections. As before, for some embodiments, it is desirable that central region 15 provide tactile feedback to a user, or that other portions of the user interface hardware and software provide audible feedback, to indicate that a user selection has been accepted by the user interface.

The following section now presents several examples how a Zenu interface and associated screens that may be used in Zenu displays developed using ZenuSuite capabilities to provide various workflow applications.

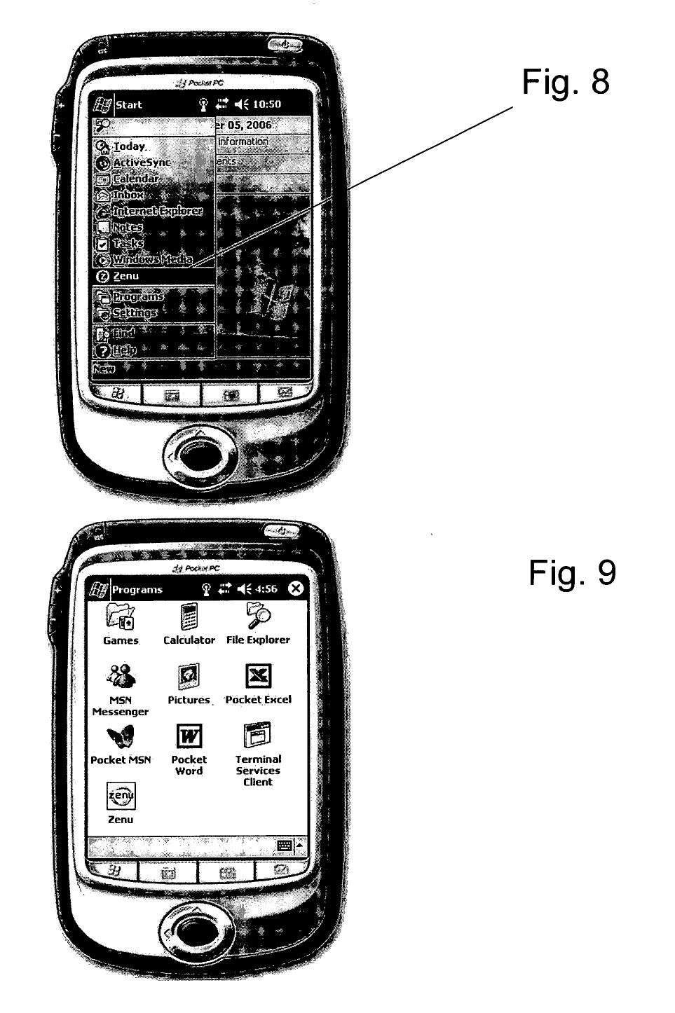

FIG. 8 shows an example of some of the applications that are available by selecting Start→Programs on a PocketPC powered device. After Zenu interface client software is installed on a handheld device, a Zenu icon will appear on this screen. In FIG. 9, the icon appears at the bottom left corner.

To launch Zenu, a user simply selects the icon with a single tap. As Zenu starts for the first time, it will prompt a user to provide a URL for it to use each time it starts. Either an end user or a system administrator will need to identify this URL as applications are designed. After the URL is entered it is stored in memory for future use. However, if there is a need to change the URL, the zcfg.txt file at the root directory of a device may be deleted, then Zenu may be restarted whereupon it will ask for a new URL. FIG. 10 shows how a URL prompt may appear when Zenu asks for a URL.

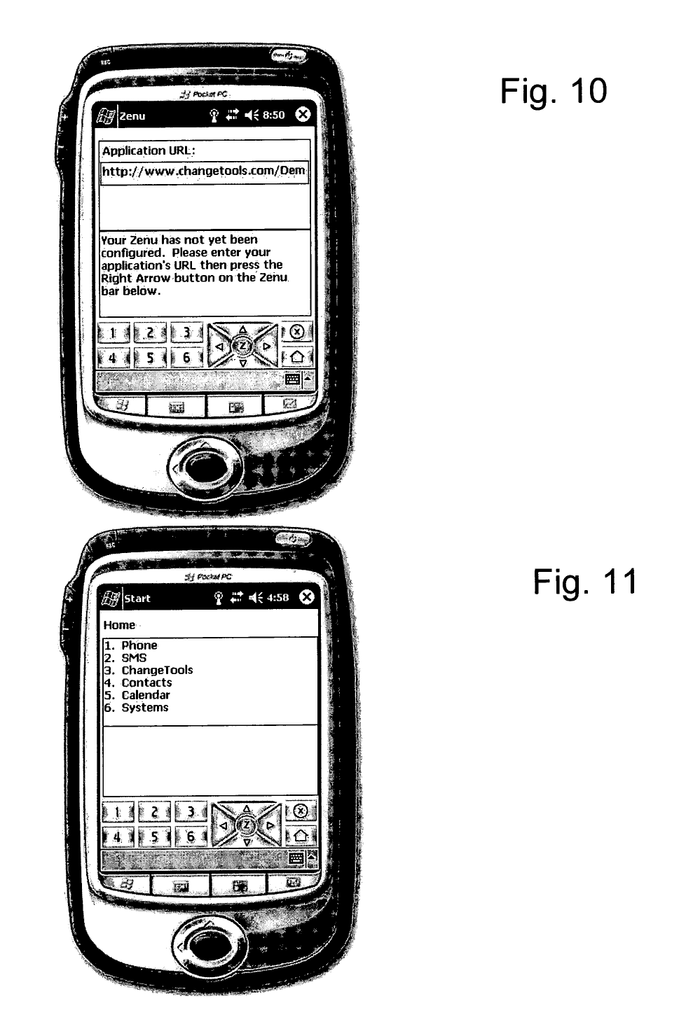

FIG. 11 provides another view of a Zenu interface. Zenu is easy to navigate because the row of buttons across the bottom of the screen remains constant through each layer of functionality as different layers are developed and presented.

In a typical embodiment, there are six numbered command buttons, 1 through 6, which may be seen near the bottom of the display shown in FIG. 11. These numbered command buttons directly correlate to listed menu items typically shown in the upper portion of a display screen, as visible in FIG. 11. Such menu items may be defined during screen development using ZTool. However, in some embodiments, relative positions of listed menu items and command buttons may be varied (e.g., listed menu items may be placed beside or below command buttons). Specific menu items presented to a user in a particular application depend upon their workflow needs.

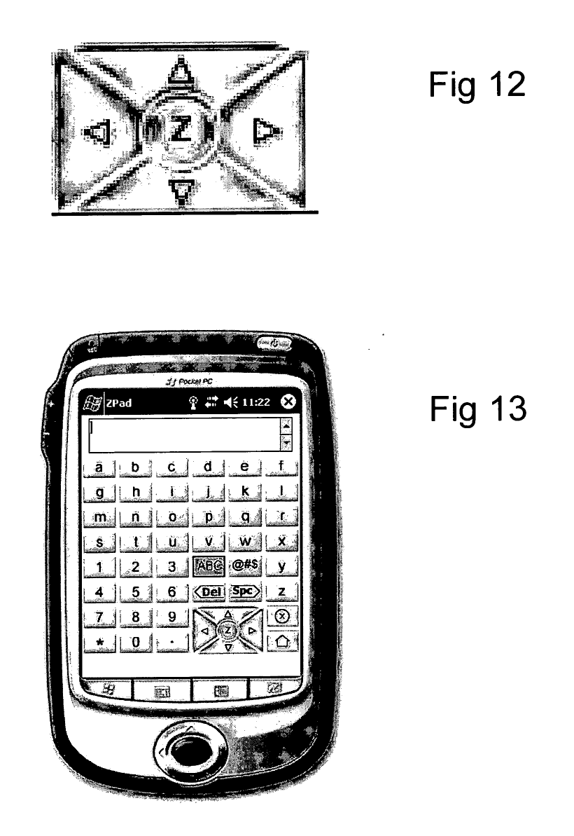

The command navigation center—a set of four command arrow buttons with a Z in the middle, as visible in FIGS. 10 and 11, is shown in a larger view in FIG. 12. Right and left command arrows move a user forward (right) and back (left) through application layers one at a time. Up and down arrows allow a user to move up and down on a display to access any additional information related to the menu items, six choices at a time.

The center Z command button in the command navigation center calls up the ZPad shown in FIG. 13, which is a full-sized keypad that may be used to enter information into any of various text fields that may be displayed. Such a keypad may be configured in a “QWERTY” or an alphabetical configuration.

The command buttons on a ZPad are large enough that a user can use a finger (instead of a stylus) to enter information to avoid problems of using or losing a stylus. In addition to standard alphanumeric and navigation command buttons, Zenu has a few special input features designed to minimize “keystrokes” needed by a user to complete the task at hand.

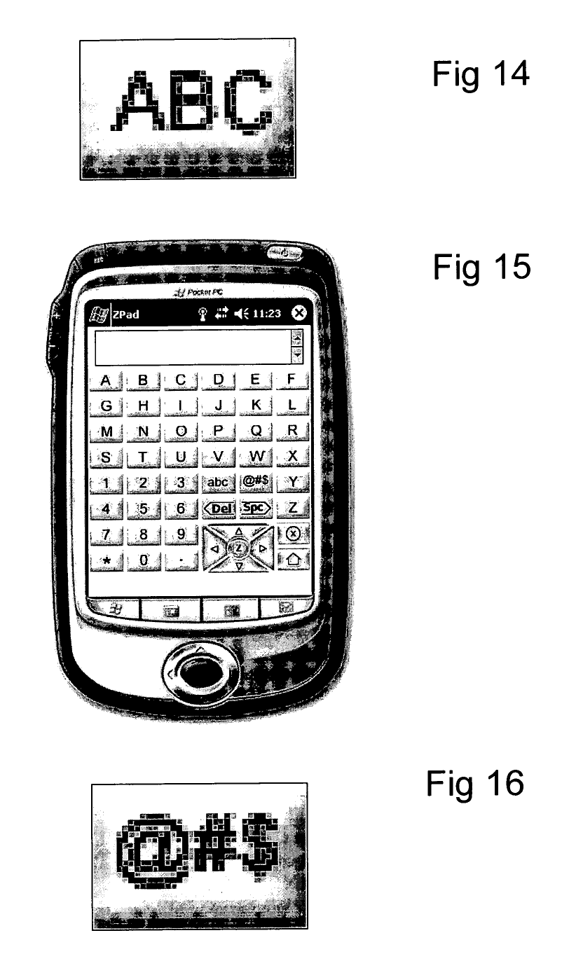

To capitalize just one letter, a user presses the “Caps” button (ABC) once, shown in FIG. 13 and in expanded view in FIG. 14, then presses the letter to be capitalized. Zenu automatically switches back to lowercase for subsequent letters.

When the Caps button is pressed the entire keyboard display changes to capital letters, as shown in FIG. 15. To type a string of text in all capital letters, the Caps button may be pressed twice in succession to leave the “Caps Lock” on while multiple letters are typed. Pressing the Caps button again turns off the Caps Lock mode and returns to lower case (abc) mode.

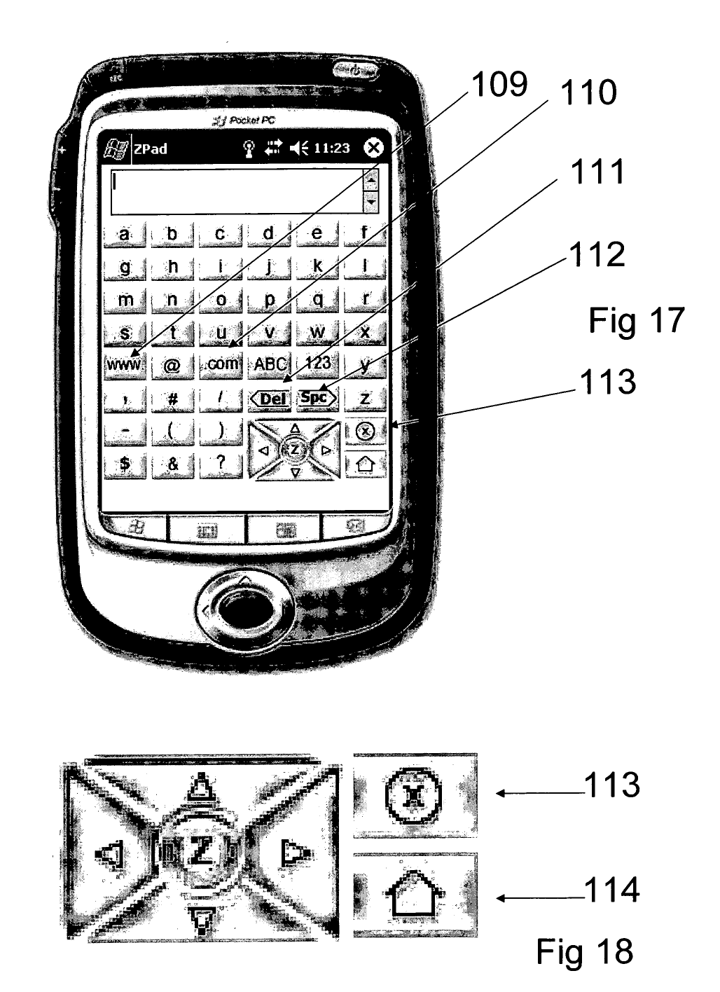

Similarly, a “Symbol Lock” button, as shown in FIGS. 13 and 15 and in expanded view in FIG. 16, may be used to switch in and out of symbols on the ZPad. When the Symbol Lock button is pressed once, the numbers (e.g., 123) on the ZPad are changed to symbols from which a user can select, as shown in FIG. 17. Available symbols include @, #, /, -, ( ), $, &, and ?. Pressing the Symbol Lock button again returns ZPad's symbols to numbers.

To input a Web site address, a user can quickly press the “www.” button 109, FIG. 17, while in Symbol Lock mode, and ZPad inserts the set of letters. Similarly, to enter an e-mail address, from Symbol Lock a user can simply press the “.com” button 110 and Zenu will insert the characters at the end of the address.

To erase something once entered, a user may click the “DEL” button 111 once for each character to be erased. The “SPC” button 112 may be used to enter a space.

A user may exit the entire program by simply clicking the “Exit command” button 113, shown in FIG. 17 and in expanded view in FIG. 18. When ZPad is displayed, the Exit button simply dismisses the ZPad without accepting any of the text that a user entered while in ZPad.

On every screen, there is a “Home command” button 114. This button may be used to return to the Home page from which Zenu starts.

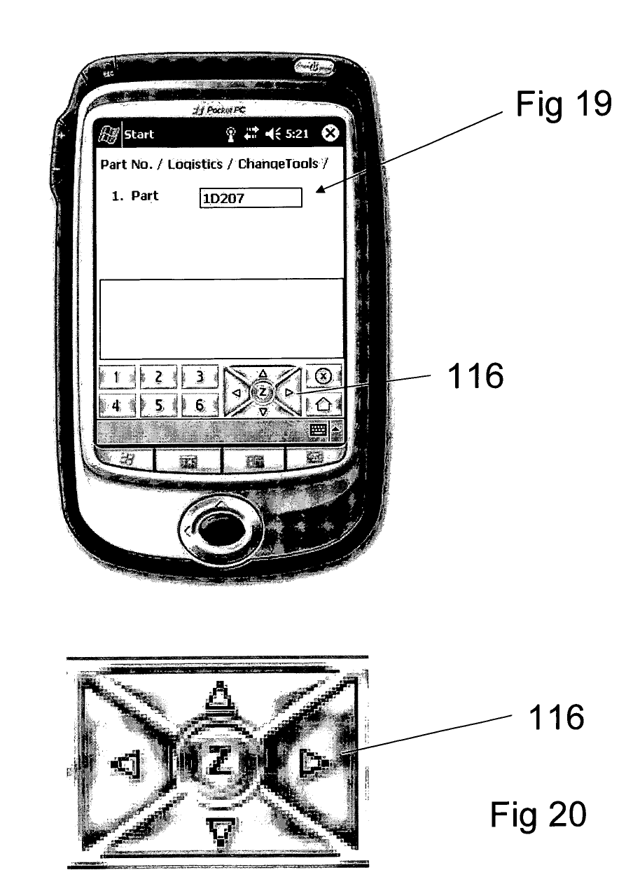

A user can observe information entered into a blank field on a screen. If text extends for more than one line, or more than the width of a blank field, the right and left command arrows in the navigation center enable scrolling through such text. When a user has finished entering information in a field (i.e., a part number or location), clicking the “Z” button again causes Zenu to accept the text. FIG. 19 shows a text box field for a part number.

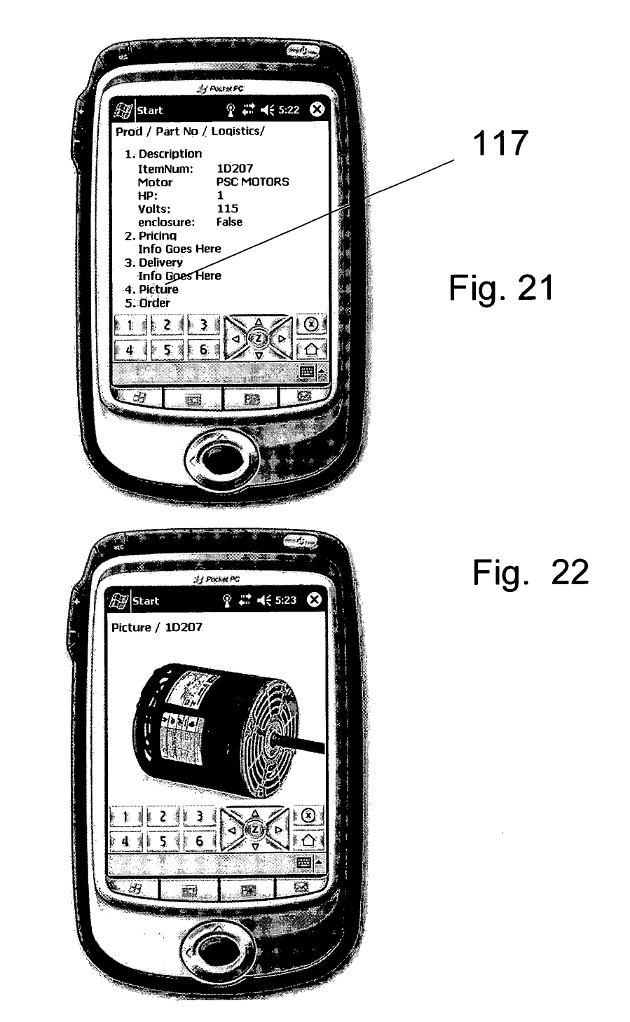

The right command arrow button 116, FIGS. 19 and 20, may be pressed to submit data and retrieve the information being sought, in this case a part description. FIG. 21 shows what a typical result might look like.

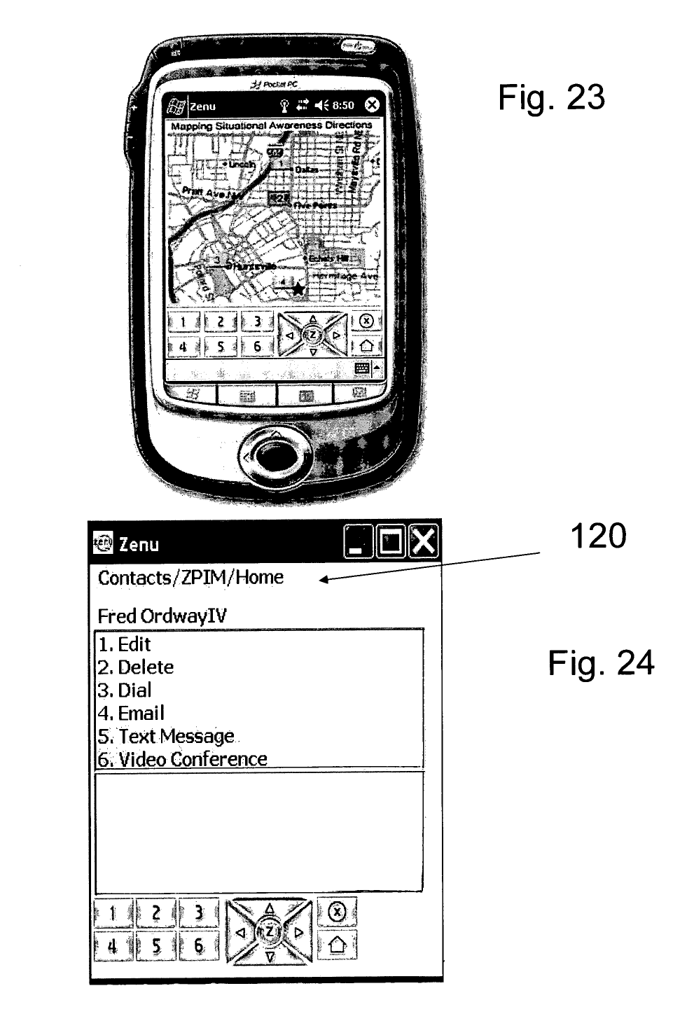

On a screen as shown in FIG. 21, a user may be given a choice 117 (e.g., #4) to see a photo of the part requested. Zenu can display an image, shown in FIG. 22, in black and white or in full color, as appropriate to a given application and hardware capabilities, simply by clicking the number 4 command button. Zenu can also display full color maps, as depicted in FIG. 23.

One issue for many users is knowing or remembering where they are within an application. As a user works through layers, sometimes he or she might forget exactly where they are and need a reminder or navigational aid. The Zenu interface and methodology enables a navigational aid called a “Breadcrumb,” which displays the directory path, enabling a user to quickly see where he or she is within an application and easily determine how to get back Home, Exit, or move forward or back. FIG. 24 shows an example of a Breadcrumb navigational aid 120. In this figure, a user could see that he or she is at the PIM (Personal Information Manager) layer within Contacts, within the ZPIM layer from the Home page. Note that the current layer is displayed at the left of the path, allowing a user to quickly know where he or she is within an application.

The following example shows a method by which a user or organization may design an interface for an application using ZenuSuite. Zenu is a powerful tool that enables easy implementation of sets of commands defined in layers. Zenu can have an unlimited number of layers which provide access to a wide range of commands from one single user interface.

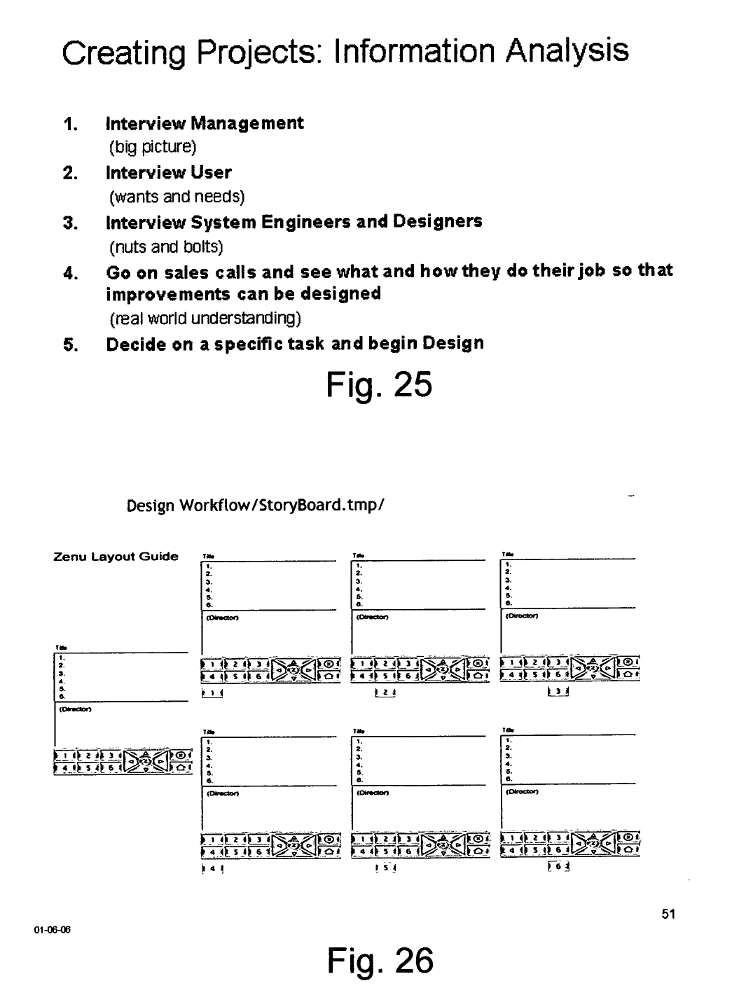

Design of a Zenu interface for a particular application typically begins with consideration of what is to be accomplished in a given task. In some cases it may be useful to create a storyboard-type map of interfaces to a given software application. FIG. 25 shows a representative flow of steps that may be followed to develop a design for using Zenu interface capabilities to help implement a workflow involving information exchanges between a user and a server. FIG. 26 shows a storyboard form that may be used to help to breakdown a workflow and define information to be included on each screen in a Zenu interface.

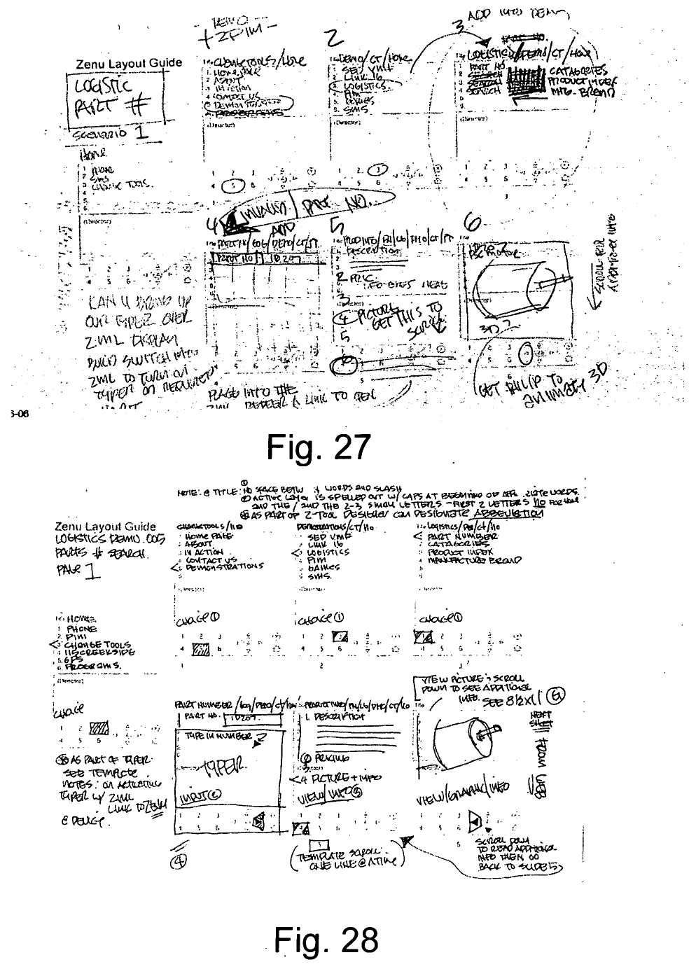

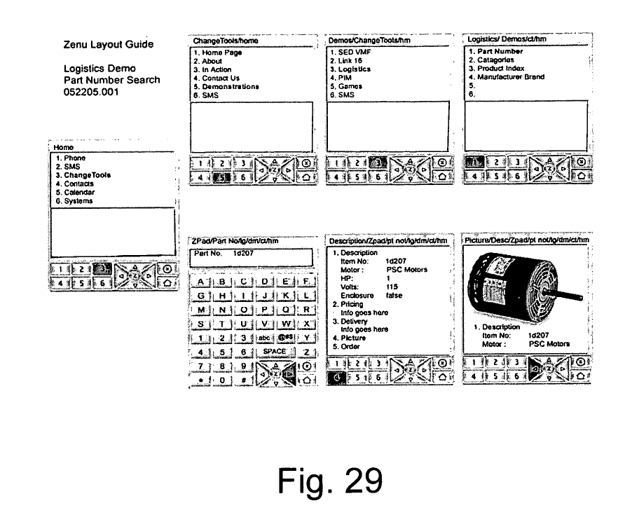

At this stage, the methodology is similar to a typical approach for laying out a Web site and includes defining, for example, information to be on a home page, links to other screens within an application, and information a user really needs on each screen for a given task or task flow. FIGS. 27, 28, and 29 show storyboard forms that may be used in developing a Zenu interface application in various stages of development as a representative example interface design is developed.

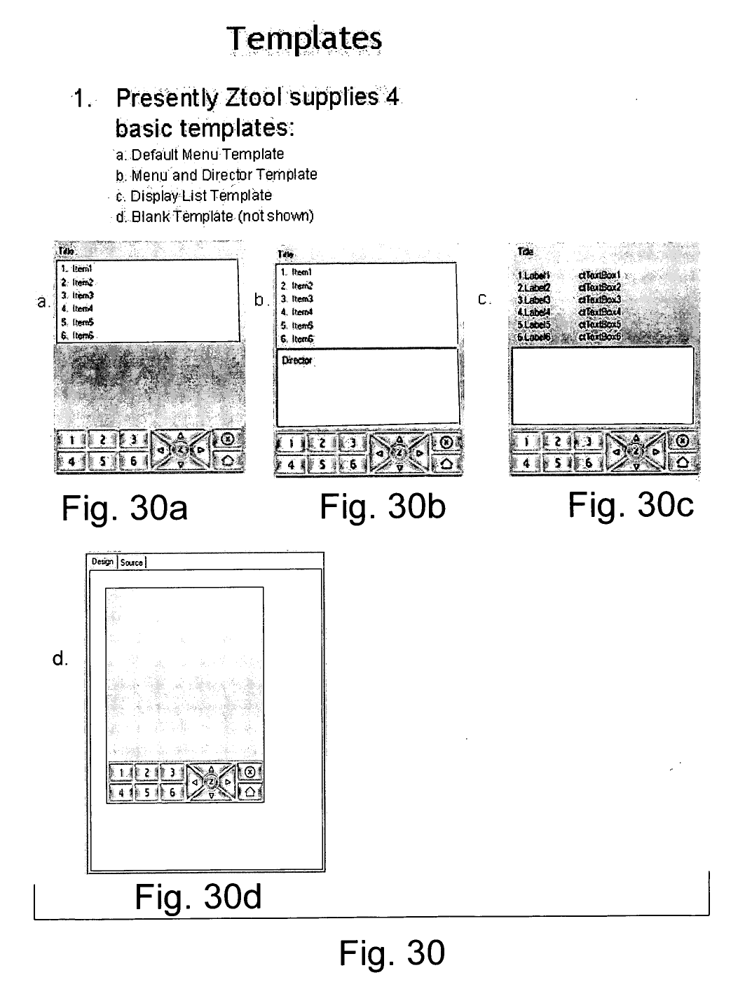

ZTool aids in the development and implementation of user interfaces for particular applications, while Zenu offers a simple, easy-to-use and always standard method of navigating and accessing information across all platforms, devices, and applications. In most embodiments, ZTool uses just four standardized templates, as shown in FIG. 30, to create a consistent appearance for a user and avoid demands on bandwidth to support non-essential graphics. By tailoring these templates, a using organization can quickly and easily design an interface that an end user can readily assimilate and use for a particular application and task flow. Each template uses the same set of standardized command buttons, some of which may be linked during design to particular tasks, and others that are “hard wired” to operate in a specific way.

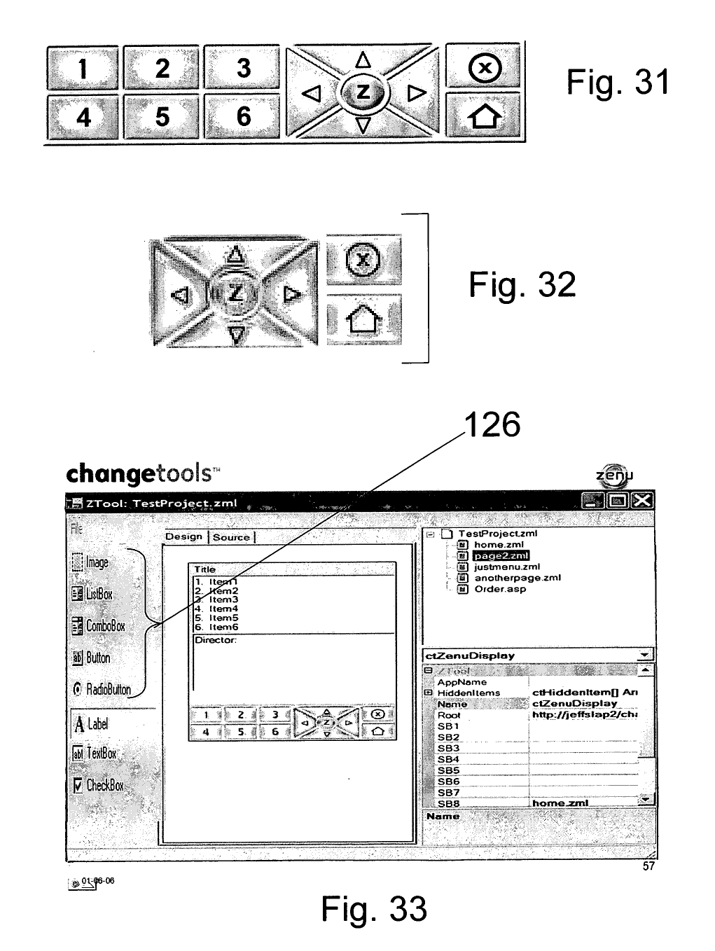

The six command buttons, shown in FIG. 31 allow an Zenu interface developer to anticipate user needs, employing a certain level of analysis to consider what a user needs to do and thus minimizing the number of clicks required to accomplish a given task. A developer can easily link specific tasks to each numbered command button, as explained in more detail later herein.

Zenu also has three control buttons that typically do not change. These include the Home and Exit buttons, and the navigation center with its embedded “ZPad” button. These buttons appear on Zenu as shown in FIG. 32. The “Home” button icon is a house; the “Exit” button is an X, and the ZPad button is the Z in the middle of the command arrows.

In a typical embodiment of the instant invention, an early step in designing a Zenu interface for an application involves defining what URL to use as the starting point for the application. When Zenu first initializes on each handheld device, it will ask for a URL. This URL provides access to the Root address, typically on a server, where all the processing for the application takes place.

As noted, ZTool provides four basic templates to create Zenu screens, as were shown in FIG. 30. While a developer in a using organization may modify any aspect of the elements included in a template, typically the appearance of the numbered buttons or arrows located at the bottom would not be modified so as to preserve the look and feel of the Zenu user interface. Making such modifications would eliminate the benefit of a common look and feel to the screens.

Next, a developer of a Zenu interface would typically consider what information to present to and ask for from an end user. For example, does the screen need a text input field, perhaps for entering the name of a suspect, or a part number? Will it need an image box, to display fingerprints, schematics, or other photos? Does it need radio buttons or checkboxes to help a user quickly select an option? How many menu items or options are needed to present information to the user on this screen. Screen content is typically limited to six items per screen. Each numbered menu item or option tracks to a numbered command button on the Zenu interface, which is always displayed at the bottom of the screen. The default Zenu templates may be modified using ZTool or another forms editor to design screens while preserving the standardized interface.

Once the number of menu items or options are defined for each screen, separate templates may be selected and tailored using ZTool, which may be implemented using a screen editor such as available in Microsoft Visual Basic, as shown in FIG. 33, and using various design elements 126, so that each button on a given Zenu screen calls the next display screen needed to implement a given task flow when pressed. For example, if menu selection “1” is designated as “Addresses” a template that includes address information may be configured to be downloaded from a server and presented to a user when “1” is pressed on that display screen. The interface will display on the screen of a particular Zenu-enabled device the way the screen was formatted in the modified template. Additional information about how to program the buttons and other interface features is presented later herein.

In a typical embodiment, Zenu interface enabling software running on a particular handheld device or other platform only recognizes text streams containing ZML. A strength in many embodiments where a Zenu interface is used for a particular application is that Zenu software on a typical user platform accesses a network and then accesses files and applications stored on one or more servers. Thus, changing information available to an end user is a simple matter of updating files on a server. Before a Zenu interface can be enabled for a particular application, however, a developer in a using organization must create the files and paths needed to access the data. It is also possible to have a number of screens generated programmatically from within an application, if needed. This functionality can be useful for adding dynamic content to screens (e.g., displaying information from a database).

The use of ZML tags and ZTool are described next. As noted, in a typical embodiment, Zenu only accepts and understands data in ZML format. ZML is a proprietary implementation of XML. ZML uses element tags to specify controls that are placed on a given display screen in order to display information or allow a user to enter data to be used by an application. Data entered into these controls may be transmitted back to the server when a user selects one of the Zenu command buttons on a particular display. The following table contains a list of element tags that are currently supported by Zenu.

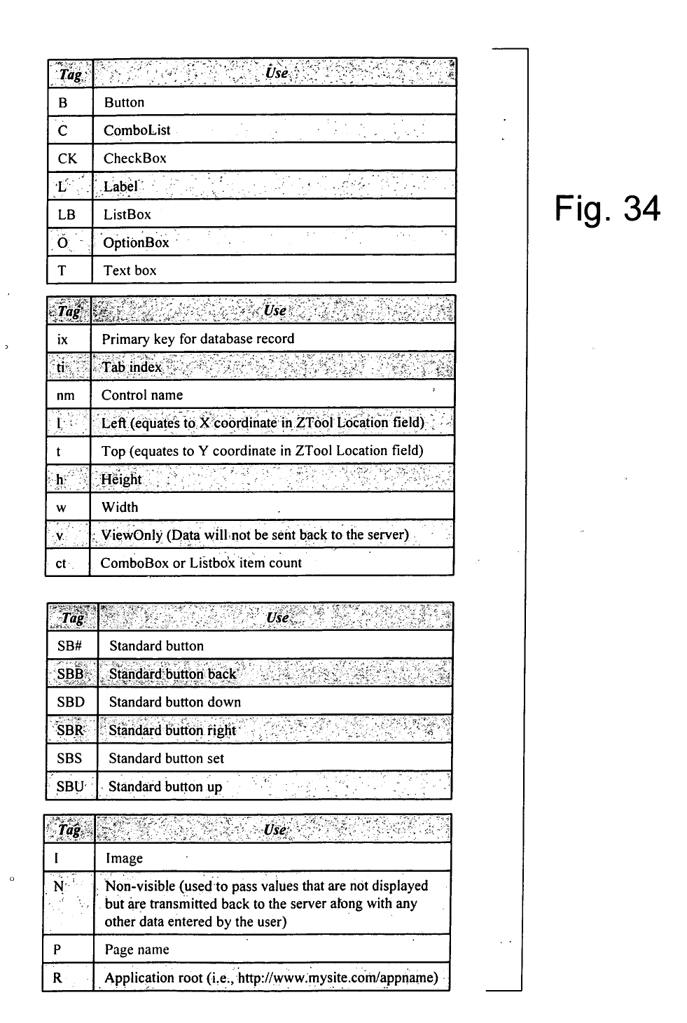

Property tags are used to modify or define the behavior and appearance of an element. These properties are included within the definition of each element tag. Properties control certain aspects of an element such as giving it a name and specifying the element's position and size within a Zenu interface. The table shown in FIG. 34 contains a list of the property tags that are currently supported by Zenu. All ZML tags are copyrighted by ChangeTools, Inc.

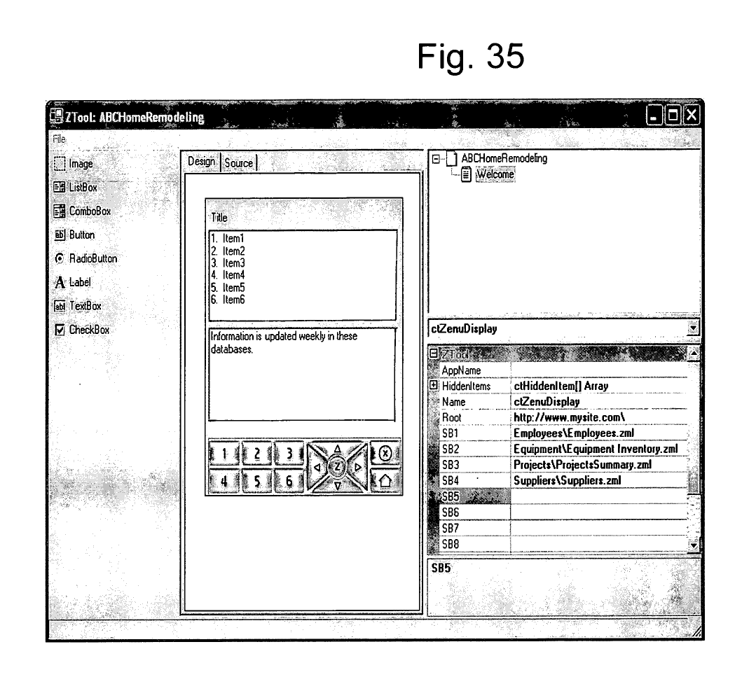

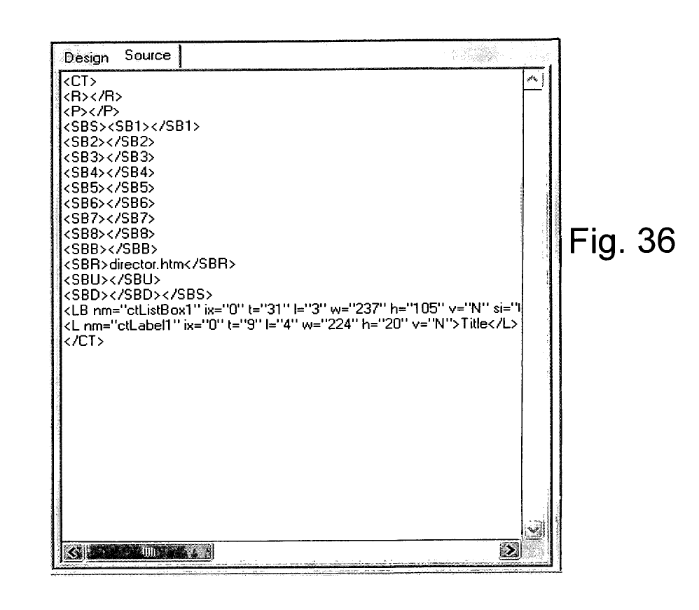

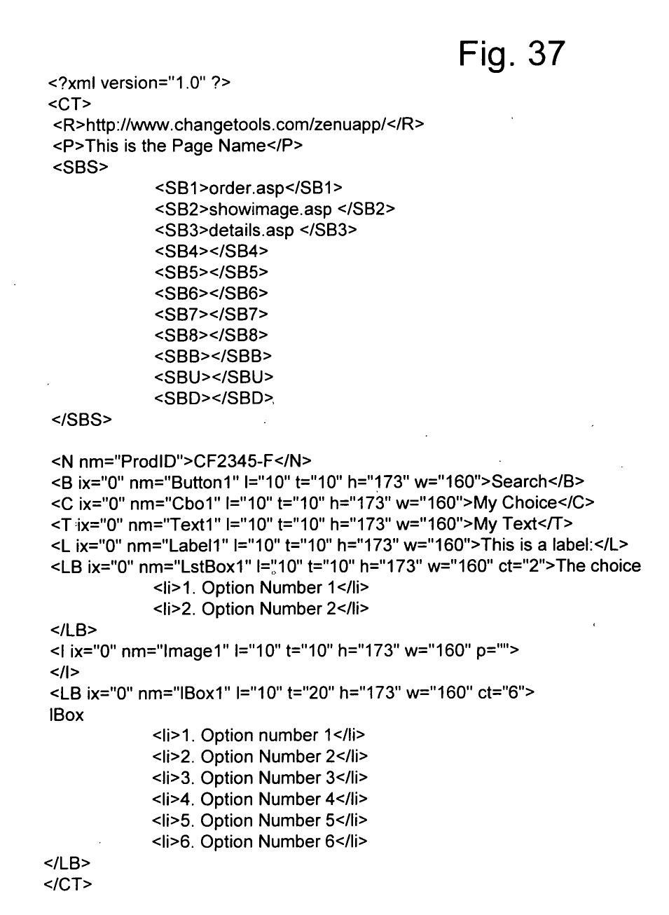

Standard Button tags are used to tell Zenu what to do when a user clicks one of the Zenu Command buttons that are always displayed on every screen within an application. The action for each numbered command button can be coded by including an action string within one of the standard buttons tags SB1 through SB6. The four Zenu Command Arrow buttons can also be coded using the SB_tags shown in the table in FIG. 34, using screen editing capabilities of ZTool shown in FIG. 35. In addition to the ZML tags described above, there are four other tags, I, N, P, R that are recognized by the Zenu application, as also shown in the table in FIG. 34. A typical ZML file looks like the examples shown in FIGS. 36 and 37.

ZTool was created to help a Zenu interface developer accomplish two basic tasks: design workflow and create ZML. While creating and managing ZML could be complex and difficult, ZTool simplifies the process. A developer can easily create, change, and maintain these ZML templates with the ZTool's help. This following section describes how ZTool may be used to help develop interfaces for applications customized for particular needs.

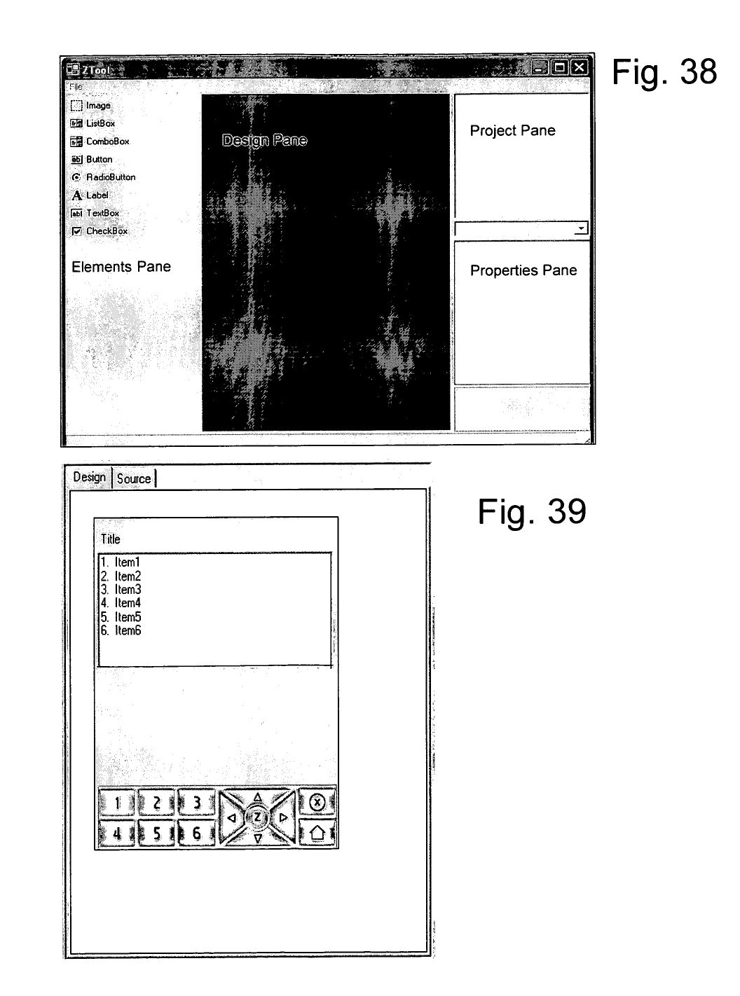

FIG. 38 illustrates the first window shown when ZTool is started. The window includes four areas. To the left is an Elements Pane that a Zenu interface developer can use to select display elements that he or she would like to place on a template (the dark gray area in the center of FIG. 38) to create a screen for a particular user interface. The center dark gray area is a Design Pane, where a template will display as it is developed or modified. The upper right area is the Project Pane, where the name of a project and its associated pages are shown in a directory tree format. The bottom right area is a “Properties Pane,” where properties of the selected screen element will be shown. Each time a different element is selected and placed on the template, the Properties Pane will update to reflect the properties for that element.

As shown in FIG. 39 two tabs are contained within this one pane: “Design” and “Source.” The Design tab selects a display of an interface screen design as it is developed. A screen is designed and developed in ZTool by dragging and dropping elements into place, modifying the text labels on elements, and moving elements around within the display space. The Source tab allows a developer to see and edit the ZML file created by ZTool as elements are positioned and modified in the Design window.

Four default page templates, shown earlier in FIG. 30, are typically used as a basis for customized interface screens, but more or fewer templates may be implemented in a particular embodiments. The four typical templates include:

Menu

Menu with Director

Displaylist

Blank

These templates may be modified in any way that meets the needs of a particular application, to create the best interface for an end user. The command buttons and arrows on the command navigation center at the bottom of the page typically remain consistent from page to page and should not be modified by an end user or interface developer, so all navigation is consistent. This enhances an end user's ability to assimilate the information, rather than wasting time remembering or figuring out what he or she needs to do next. This simplification in turn enhances an end user's situational awareness for the tasks at hand.

The “Menu” template (FIG. 30a) provides a generic way of making a quick list that will initiate an action. To develop a customized interface based on this template, a developer simply renames the numbered menu items (from within the Properties pane), and then assign a file or script file to each corresponding button. Then when an end user selects a numbered button at the bottom of the screen, the associated action will occur.

The “Menu with Director” template (FIG. 30b) adds a Text Box Element under the menu where a developer can provide some additional information to help an end user understand what to do next. The box has a white background to highlight the information more readily to a user.

The “DisplayList” template shown in FIG. 30c provides a developer with six numbered labels and six text boxes. Each of the numbered items is associated with a numbered button at the bottom of the page.

Another default template, shown in FIG. 30d, is “Blank,” which provides a developer a blank template, with only the command buttons, command navigation center, and Home and Exit buttons, from which a customized display may be built. Using the Blank template, a developer can develop an interface screen to display any type of information needed for an end user. This includes photos, documents, user information, mapping, schematics, and more.

In a typical application of a Zenu user interface, all data for the display screens, including the format and content, comes from a server. In such embodiments, whoever manages the server can manage what is displayed on the devices used by end users.

The Source tab displays the ZML code that ZTool writes as a developer defines an interface screen, as was shown in FIG. 36. An interface developer can directly modify source code in this pane, if desired, and the properties for the element will be updated in the Properties pane. In those embodiments where Zenu understands only ZML, all applications must communicate with Zenu interface software using ZML tags.

The various elements that may be used to design an interface are described next. The elements from which a Zenu interface are designed include text or graphic boxes similar to those used in Windows, so a developer can drag an element onto the template, or select a box already positioned on a template by clicking on the box. As with text and graphic boxes used in Windows, a developer can resize it by selecting it and grabbing one of the small box handles on the sides or corners, or a developer can specify a size in the Properties pane for the element. Deleting an element is a simple matter of selecting it and pressing the Delete key.

Elements 126 used in a typical embodiment of ZTool appear to the left of the ZTool screen, as show in FIG. 33. An “Image” box may be used to display most types of graphics or photos in a particular display screen. Acceptable file formats include bitmap (.bmp), JPEG (.jpg), and GIF (.gif). A “ListBox” is used to create a series of labels that may be used to describe the selections from which an end user may choose. The numbered list can then be linked to the numbers at the bottom of the template. A developer can add or delete individual list boxes as needed. A “ComboBox” enables a developer to create a drop-down list of choices for an end user to select from. “Buttons” are “raised” buttons a developer can create on a template.

A developer can add a button to a template for a display screen that enables or launches a specific script file to cause an action. For example, an interface developer may use the Button element to include an extra option for an end user to select beyond the six command buttons that are always available in many embodiments. “RadioButtons” are labeled options that have a blank round button that an end user can select. In a typical Zenu embodiment, an end user may only choose one radio button on the screen, or within a group, at any one time. A developer might want to use a series of radio buttons for an end user to select a specific option, then select a numbered button or a tailored button added to the page. All radio buttons on a template are generally connected. The “Label” element provides a means to place text within a template that does not call for an action. This element merely displays information to an end user. The “TextBox” element, unlike a Label element, allows an end user to enter text into the field to be passed back to a server for action. For example, if a police officer needs to run a license plate check, he or she can type in the information in the text boxes a developer designs for the officer to use on a handheld or other interface device. The “CheckBox” element creates a label with a small square box associated with it. When an end user selects the box, a check mark appears in the square. Unlike radio buttons, more than one check box may be selected at the same time.

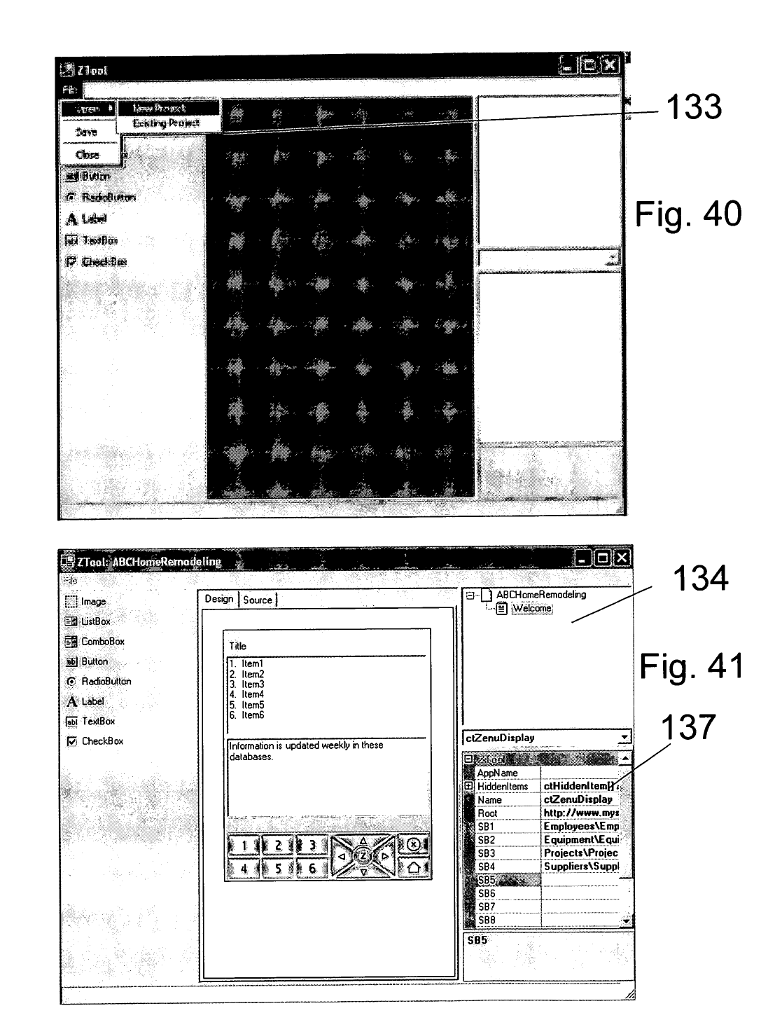

ZTool uses a tree structure similar to Windows for its directory. When ZTool is first opened, the Directory pane will be blank. To open a new or existing file, a developer selects File|Open, then New Project or Existing Project 133, as shown in FIG. 40. ZTool will then display a directory tree 134 similar to those found in Windows products, as shown in FIG. 41.

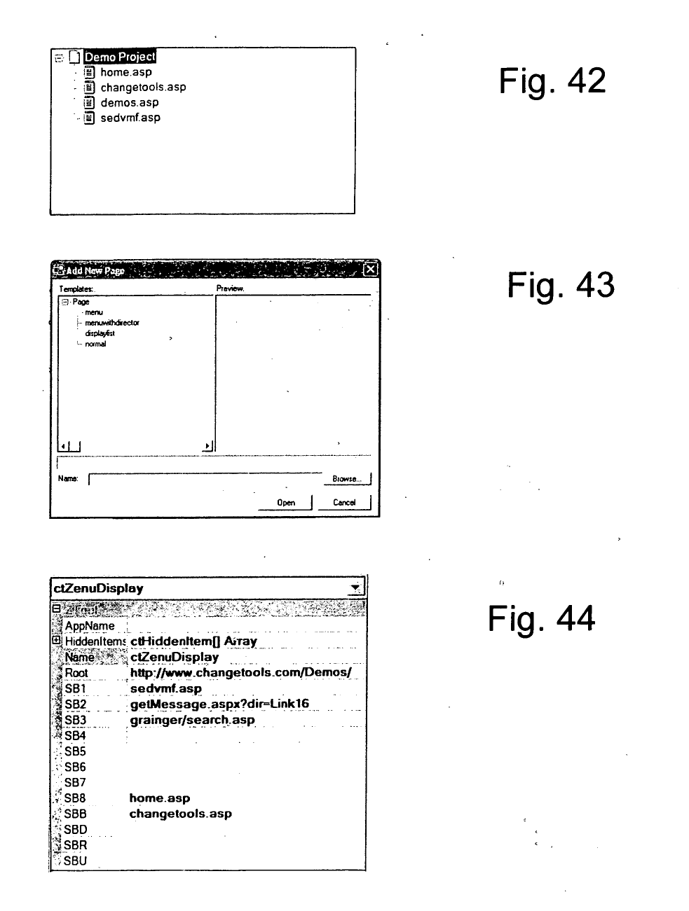

Note that beside the Demo Project item are two icons. The first is a minus sign (−), and the second a blank page. The minus sign toggles the directory display in a manner similar to Windows directories, where a minus means the lower level has been displayed, as shown in FIG. 42, and a plus (+) that there are pages hidden. The blank page icon indicates that this is a high-level directory. Notice that the lower levels show a page with text on it, showing those that have “writing” on them in the form of elements and information.

When template files are named, an extension, such as .zml, is typically added to the name. When pages for additional display screens are to be added to a Project, a developer merely needs to right-click on the top level directory, which in this example is Demo Project. A pop-up window opens and asks if the developer wants to add an existing item or add a new item. See FIG. 43 for an example of the Add New Page Window. A developer will need to tell ZTool which kind of page the developer wants to create and then give the new page a unique name. To save a Project somewhere other than the default directory, the Browse button may be used to find the preferred directory.

After a developer has chosen the kind of template to create, and assigned the directory and name, he or she selects Open to begin. Selecting Cancel exits the dialog box without changes and returns control to the main ZTool window. Once a developer has created a template specific to a given application, the template can easily be added to and reused within other parts of an application or in a different project. This may be done by right-clicking on the top level of the directory within a project, then select Add Existing Project. A dialog box will appear displaying available templates a developer can choose from in existing projects.

The lower right pane displays properties for any selected element. In this pane a developer uses ZTool to define how a user interface and hence a server based application will respond when a user selects a numbered button, or any other defined element. For example, FIG. 44 displays some of the properties of the current template. These properties may be seen when a Zenu command button is selected within ZTool. Each element also has a unique set of information that can be controlled in the ZML produced by ZTool. The Properties pane allows the system designer to set properties for any element within the template. The “AppName” property is for labeling this information so that the creating developer or another developer may know what a particular group of tasks is accomplishing. “HiddenItems” lists information that is in the background from an end user's perspective. These hidden items carry information that may be needed by the server-side application, but are not displayed to an end user. The fields are transmitted to the client (Zenu) by the application, and are then retransmitted back to the server along with any other information that was entered by an end user within the visible elements of a user interface screen.

Referring back to FIG. 41, the series of SB1-“n” fields 137, FIG. 41, correspond to the numbered buttons on a user interface screen. In the example in FIG. 41, the SB1-4 fields correlate to the numbered buttons on a user interface screen. The SB5-8 fields are blank. The SB7 field will allow accept changes, but may not use them. In a typical embodiment, Zenu uses the SB7 button as the Exit button only, no matter what is entered in this field.

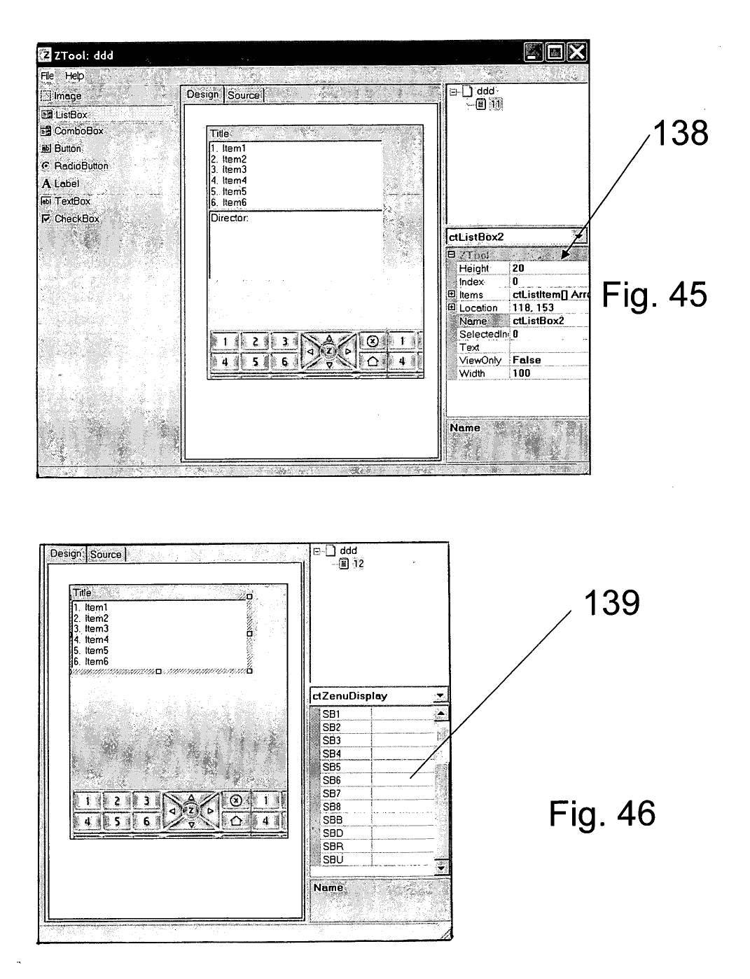

Each element, when selected, will display a different group of properties 138, FIG. 45, that a developer can tailor. These include specifics such as height, width, left, top, etc., some of which are shown in FIG. 45. Some elements have a “Text” field, where a developer can provide text that will display on Zenu's screen.

The “Root” field is used to tell Zenu where related files for a given application are located. This can be either a URL or a path on a particular computer, e.g., the computer being used to develop a user interface. The format is typically http:// or https:// or file:// followed by the path to designate the main directory. A slash (/) is generally added to the end of the root address.

The “Name” field tells a developer what a specific element is called. As may be seen in the previous figure, the element in this figure is called ctListBox1, which may be selected by clicking on the List Box element within the template. Element properties include height, width, and location, while Template properties include the SB# and the Root. This allows a developer to determine what aspect of the template or element is being modified.

The “Height” property allows a developer to specify exactly how many pixels tall an element will be when displayed by Zenu. However, by dragging an element onto a template and resizing it, ZTool will automatically fill this property with the correct value.

The “Location” field displays the precise horizontal (X) and vertical (Y) coordinates of the element within a template. A plus (+) sign next to Location that allows a developer to expand the field to display the values, or shrink the field when the plus turns to a minus (−) sign. Once again, while a developer can enter these coordinates, it is generally easier to drag an element onto a template and let ZTool fill in the coordinates.

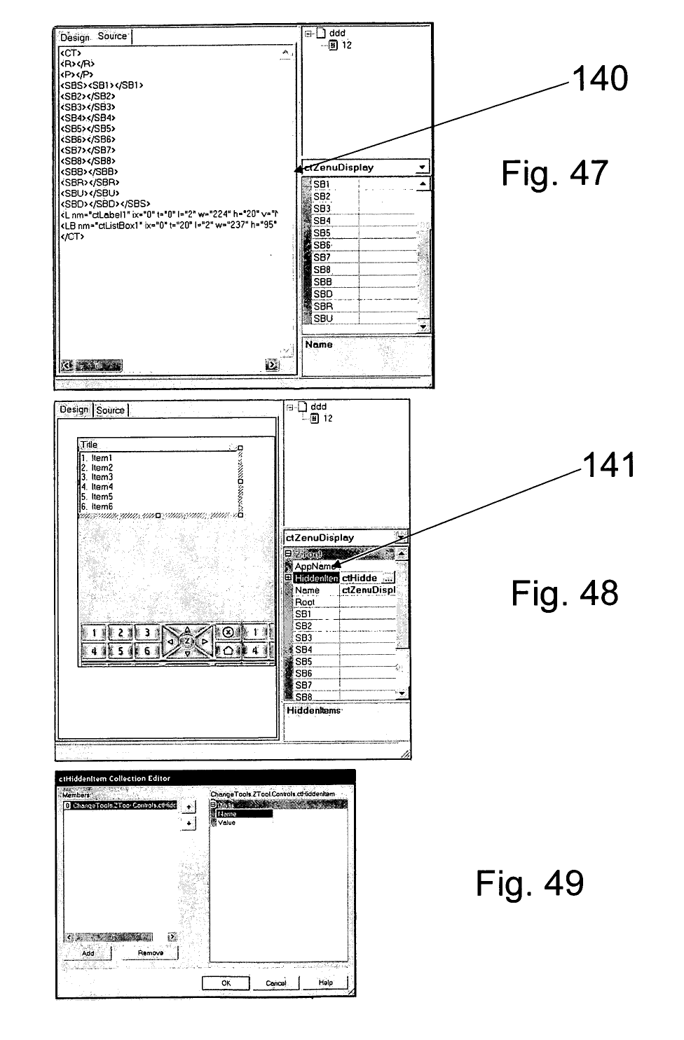

The command arrow buttons also correlate to fields. SBB is the left arrow; SBU is the up arrow; SBR is the right or Forward arrow; and SBD is the down arrow. (These fields are below the bottom of the Properties pane 139 in FIG. 46.) The action string 140, shown in FIG. 47, of all the command and arrow buttons, is used to tell Zenu which template to load next, and therefore must be a ZML file as that is the only language that Zenu understands in a typical embodiment.

In some elements there may be a field that has a plus sign beside it. Clicking on the plus allows a developer to access the next level of items. In the case of the ListBox, ComboBox elements and the HiddenItems collection, however, when a developer clicks on the plus sign an ellipse ( . . . ) appears to the right of the field. Clicking on the ellipse displays the “HiddenItem Collection Editor” 141, FIG. 48, that a developer can use to add and remove items (also known as Members) from a collection. If no Members are listed when the window opens as in FIG. 49, a developer may select “Add” and then add a “Name” and a “Value” for each Member to be added. A Member may be removed by selecting the Member to be deleted, and then selecting “Remove.” In one of these elements, the Name is the field's name for the application to use. The Value is used to store an important value to be sent back to the server when the data for a particular user interface screen is transmitted. A hidden item may be created in ZTool without a value if the application is going to automatically fill in the value when the application runs.

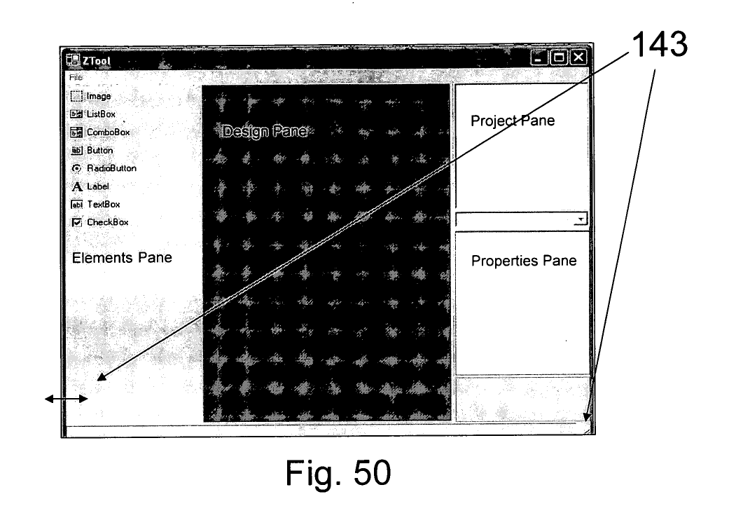

The ZTool window is very flexible. The default vertical panes 143 of the window between the Elements list and Template display (shown in FIG. 50) may be re-sized. The Page display and the Properties and Directory panes may also be re-sized. To resize a window, a mouse cursor may be positioned over the vertical border to the left of the Properties pane, until it becomes a left-right arrow, then the border may be dragged left or right to the desired size by clicking the mouse button and moving the mouse to drag the border to the desired location. FIG. 50 shows ZTool window panes resized to show the entire Properties pane entries. When the vertical border is dragged, the right-hand outside border does not change. Rather, the Design pane resizes. Similarly, when the properties labels in the Properties pane are re-sized, dragging right moves the display of the values for the individual properties out of view, and dragging left hides the labels. The Elements pane functions in the same way.

A developer has the power to create and manage a user interface with an application to suit end users' specific needs in a given task flow. No more trying to adapt a user to a new application—the Zenu interface methodology and tools allow the interface to a new application to be adapted to provide an interface the user is already familiar with and ready to use.

ZenuSuite comprises several tools that, separately, perform disparate functions, but together provide a capability to develop and implement real-time, wireless connectivity and interfaces between users and applications, which may be hosted locally or remotely on a server. ZenuSuite typically includes a client application on a handheld device (Zenu interface software), an interface language (ZML), and an infrastructure (ZCom) that allows all the components of the ZenuSuite to interact.

This capability is unlike other solutions in two key aspects. First, a ZenuSuite solution does not require proprietary or third party hardware/servers or software for the ZenuSuite to work. ZenuSuite offers this capability directly to existing applications and integrates seamlessly within their native environment. This is unlike other solutions where a organizational user must field proprietary or third party hardware and software within their infrastructure or outsource to outside companies. ZenuSuite enables an organization to control its applications directly, as well as save time and money on the corresponding maintenance costs.

Second, ZenuSuite works across a variety of applications (regardless of whether the applications are Web enabled). ZenuSuite may be used to build various solutions, including connections to a relational database. In another example, a Zenu Personal Information Manager (ZPIM) may be used to connect corporate e-mail and scheduling applications to provide an ability to retrieve information from controlled access storage and interactively display the content.

The example for the Zenu Personal Information Manager is outlined as follows:

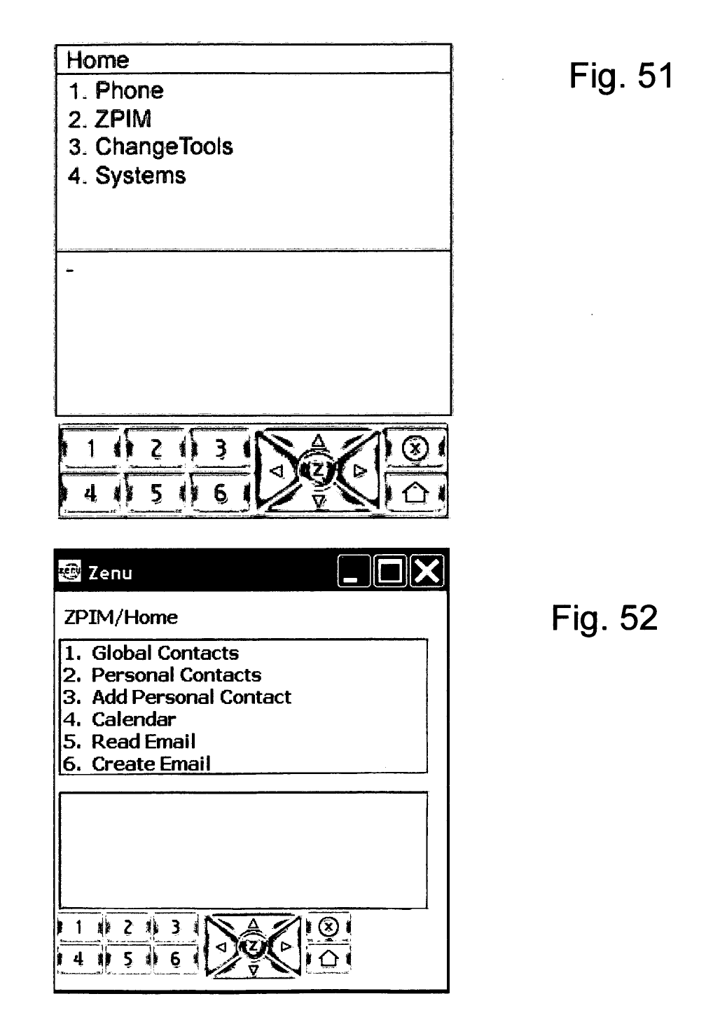

After downloading Zenu (as discussed earlier) and entering your login and password, Zenu Home appears as in FIG. 51. The choices in this menu list are completely user definable and can be reduced or expanded to suit the user. In this example is illustrated the task of entering a new contact within the ZPIM application. In this case the user selects item 2 and presses the 2 command button on the Zenu to launch ZPIM, resulting in display of the screen shown in FIG. 52.

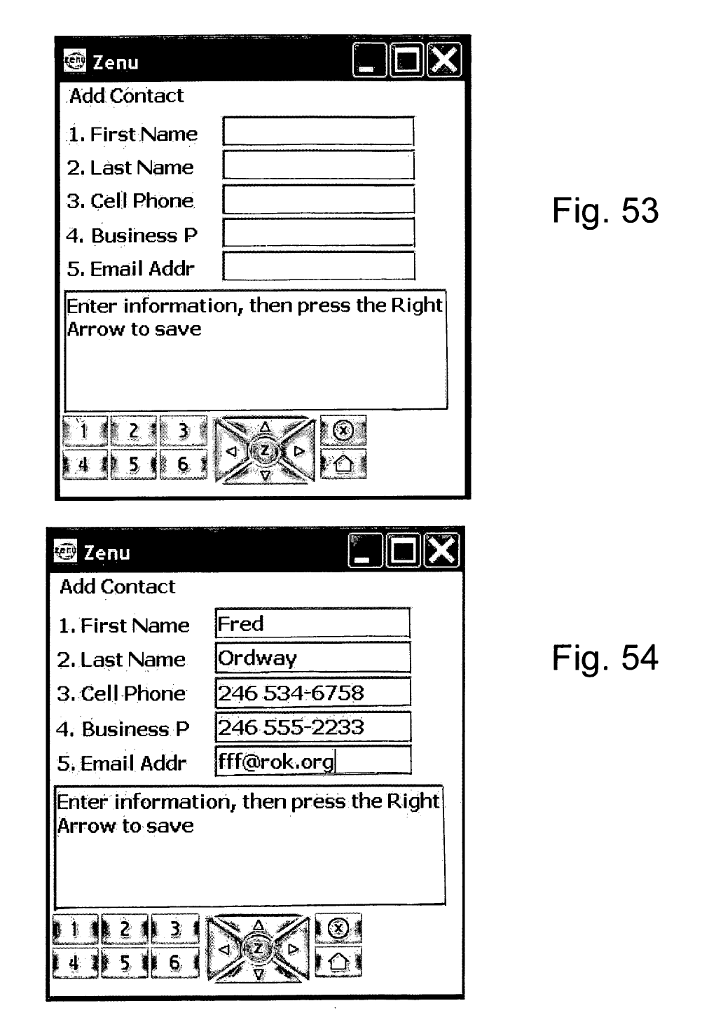

The user then selects item 3 from the menu list (FIG. 52) by pressing 3 command button on the Zenu—selecting Add Personal Contact. After each selection the forward or right arrow is pressed on the Zenu command navigation center, as described earlier, resulting in display of a screen as shown in FIG. 53.

The blank fields in FIG. 53 are presented to the user for completion by either bringing pressing the Z button in the command navigation center to bring up the ZPad, as described earlier, or by using the keys on any information appliance having a keypad to input the desired information.

When all the fields are completed, as in FIG. 54, the user can press the forward or right arrow on the command navigation center to accept the entry. By pressing the forward arrow the information is updated (i.e., transmitted) to the remote server.

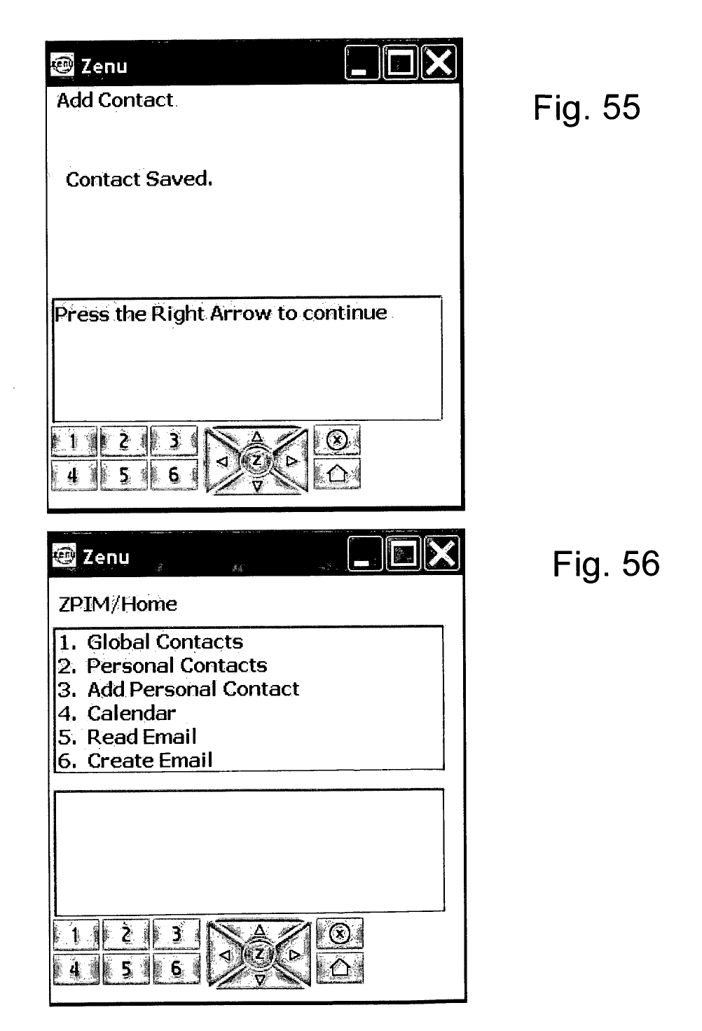

The confirmation is received as shown in FIG. 55 after pressing the forward or right arrow that the information as entered has been saved and is available at the server.

Upon completing this Add Personal Contact task, the screen returns to ZPIM home, as in FIG. 56, and is available to receive further instructions.

ZenuSuite tools help integrate working components of a user interface system to provide the Zenu interface capability. To support the development of a robust interface system that can support multiple user needs, the Zenu software and ZCom work together on multiple devices, over multiple communications infrastructures, using disparate communications paths, and multiple communications interfaces.

ZCom provides an infrastructure for a ZenuSuite environment. The ZCom infrastructure connects the Zenu real-time interface software, the ZML data exchange language, and applications via the communications infrastructure. The ZCom infrastructure for communicating between a Zenu enabled device (i.e., a device running Zenu real-time interface software) and an application, which may be hosted on a remotely-located server, to exchange real-time information, and provide the required functionality of the Zenu interface system, is described further below.

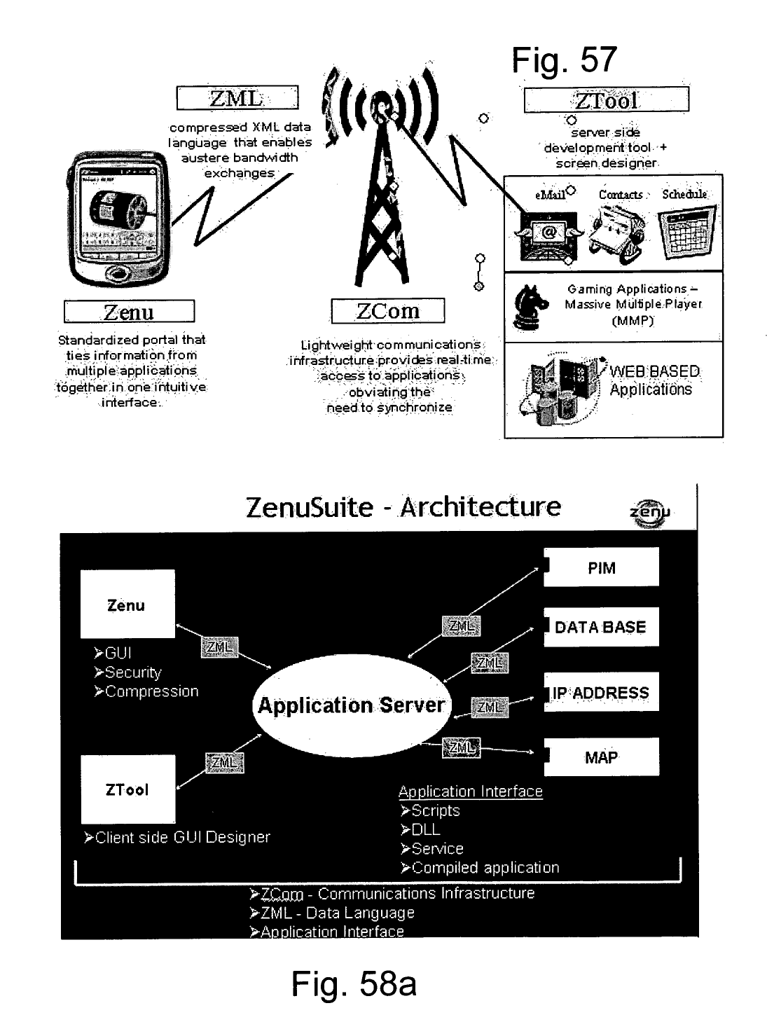

As shown in FIG. 57, the Zenu real-time interface software receives information in a ZML format via a communications interface. As noted earlier, ZML is an XML compliant data language. In a typical embodiment, the Zenu display software reads the ZML and displays menus, controls, and content information in a user interface screen according to format and content information included in the ZML.

The ZML information may be distributed via public or private wireless computer networks or over the Internet via existing or custom communications infrastructures to or from a server. The communications infrastructure may comprise an existing network such as a wireless or wired network. The network may use communication paths that direct traffic over private or public network links.

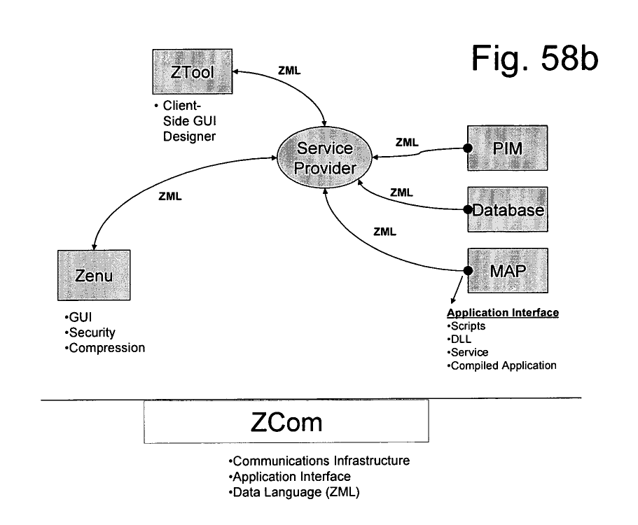

In a typical Zenu-enlabled information management system depicted in FIGS. 58a and 58b, one or more applications may reside on one or more servers and be configured to receive (pull) and respond to (push) requests for information by end users using Zenu interface enabled devices (i.e., devices running Zenu real-time user interface software). This information “pull” and “push” allows access to the most relevant and current information extracted from databases to be displayed on a Zenu interface enabled device when required. For example, in some embodiments, the ZPIM application referred to earlier herein may “push” data to a Zenu interface enabled device without being prompted, enabling access to the latest real-time information. In some embodiments, on a server, where Zenu menus may be stored and configured, each interface screen is stamped with a unique identifier allowing a user to know that they have the latest version. If not, the server will push the new menu items to the Zenu when the user connects to the server. As another example, a user may query a server for e-mail contacts, or query for contacts or e-mail meeting certain criteria (e.g., from a particular source) and the server application would respond with the requested data.

In an example application and embodiment shown in FIGS. 58a and 58b, the ZCom infrastructure uses ASP pages on a Windows 2003 Web server (service provider) to deliver content (ZML) in the form of menus and data to a Zenu user interface application. A service provider communicates with an appropriate application server (ZPIM, Database, etc.) to request required information and returns information back to a Zenu user interface enabled device via a service provider. ASP pages at a service provider exchange data with Zenu interfaced software using ZML. The ZCom can be encrypted and compressed at both the server and client sides of the communication path for secure and efficient communications.

Access control may be defined by a login list and script files made available through transactions with a server. This puts control of data access on the server side.

The ZCom infrastructure allows the multiple pieces of the ZenuSuite to work together to accomplish the tasks required. The ZCom can be tailored to operate over multiple communications infrastructures and communication paths, use multiple communications interfaces, and interface with multiple applications and service providers. This unique adaptability coupled with the unique way the components interact make the ZenuSuite a versatile, innovative, and flexible set of tools to connect handheld devices to enterprise applications.

The next section describes how to use ZenuSuite tools together to create a user interface for particular projects.

As noted earlier, the process for implementing a Zenu interface system for a particular application typically begins with defining the goals and objectives for the particular application, and then defining the task flow and associated information flow needed to meet the objectives for the application. An example of a flowchart for creating a project was presented in FIG. 25. This process may be broken down into steps.

The first step in a typical Zenu user interface development project is to define the needs and the associated functionality—the workflow—and associated information flow that a user requires. What is the personal or enterprise goal to be achieved or supported through a particular user interface? For example, a goal or objective may be to access an employee database to retrieve static information. Another goal may be to query a dynamic inventory database or to find specific images on a public Web site. In this step, user's needs are identified, and the tasks required to satisfy those needs are defined.

For each part of the workflow tasks, choices or information requirements to be presented to a user at each step are defined. For example, a Home page or startup display screen may list up to six options. These options will typically reflect the first steps or choices that a user would most need to take.

Each of those choices would then have a separate command associated with it. For example, a command may call up a template or dial a phone. The command or action that each option links to may be mapped out. Then, for a second or successive command layers, options or information needs associated with each of the choices that may be made in the first command later are also determined and mapped out. This process of defining options continues until the end of each chain of options is reached. It is generally desirable for a developer to have the template graphics available for markup during this phase of the Zenu interface development process. It is also desirable for a developer to work within the standards presented in ZTool to save many hours in GUI design, and permit efficient implementation of Zenu-compliant user interfaces.

Once the objectives and workflow process to be supported by a user interface application are defined and the standard templates that will be used as basic building blocks are identified, a developer may choose to use a pencil and sketch what each screen is to look like. In most cases a developer will be able to simply use the ZTool-provided default templates. Where there are special needs that the standard templates will not meet, default templates may be customized with additional or modified elements as described earlier herein. For example, simple text displays, dropdown lists, radio buttons, or other elements may be added and modified as needed. It may be desirable to sketch out representative display screens on printouts of default templates and then ask for input from end users regarding designs of user interface screens. To assist in this stage of development, a JPG file may be provided within ZTool that may contain screen shots of Zenu command regions.

The first command region (middle left side of the image) is a typical launch layer, with six standard choices and a Director screen to be completed by an interface developer. The next six screen layout sections correlate to command regions associated with the first six launch command regions. As many design sheets as may be needed to detail screen designs and layouts for a given user interface application may be printed out from ZTool.

At this stage it is also important to define what result is desired when a user selects any given element of each display screen. For example, what will clicking a particular button cause to happen? When a user selects something on Zenu, the user will expect to have a result. What will that be?

At this point, it may be desirable for a developer to take time to design templates for user interface screens based on the standardized templates provided in ZTool. Generally a template most closely matching a storyboard or sketch of a user interface will be selected as a starting point for each user interface screen. For some developers, it may be desirable to work out the details on paper of adding or removing elements from a template before using ZTool to implement display designs. Other developers may find it efficient to simply begin developing displays in ZTool or another display editor.

Preferably, once preliminary or prototype versions of displays have been developed or considered, ZTool or another display editor may be used to design templates for user interface screens.

Functionality of an application should be tested by a typical user before it is distributed to end users. This will help identify and remove any remaining issues that may be overlooked during interface development. It will typically take only a few minutes to introduce a Zenu GUI to end users!

Whenever there is a need to change how Zenu functions in a particular application, updating server files that Zenu uses to define screen format and content is all that is needed to provide rapid dissemination of changes to all users of a particular application.

The following is an example of an application developed for the disposal of used tires, and performed by field workers on both laptop PC and handheld smartphone communication devices.

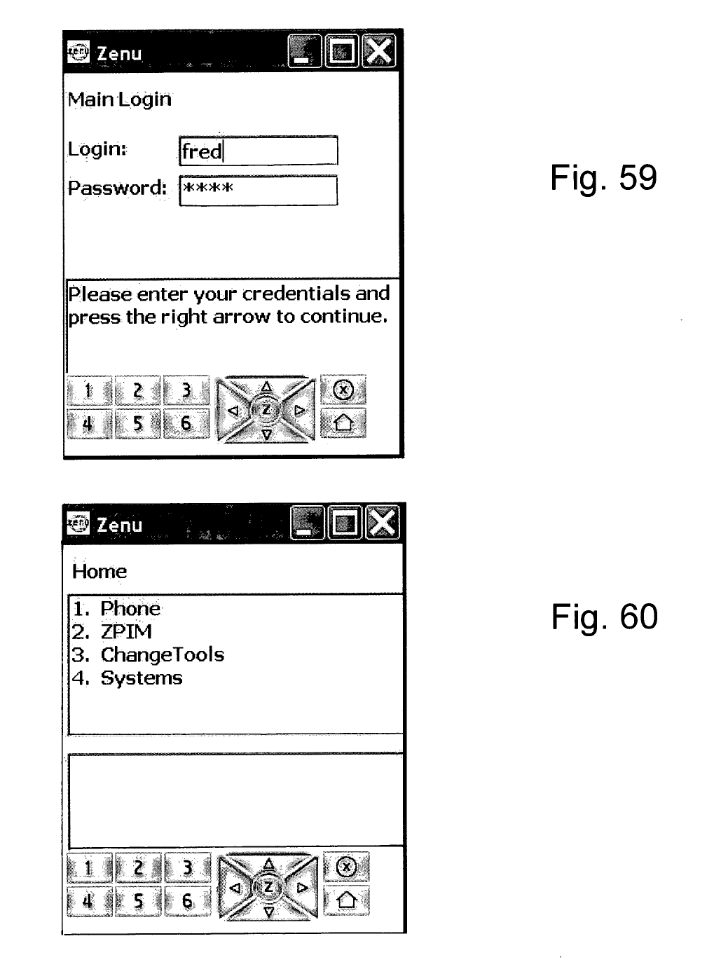

After the Zenu is downloaded, the user enters login and password to gain access to his/her Zenu, as shown in FIG. 59, pressing the right command arrow to proceed to the next screen.

After user credentials are checked at the server the default home screen appears, as in FIG. 60, the menu choices are displayed, and the desired application is chosen by pressing the corresponding number on the Zenu. In this example the desired application is under the no. 1. Phone directory. (this is purely an example as in most cases the desried application would be prominently displayed at the first level of the directory.) The user presses 1 on the Zenu to go to the next screen.

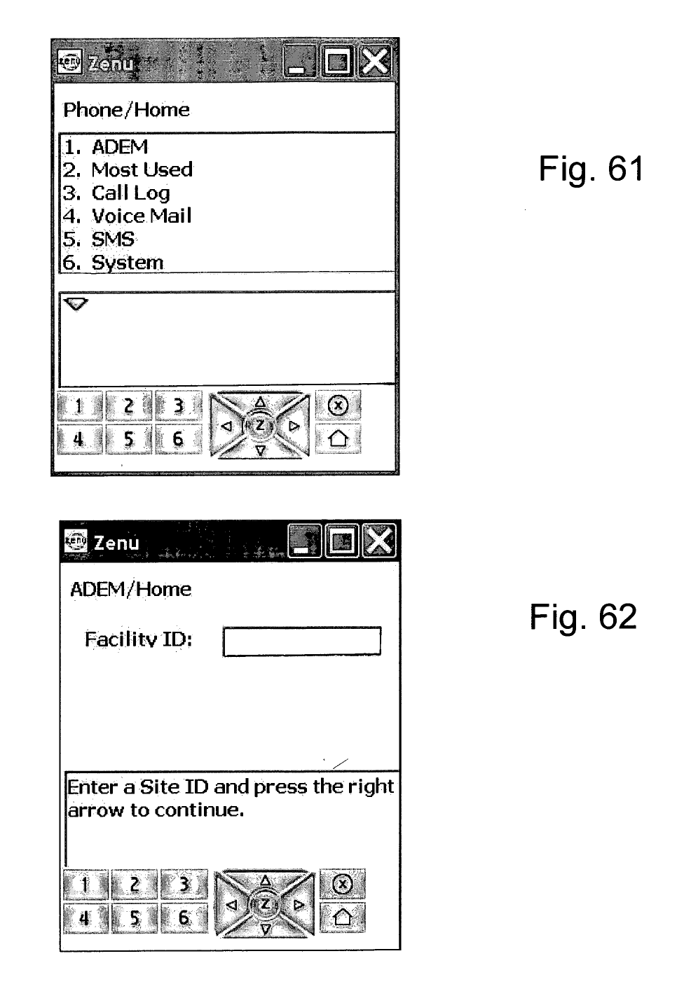

In this case the user presses 1 in FIG. 61 for ADEM and then press the right arrow on the Zenu to go to the next screen

The next screen, FIG. 62, presents a text field for the correct entry of the facility ID. If the user was using a Handheld appliance they would press the Z button in the center of the command navigation center on the Zenu to bring up the ZPad as described earlier, or they may use the keyboard on their PC Laptop or information appliance to enter the correct text.

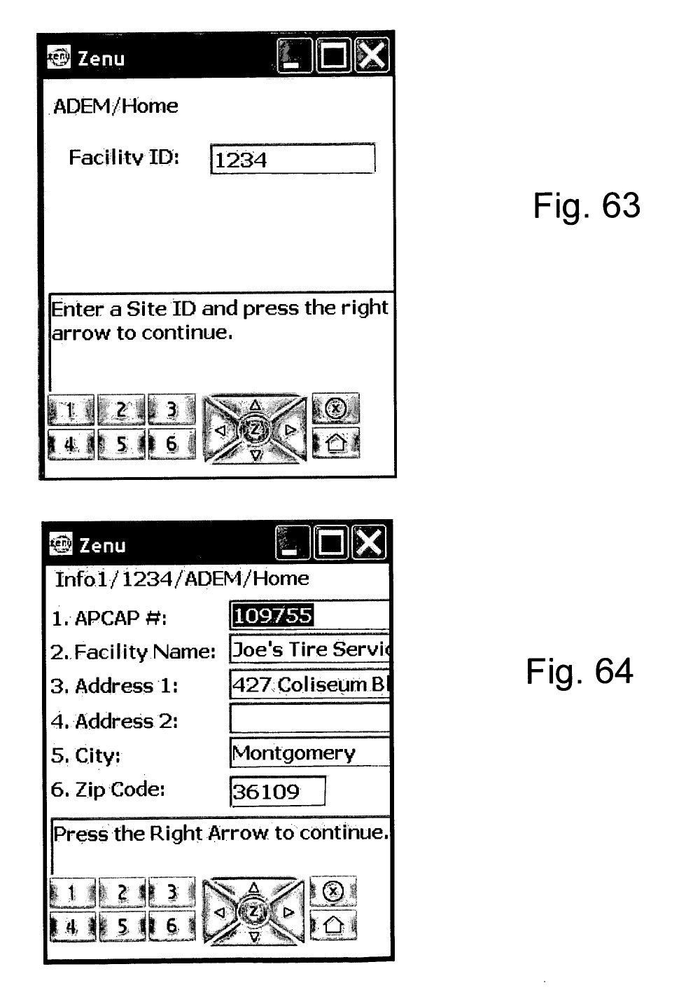

The correct text is entered, as in FIG. 63, and the user presses the right arrow to proceed. Pressing the right arrow on the Zenu sends the entered data to a server, which responds, within the designed task flow, typically by launching a script file to retrieve the requested data from a data base and send the next screen.

The requested information is displayed, as in FIG. 64, from the remote server to the user and the user has the option to accept or edit as appropriate.

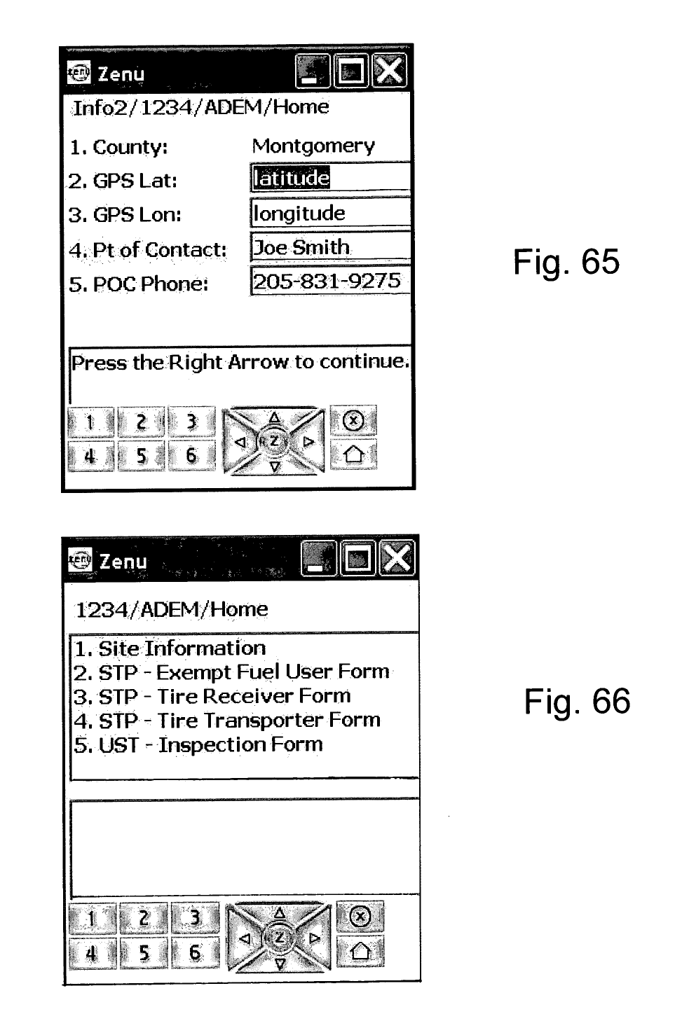

After a user presses the right arrow, additional information is presented for confirmation by the user, as in FIG. 65. The user may then press the right arrow on the Zenu to proceed.

After confirming the correct details of the previous screens, and pressing the right arrow, the user is presented with a series of menu choices, as in FIG. 66, which is the workflow that will enable the field inspector to perform their tasks.

The menu choices are presented as in FIG. 66 and the first task (Fuel User Form) to be performed is accessed by pressing 1 on the Zenu command buttons.

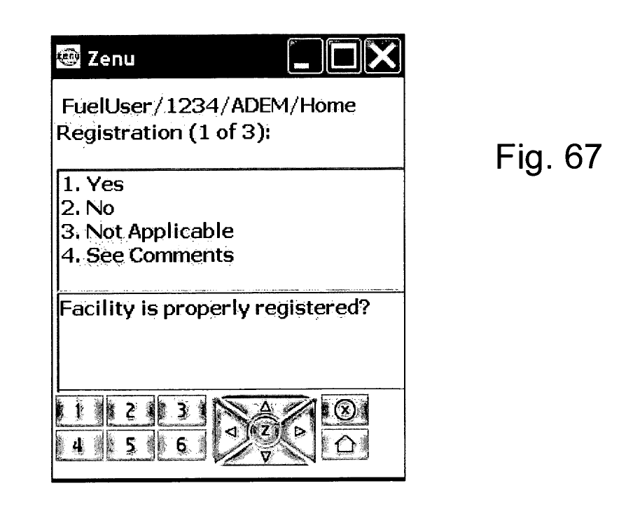

To perform the specific task, the user is presented with a series of questions, as in FIG. 67, in the director window which is located just above the Zenu command region. It is here that the user looks to determine what command button to press based on the menu choices. The director window and Zenu command functions are designed to minimize the problem of divided attention. Divided attention is a big problem that users face when too much information and the control of this information is presented inconsistently. The user spends time searching of the right response rather than executing one action at a time. The user also knows by the “breadcrumb” feature described earlier where they are within the application and how many screens they will be interacting with to complete the specific task. In this example there are 3 steps to complete the Fuel User Form. The user responds to the question in the director window by pressing 1 on the Zenu command button confirming that ‘Yes’ is the answer to the ‘Facility being properly registered’. The correct choice is entered and the user presses the right arrow to proceed.

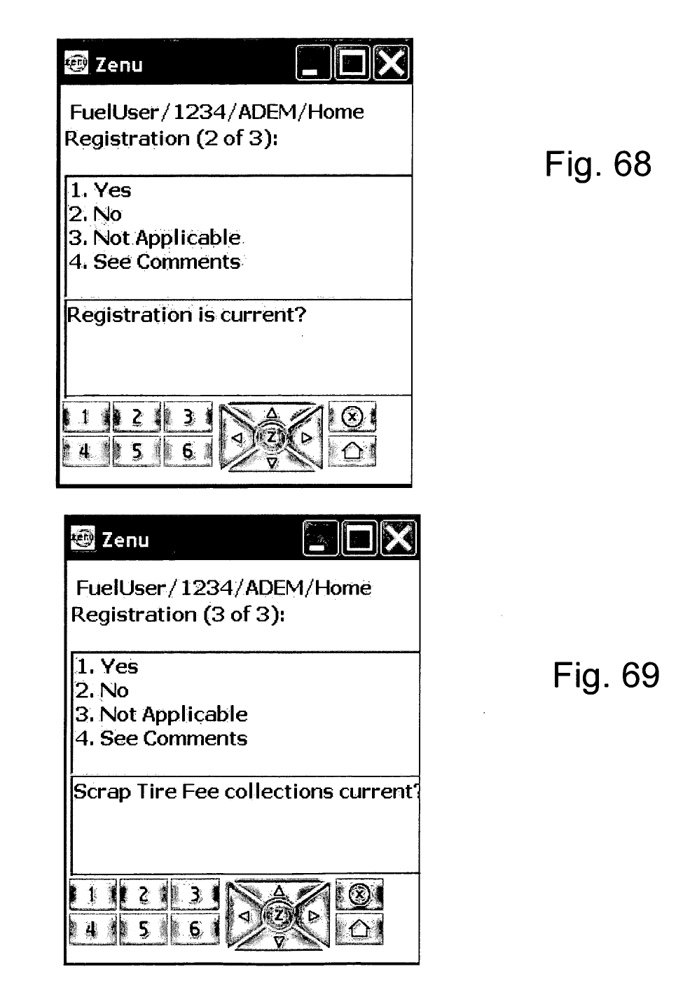

FIG. 68—The correct choice is entered (in this example the answer to the question in the director window is ‘N/A’) as 3, and the user presses the right arrow to proceed.

FIG. 69.—The correct choice is entered (in this example the answer to the question in the director window is ‘Yes’ 1, and the user presses the right arrow to proceed.

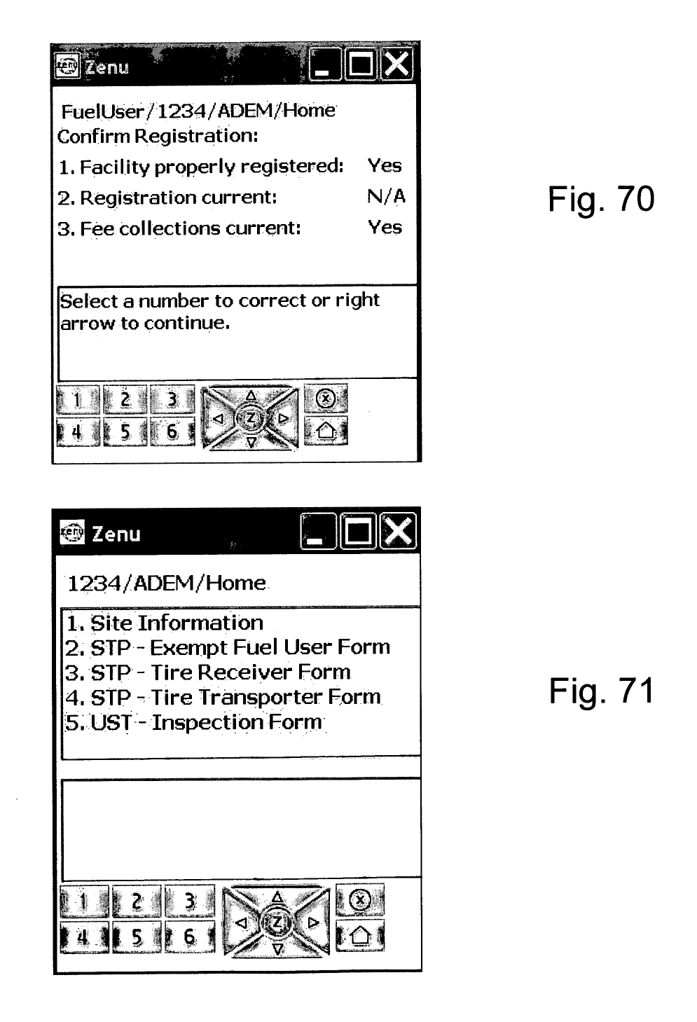

FIG. 70—The screen presents the summary of the workflow completed. If all is correct the user presses the right arrow to confirm and move to the next task.

FIG. 71—The first task being completed the user is directed back to the task home screen so they may continue with the tasks required. In this example the next task is no. 3 (tire receiver form) on the menu choices. The user presses 3 command button on the Zenu and the next screen is presented.

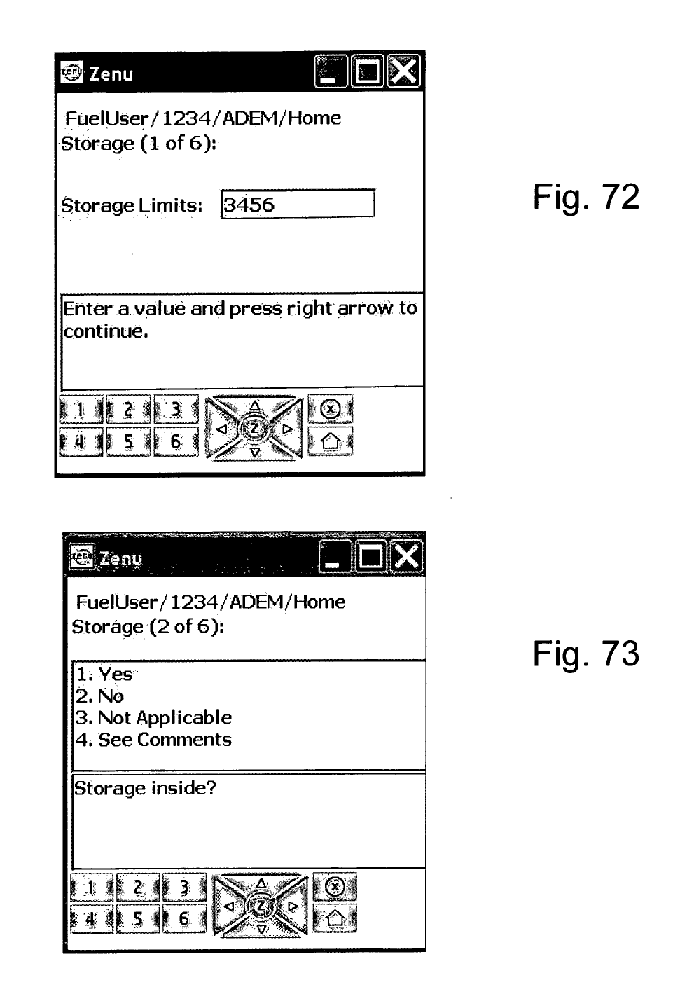

FIG. 72—The text field is presented and the user enters the correct information by either depressing the Z button or using the keyboards on the information appliance, as described earlier.

FIG. 73—The correct choice is entered (in this example the answer to the question in the director window is ‘Yes’, and the user presses the corresponding command button confirming the choice and then the right arrow to proceed.

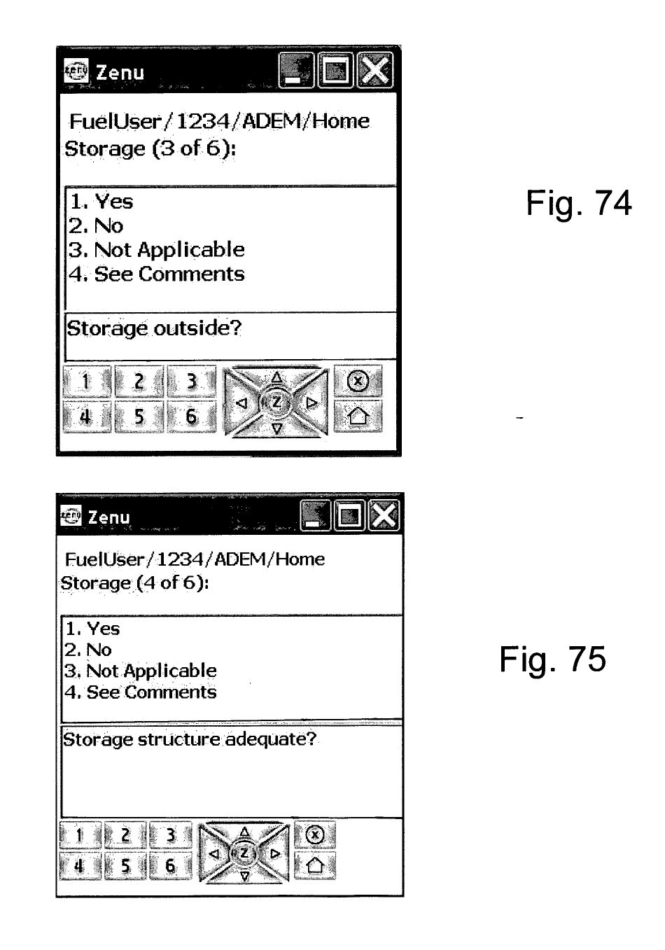

FIG. 74—The correct choice is entered (in this example the answer to the question in the director window is ‘N/A’, and the user presses the corresponding command button confirming the choice and then the right arrow to proceed.

FIG. 75—The correct choice is entered (in this example the answer to the question in the director window is ‘No’, and the user presses the corresponding command button confirming the choice and then the right arrow to proceed.

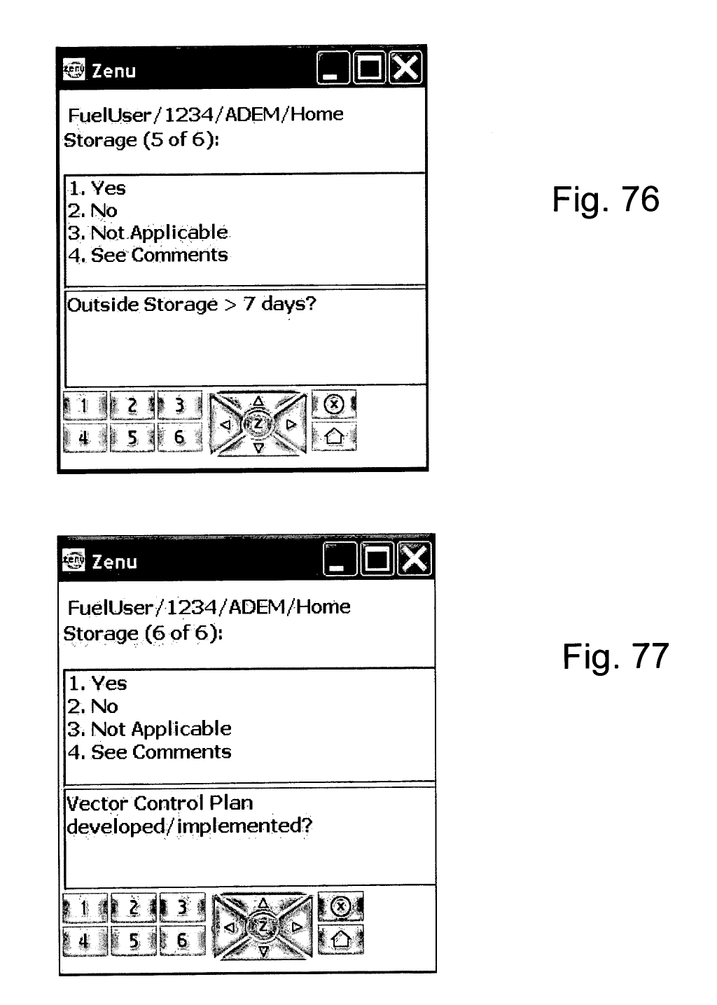

FIG. 76—The correct choice is entered (in this example the answer to the question in the director window is ‘Yes’, and the user presses the corresponding command button confirming the choice and then the right arrow to proceed.

FIG. 77—The correct choice is entered (in this example the answer to the question in the director window is ‘No’, and the user presses the corresponding command button confirming the choice and then the right arrow to proceed.

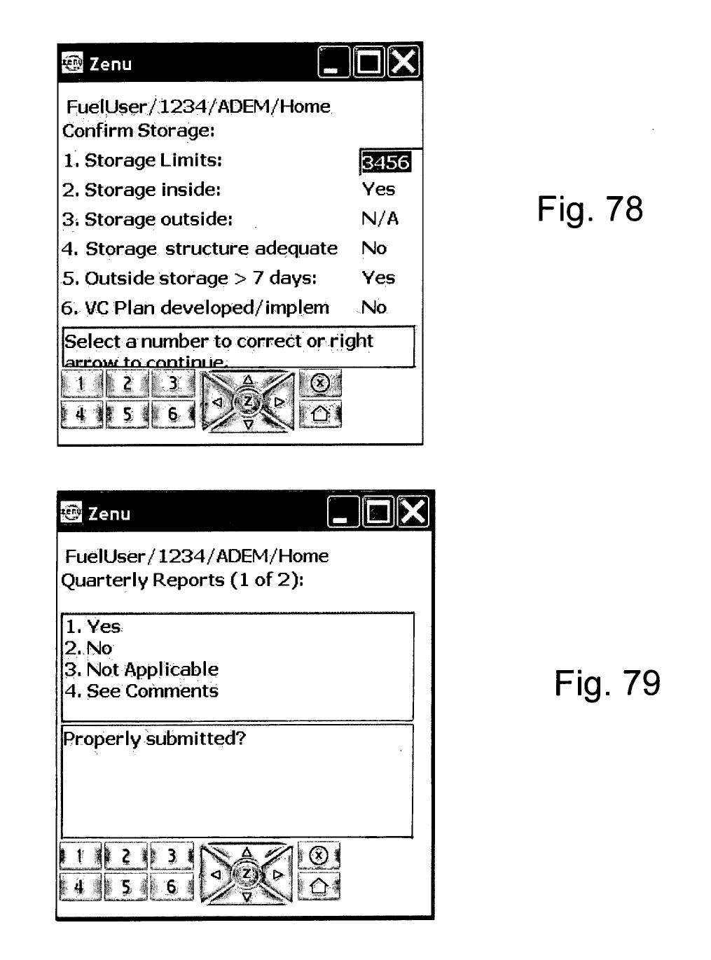

FIG. 78—The user is presented with the summary of the previous actions and if the correct choices were selected the right arrow is activated to confirm the task, or the user could make the appropriate corrections before proceeding.

FIG. 79—The correct choice is entered (in this example the answer to the question in the director window is ‘No’, and the user presses the corresponding command button confirming the choice and then the right arrow to proceed.

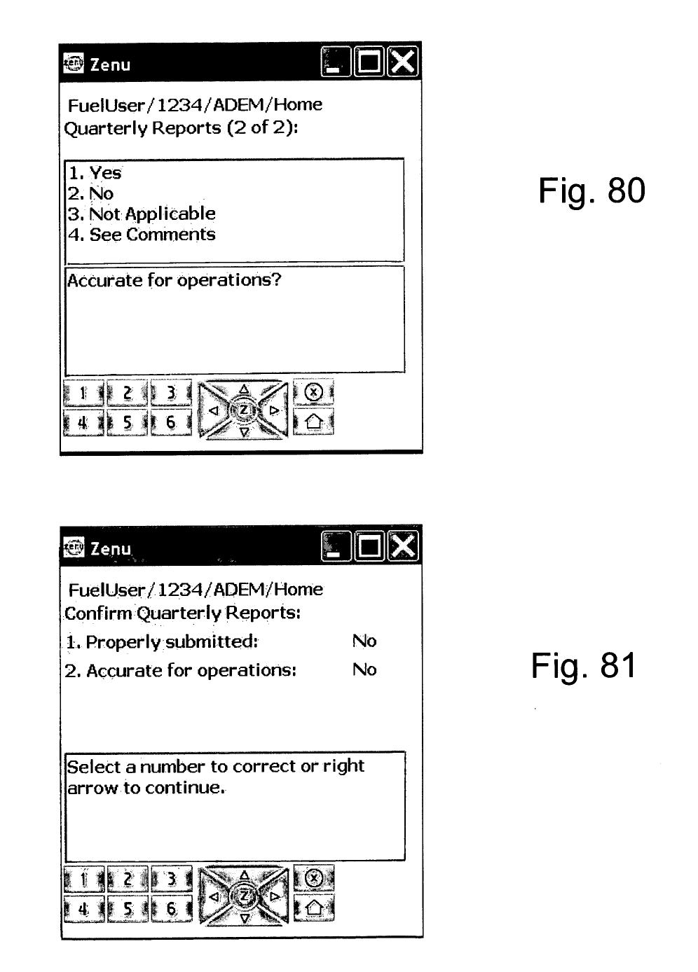

FIG. 80—The correct choice is entered (in this example the answer to the question in the director window is ‘No’, and the user presses the corresponding command button confirming the choice and then the right arrow to proceed.

FIG. 81—The user is presented with the summary of the previous actions and if the correct choices were selected the right arrow is activated to confirm the task, or the user could make the appropriate corrections before proceeding.

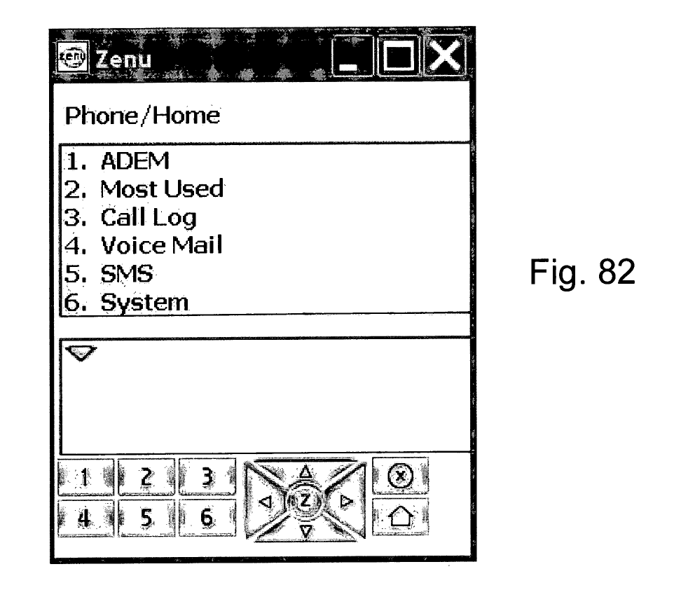

FIG. 82—When the tasks are completed the user is returned to the home page.

As noted earlier herein, the utility and adequacy of the Zenu™ user interface for performing many transactional task has been established via independent testing conducted by Professor Clifford Nass, Director of the Center for the Study of Language and Information, Department of Communications, at Stanford University. In this experiment, a statistically significant number of participants, each of whom had substantial experience with conventional computers and use of web-browsers on the Internet, but no experience with a Zenu™ interface, were asked to perform a number of transactional tasks related to on-line banking using conventional interfaces, and separately, Zenu™ interfaces, on a personal computer and on small-screen hand-held computers (personal digital assistants). The tasks included checking balances, transferring funds between accounts, paying a bill in full, paying a minimum amount, and paying a specific amount. Results of this test presented in February 2003 showed that 85% of participants liked the Zenu™ interface better than the conventional interface, 80.5% of participants found the Zenu™ interface easier to use, and 78% found the Zenu™ interface to be more engaging and more relaxing to use than a traditional Web interface.

Another feature of some embodiments of a Zenu™-based system architecture is the storage of templates and other user display formatting and information on a server, which may be a conventional network server or other information appliance, and tailoring of XML to a more efficient structure, called ZML™, for transactional dialogs between a user and a server hosted information process. An example of ZML™ was shown in application Ser. No. 10/931,128, previously incorporated herein by reference. Hosting templates and other formatting and content data for user displays located on any device such as PC's, laptops, cell phones, handheld computers, or remote control devices, which may be portable or located remotely from the server, allows selection and control of specific displays, responsive to user inputs or requests, from a server, while the Zenu™ interface software (which may use ZenuStack™, an information display protocol and methodology for mapping applications and control functions to a Zenu® interface) running on a handheld computer or other remote device permits display of user interface screens, using Zenu™ Information Display Protocol, on virtually any PC, laptop, cell phone, personal digital assistant, or other remote device capable of receiving an XML data stream and running the Zenu™ software. This Zenu™ architecture and framework permits a single device, such as a PC, laptop, cell phone or handheld computer having both RF connectivity via a cellular or other data network, and an infrared transceiver, to be used to access and interact with information processes, such as on-line banking or a real estate locator, located on a centralized server, while also using the same cell phone or other device to interact with and control a stereo, television, or other appliance in a household or office environment, all using a common (i.e., shared) and familiar user interface. This user interface architecture, involving push-down user interface screens or displays, permits a Zenu™ system embodiment, with user interface screens appropriate to specific tasks hosted on one or more servers supporting different applications (e.g., on-line banking, airline reservations, real estate locator, or a home stereo or video cassette recorder), wherein the different applications provide data, via ZML™, for standardized user interface screens which could permit use of just one handheld device, or at least one familiar user interface protocol, to interface with, exchange information with, and/or control any of a plurality of such interfaces. The Zenu™ interface thus provides an important capability supporting digital convergence.

Swift communication is the most important hurdle for any competitive environment. The faster a product can be ordered, the more sales can be accrued. The faster you can perform a task the better, The faster a soldier or front line responder can determine situational awareness the more lives can be saved. With data rates and network stability making amazing strides, the only remaining obstacle for increased productivity is the ability to access and manipulate information quickly, easily and efficiently irrespective of device. As described herein, Zenu provides users with faster access to live data through a patented user interface. By simplifying menus, reducing keystrokes to pertinent information, and providing a common interface across any platform, Zenu removes unnecessary complexity from common transactional tasks, especially for untrained users where accuracy and speed are essential to the success of the enterprise.

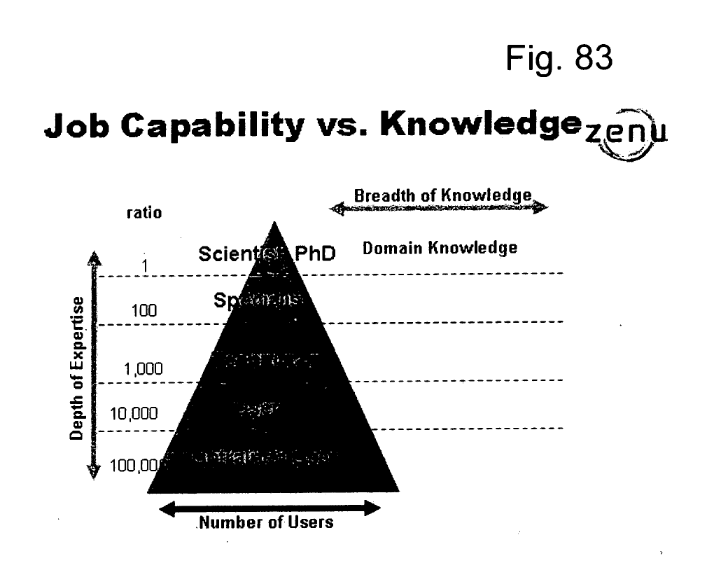

FIG. 83 illustrates the common situation where the people with the highest breath of knowledge usually are the inventors, providers and designers of applications and devices that are designed for a wider mass market (whose members usually possess a much lesser degree of knowledge).

The ZenuSuite provides the tools required to always present information to users, irrespective of information appliance, in substantially the same format, creating a protocol for control so that the training of the wider market to use the device or perform the desired task is reduced.

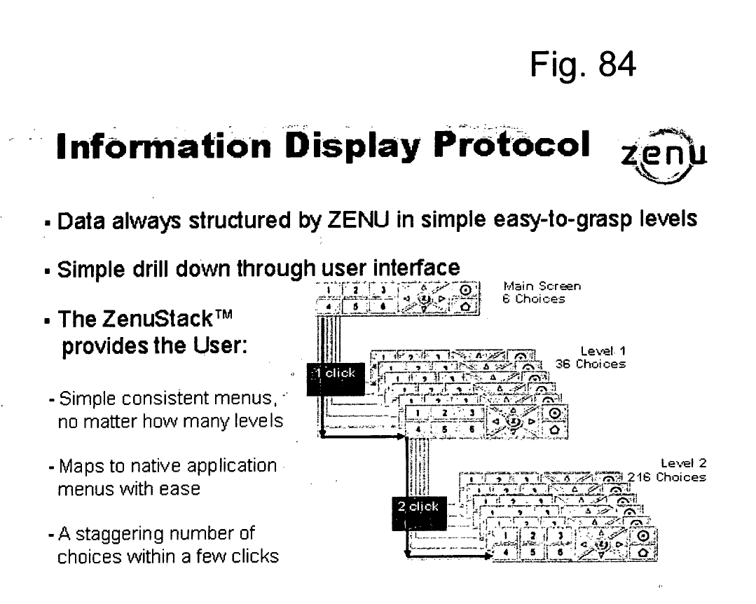

FIG. 84 illustrates how one component of the ZenuSuite works to facilitate the information display protocol. The ZenuStack is a feature of the ZenuSuite that allows the application designer to map information to the controls (the command buttons, command arrows within the navigation command center) of a Zenu.

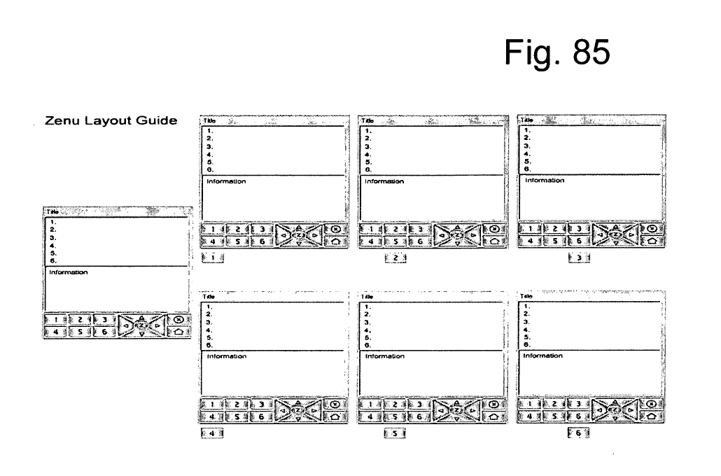

FIG. 85 illustrates the templates that may be used to map the application/storyboard for the specific task to the Zenu. If one takes these templates and stacks them on top of each other—like a deck of cards—this provides, in effect, an example of a ZenuStack. The ZenuStack is navigated through the command buttons or the command arrows within the navigation command center of a Zenu.

As another example of how a conventional interaction between a user and a information processing application may be mapped into a more natural and efficient interface, as provided by a Zenu™ architecture, consider the following. When you are on the road and headed for the airport, it would be nice to be able to check-in before you get to the airport so that you can get the best seat possible. You can do this easily online if you happen to be carrying a laptop or stop by an Internet Café. But what if you are in a cab or on a train and have forgotten to check-in? If you wait until you are already at the airport, you will get what's left over, probably a undesirable seat selection. With a Zenu on your information appliance, you can access the Internet and do the job in just a few clicks.

To build the demo, we analyzed the current web site used by the specific Airline. Out of all of the available functionality, we decided that the best part of the site and what would make the most sense to use on the road would be just the pages that allow a ticketed passenger to check-in online. To begin the process of developing the application, you need to examine the existing functionality and break it down into steps.

By looking at the home page of the airline's web site, we find a link that leads to a form. This form asks for the passenger's confirmation number, first name and last name. By examining the source code of the web page, we see that the fields are named recordLocator, firstName and lastName. We also see the name of the script that will be receiving the information. Since there is no API, we can use this to replicate the form in Zenu and then send a properly formatted request to the airline web site script to get boarding pass information.

Upon entering the requested information, we submit the form and take a close look at the results. A list of passengers is displayed along with information about the flight. Examining the source code for this display reveals information about the next script that is used to do the actual check-in as well as the names and values for all expected parameters to the script. Again, since there is no API we can parse the output of the display and reformat it in Zenu to make the interaction easier.

Now we select the passengers to check-in and click the check-in button to submit our request. The response from the server returns the boarding group and number within the group. We can also parse this output and display it within Zenu.

In a Zenu application, workflow is everything. This makes the user experience much easier and intuitive. Rather than having to scroll around a large website looking for the correct links to perform a task, the user is given limited options and guided through the task step-by-step. Now that we have analyzed the target application, it is time to come up with our workflow. We know that the only thing we want to do for this demonstration is to provide the ability to check-in. That means we only need one click to launch this process so we will simply add a single option to our demonstration menu in our application. We also know that the user will take the following steps to complete this task:

1. Enter confirmation number and name (first & last).

2. Select passengers to check-in.

3. Check-in and receive boarding group information.

This task has three steps that must be done in order. So for this task, we will create three ZML templates and use the right arrow to drill into the task one step at a time.

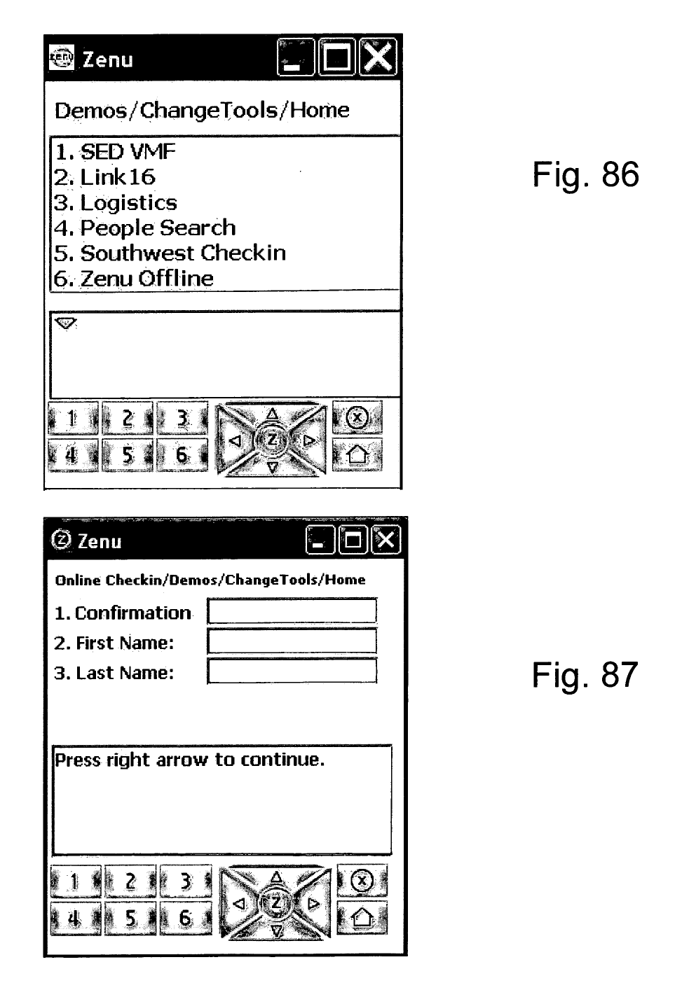

The first template will be a screen with three labels and three text entry fields. There will be one label and text entry field for each of the pieces of information needed to begin the process; Confirmation Number, First Name and Last Name. We can also make use of a director box to give the user instructions on how to proceed. The template can either be created by hand or the ZTool product can be used to build the interface by dragging and dropping controls onto the template. FIG. 86 displays the option 5 for the desired check-in application for the particular airline. The user presses the corresponding command button 5 followed by the forward/right command arrow to proceed to the next screen.

The next screen, shown in FIG. 87, will be a screen to display the required text fields that need to be completed for accomplishing the task. The user can either activate the Z button and bring up the ZPad or use the keyboard provided in the information appliance as outlined earlier. Once this is completed the user presses the forward/right command arrow to send the information to the server for confirmation.

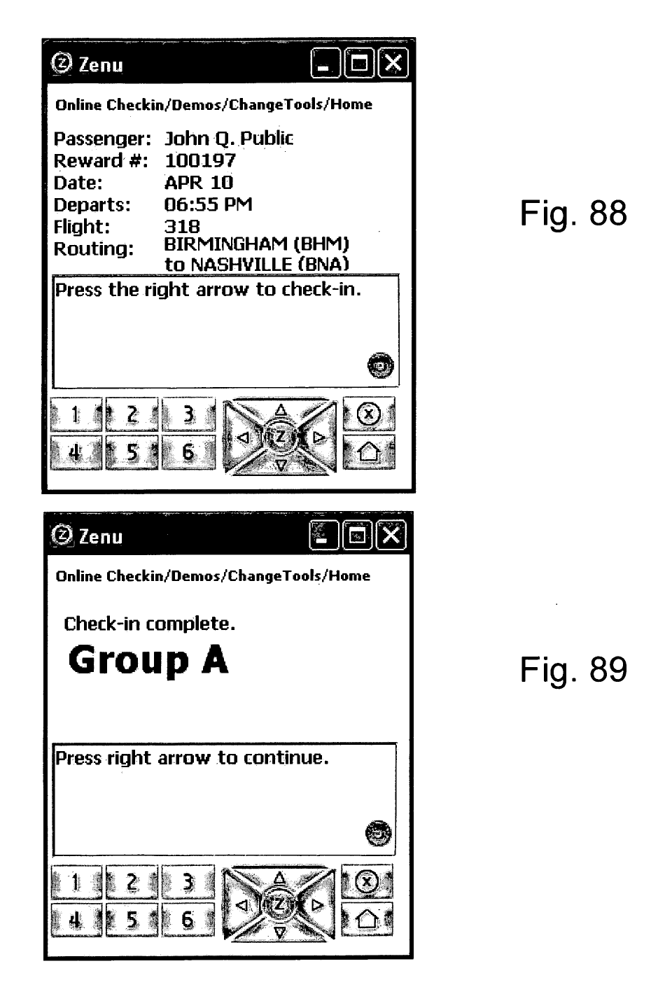

FIG. 88 illustrates a Zenu screen that displays the boarding information of the requested passenger. This will be the same information about the passenger and flight as was displayed on the airline's original web site. The information displayed will include: Passenger Name, Reward Number, Departure Date, Departure Time, Flight Number and Routing Information. The following screenshot is an example of the template as displayed in Zenu.

FIG. 89 illustrates the final Zenu screen of this example. This screen will display the boarding group information. When you check-in at this particular airline, you are assigned a boarding group. This group can be Group A, Group B or Group C. The group that has been given will be displayed in this screen. The following screenshot is an example of the template as displayed in Zenu.

Now that we have the workflow defined and all of the templates created, it is time to hand all of the information over to the programmer. They will be responsible for doing the integration work for the project. It will be up to the programmer to write any software that is necessary to carry on the communication between the Zenu Application templates and the airline web site scripts. In this example, we are exchanging data with an airline web server. The same kind of programming effort is necessary any time we want to have a Zenu interface interact with data from an existing application. Whether the data can be retrieved from an application's database directly or there is an API that provides access to application data, some kind of programming interface will most likely be necessary to integrate the available data into a Zenu application.

For the purposes of this demonstration, the programmer will be given the workflow, templates, URLs to the web server, and any data that was collected during the analysis phase of the project. Since a lot of our demonstration application has been written in ASP/C#.NET, the programmer will be instructed that this will be the development environment for the implementation of this project. The implementation environment is completely up to the integrator. Any language that is capable of sending and receiving ZML (XML Text) can be used.

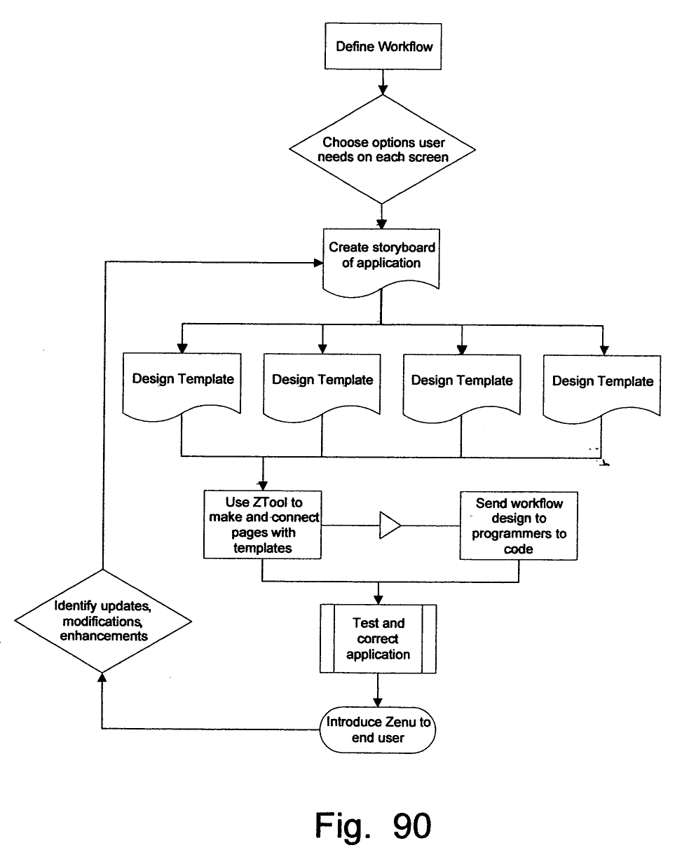

FIG. 90 provides another flowchart representation of the methodology that may be followed to design and implement a Zenu interface application for an enterprise.

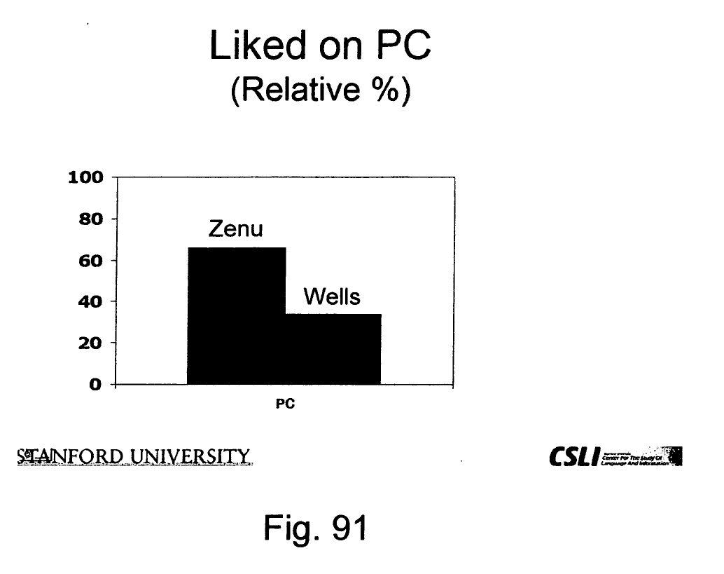

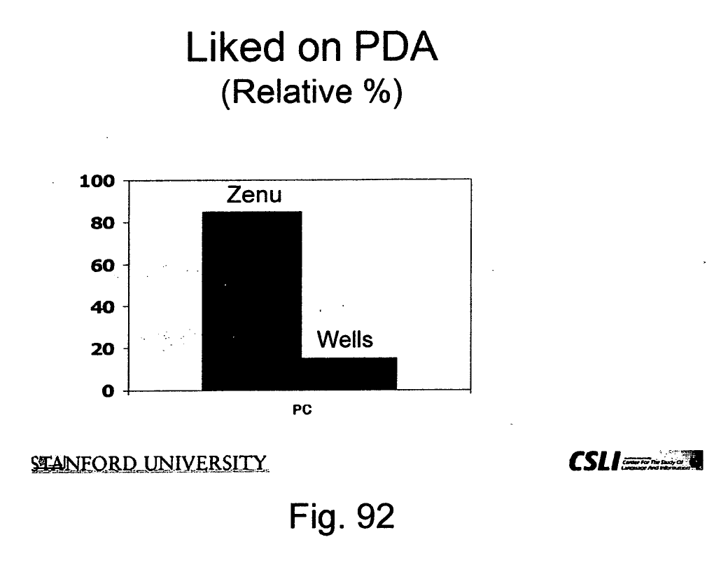

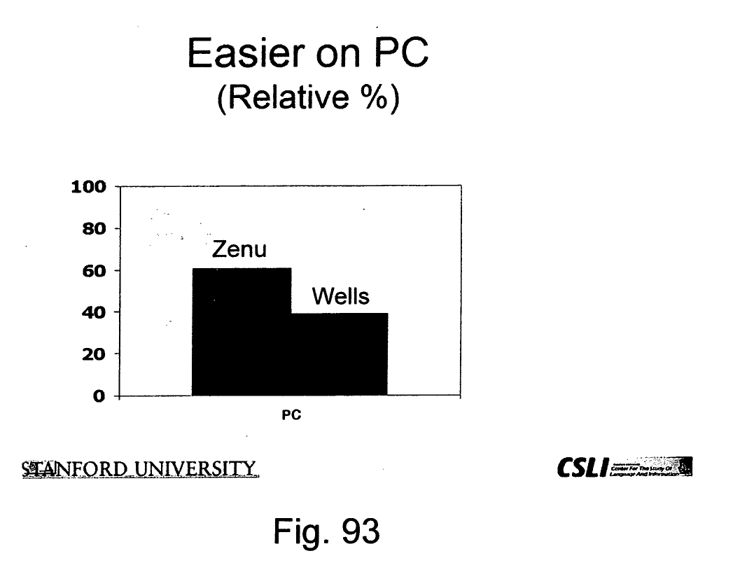

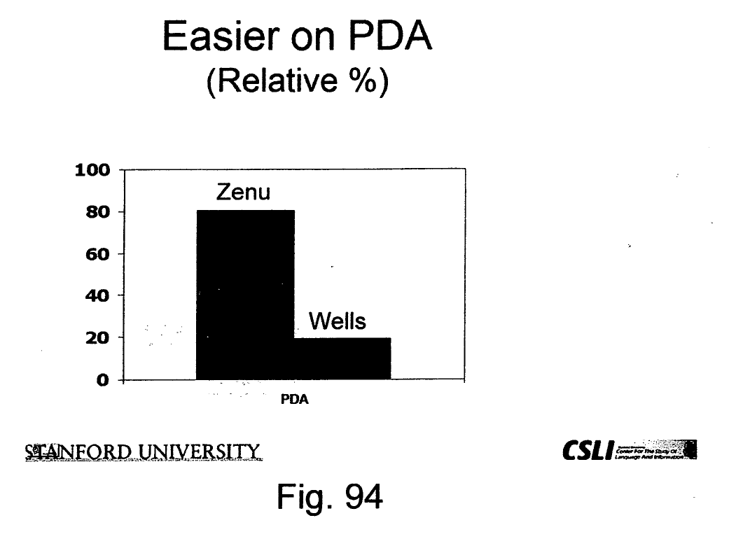

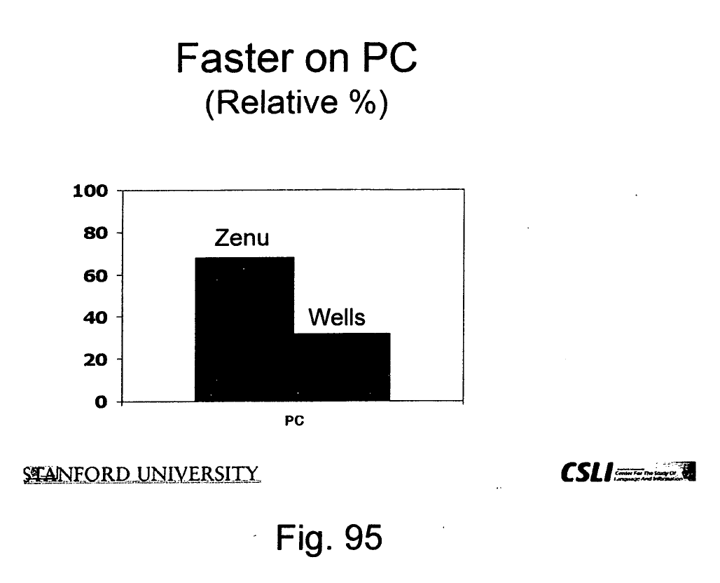

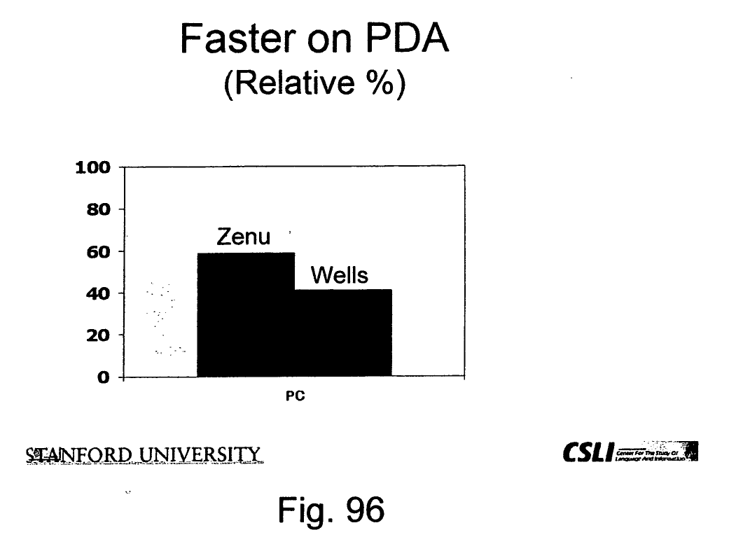

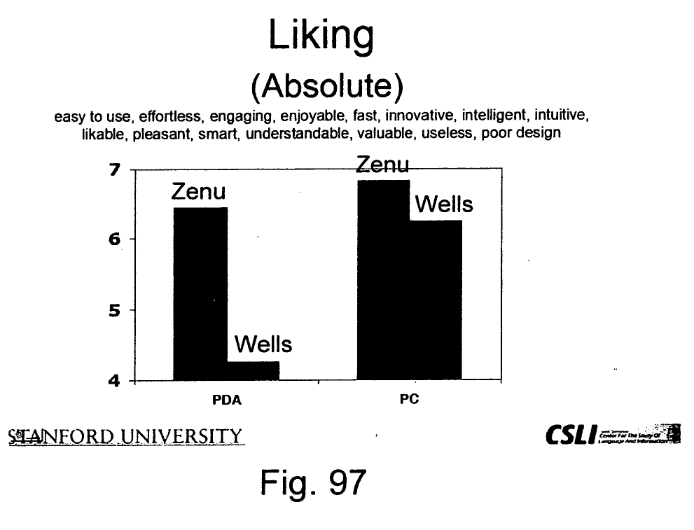

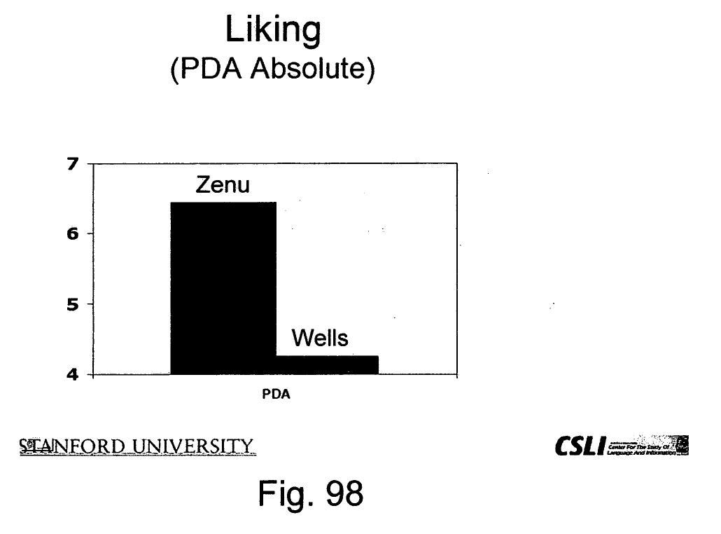

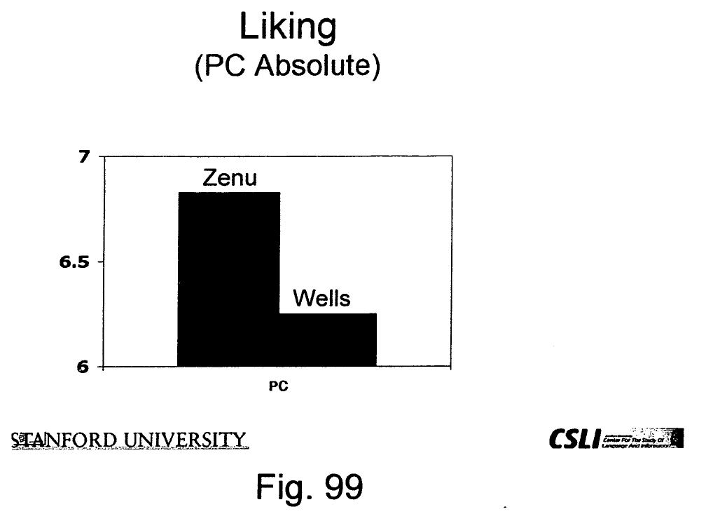

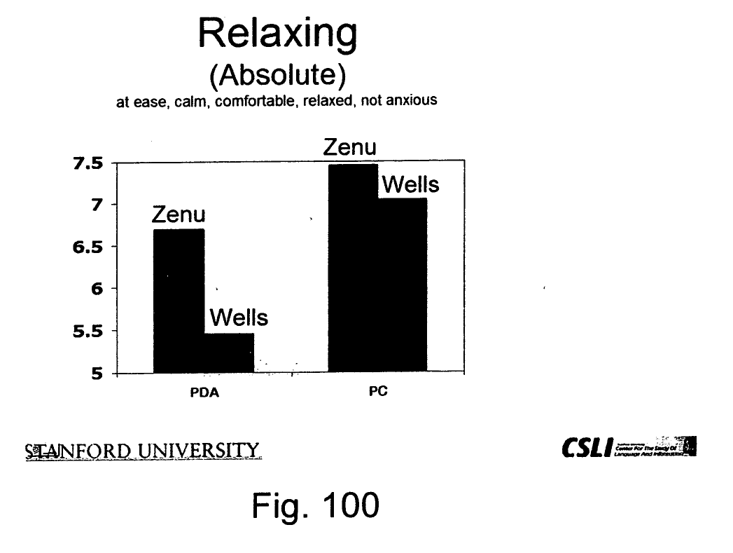

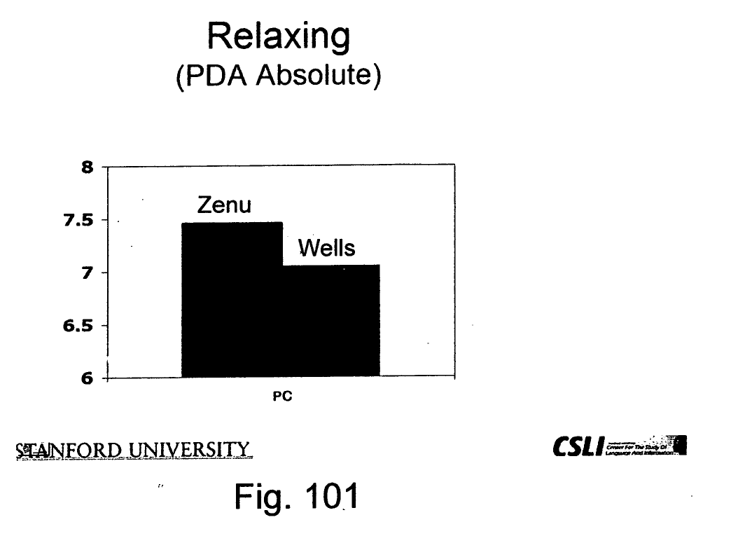

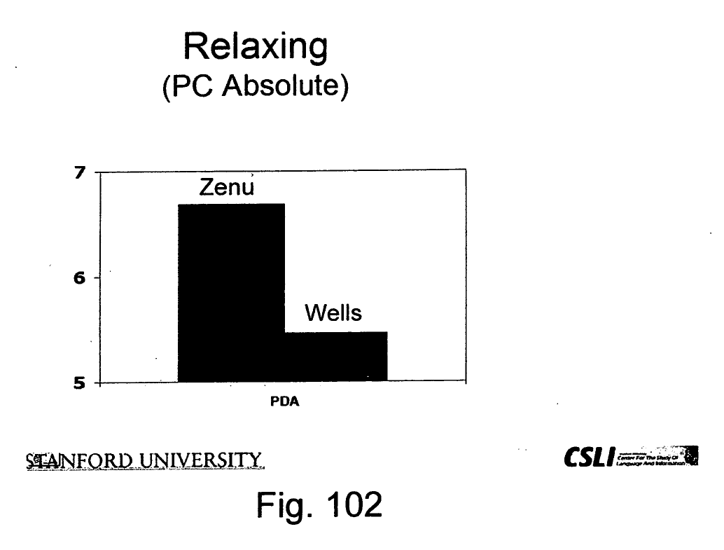

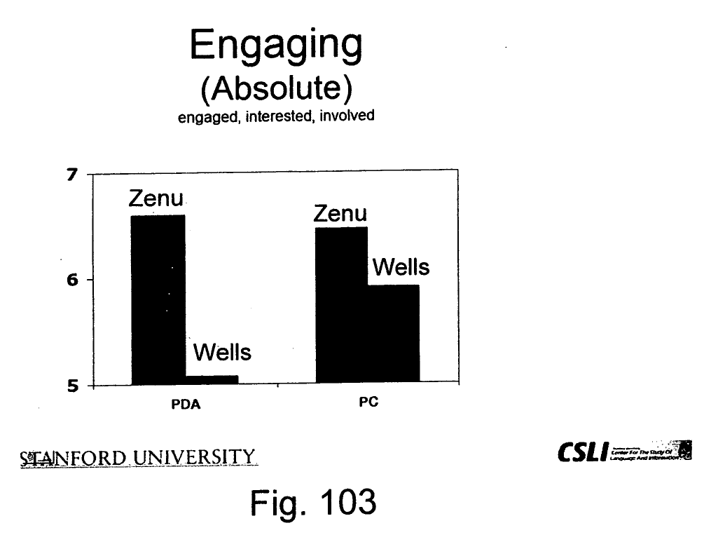

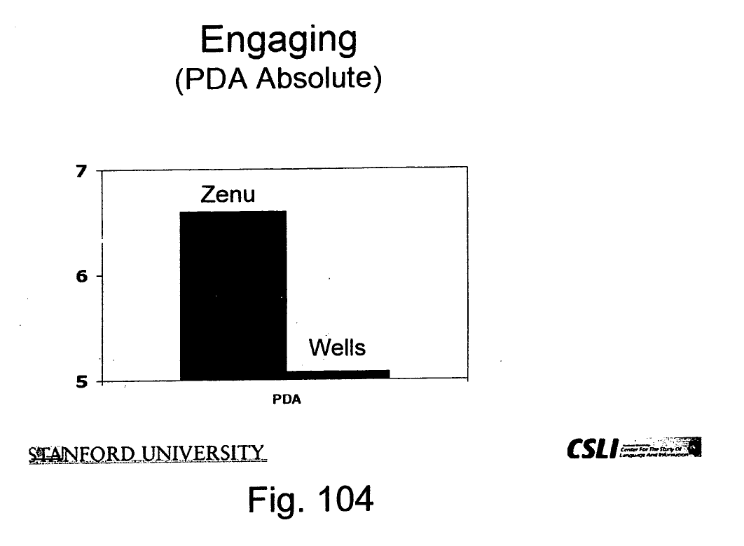

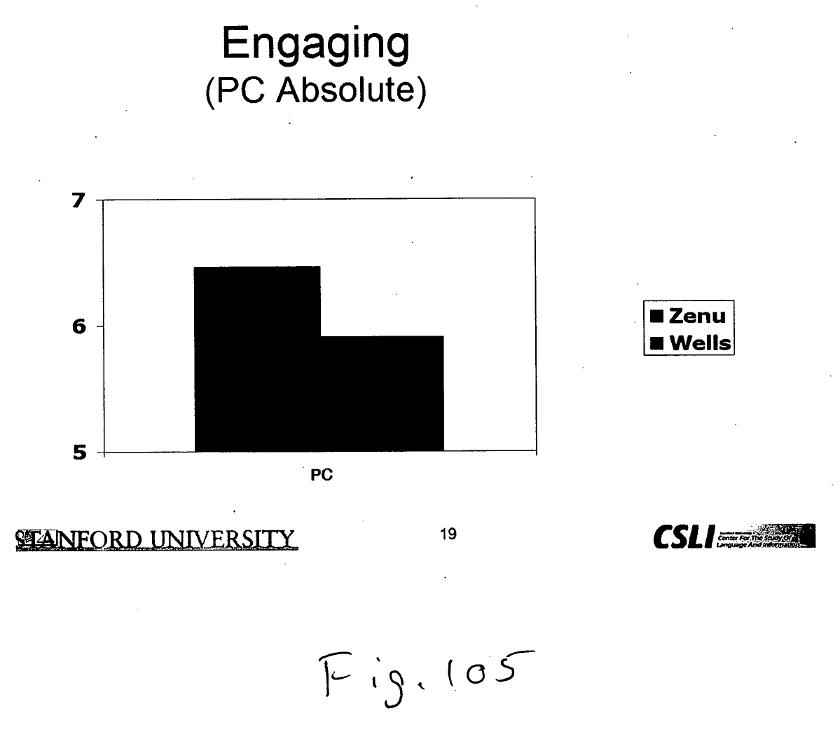

Reference was made earlier herein to a study conducted by Professor Clifford Nass Director of the Center for the Study of Language and Information, Department of Communications, at Stanford University, comparing Zenu user interfaces implemented on a PC and on a handheld PDA with a more conventional interface for transactional tasks implemented on the same platform. FIGS. 91 through 105 provide detailed results of the comparison based upon various comparison characteristics noted at the top of each chart. In each figure, comparison results are indicated by two adjacent vertical bars, where the ranking of the Zenu interface is shown in the left bar, and the ranking of the conventional user interface is shown in the right bars.

1. A method for developing a user interface for exchanging data between a client device and an application hosted on a server comprising:
selecting a workflow for which a user interface is needed,
identifying information that must be exchanged between a user and an application on a server to perform said selected workflow,
defining steps to exchange said information for said workflow such that no more than about six elements of information, including choices, are presented to a user of said client device in any step,
defining screens for a client device to be used in exchanging information with said user, and
exchanging information between said client device and said application using tags to demark selected element of information.
